(19) United States
(12) Patent Application Publication
(10) Pub. No.: US 2025/0207984 A1
(43) Pub. Date: Jun. 26, 2025

(54) SENSOR SHEET AND MANUFACTURING METHOD OF SENSOR SHEET

(71) Applicant: Sumitomo Riko Company Limited, Aichi (JP)

(72) Inventors: Masaki Nasu, Aichi (JP); Sho Omori, Aichi (JP); Tomonori Hayakawa, Aichi (JP); Katsuhiko Nakano, Aichi (JP); Tetsuya Yoshida, Aichi (JP)

(73) Assignee: Sumitomo Riko Company Limited, Aichi (JP)

(21) Appl. No.: 19/074,457

(22) Filed: Mar. 10, 2025

Related U.S. Application Data
(63) Continuation of application No. PCT/JP2024/011522, filed on Mar. 22, 2024.

(30) Foreign Application Priority Data
Mar. 24, 2023 (JP) 2023-048568

(51) Int. Cl. G01L 1/14; D04H 1/4234; G01L 5/22

(52) U.S. Cl. CPC G01L 1/14; D04H 1/4234; G01L 5/221

(57) ABSTRACT

A sensor sheet includes: an insulating sheet; a conductive first electrode sheet disposed on a first surface side of the insulating sheet and having first openings penetrating through; a first bonding part bonding the insulating sheet and the first electrode sheet; a conductive second electrode sheet disposed on a second surface side of the insulating sheet and having second openings penetrating through; and a second bonding part bonding the insulating sheet and the second electrode sheet. The sensor sheet is configured not to have a yield point showing a local maximum value in a range with a strain being 0.5 to 10% in a stress-strain curve in a tensile test. An opening ratio of the first openings in the first electrode sheet is 1% or more and 50% or less. An opening ratio of the second openings in the second electrode sheet is 1% or more and 50% or less.

### CROSS-REFERENCE TO RELATED APPLICATION

The present application is a continuation of PCT/JP2024/011522, filed on Mar. 22, 2024, and is related to and claims priority from Japanese patent application no. 2023-048568, filed on Mar. 24, 2023. The entire contents of the aforementioned applications are hereby incorporated by reference herein.

### BACKGROUND

### Technical Field

The disclosure relates to a sensor sheet and a manufacturing method of the sensor sheet.

### Related Art

Patent Document 1 (Japanese Patent Application Laid-Open No. 2019-68414) discloses a sensor sheet that includes a dielectric layer and a first electrode sheet disposed on a first surface of the dielectric layer. The sensor sheet is, for example, attached to a steering wheel of a vehicle to detect whether an occupant has contacted the steering wheel.

The sensor sheet described in Patent Document 1 has an issue with reliability of detection accuracy of the sensor. For example, in the case of attaching the sensor sheet to a steering wheel, since the sensor sheet is wrapped around the steering wheel while being stretched and pulled, there is an issue that a conductive path of the first electrode sheet changes due to a tensile stress, and an electrical resistance value of the first electrode sheet changes.

### SUMMARY

An aspect of the disclosure is a sensor sheet including an insulating sheet, a first electrode sheet, a first bonding part, a second electrode sheet, and a second bonding part. The insulating sheet has a first surface and a second surface and is formed of a foamed body. The first electrode sheet, which is conductive, is disposed on a first surface side of the insulating sheet and has first openings penetrating through the first electrode sheet. The first bonding part bonds the insulating sheet and the first electrode sheet to each other. The second electrode sheet, which is conductive, is disposed on a second surface side of the insulating sheet and has second openings penetrating through the second electrode sheet. The second bonding part bonds the insulating sheet and the second electrode sheet to each other. The first electrode sheet and the second electrode sheet are conductive cloths woven with multiple filament assemblies. The multiple filament assemblies include multiple filaments and a plating layer formed on at least a part of a surface of the filament. The first electrode sheet includes the first openings that are opened between the multiple filament assemblies. The second electrode sheet includes the second openings that are opened between the multiple filament assemblies. The sensor sheet is configured not to have a yield point showing a local maximum value in a range with a strain being 0.5 to 10% in a stress-strain curve in a tensile test. An opening ratio, which is a ratio of an opening area of the first openings to an area of the first electrode sheet, is 1% or more and 50% or less. An opening ratio, which is a ratio of an opening area of the second openings to an area of the second electrode sheet, is 1% or more and 50% or less.

Another aspect of the disclosure is a manufacturing method of a sensor sheet including: forming a filament assembly by bundling multiple filaments; forming a base fabric by weaving multiple filament assemblies; forming a conductive cloth by performing a plating treatment on the base fabric; and forming a sensor sheet by bonding the conductive cloth to a first surface of an insulating sheet made of an elastomer having the first surface and a second surface.

According to an aspect of the disclosure, upon application of a tensile force to the sensor sheet, the first openings of the first electrode sheet and the second openings of the second electrode sheet deform, and the opening areas of the first openings and the second openings deform to decrease. As a result, new conductive paths are formed between the multiple filament assemblies which were separated by the first openings. Similarly, new conductive paths are formed between the multiple filament assemblies which were separated by the second openings. Accordingly, even in the case where a tensile force is applied to the sensor sheet, a change in the electrical resistance value can be suppressed.

In addition, the sensor sheet related to an aspect of the disclosure is configured not to have a yield point showing a local maximum value in the range with the strain being 0.5 to 10% in the stress-strain curve in the tensile test. Accordingly, since breakage of the plating layer in the range with the strain being 0.5 to 10% can be suppressed, a change in the electrical resistance value of the sensor sheet can be suppressed.

In addition, according to another aspect of the disclosure, there are filaments that are electrically connected by the mutual contact between the plating layers formed on the surfaces of the filaments adjacent to each other, and filaments that can move freely relative to each other without forming the plating layer on the surfaces of the filaments adjacent to each other. Accordingly, in the case where a tensile force is applied to the sensor sheet, with the stress absorbed by the filaments that can move freely relative to each other, application of an excessively large stress to the sensor sheet can be suppressed. As a result, since electrical connection of the sensor sheet is maintained by the filaments that are electrically connected to each other, a change in the electrical resistance value of the sensor sheet can be suppressed.

Reference signs in parentheses described in the claims indicate correspondence with specific means described in the embodiments to be described later, and are not intended to limit the technical scope of the disclosure.

### BRIEF DESCRIPTION OF THE DRAWINGS

FIG. 1 is a front view showing a steering wheel to which a sensor sheet of Embodiment 1-1 is attached.

FIG. 2 is a cross-sectional view taken along line A-A of FIG. 1.

FIG. 3 is a plan view showing the sensor sheet of Embodiment 1-1.

FIG. 4 is a cross-sectional view taken along line B-B of FIG. 3.

FIG. 5A is a partially enlarged plan view showing a first electrode sheet of Example 1-1, and FIG. 5B is a partially enlarged plan view showing a second electrode sheet of Example 1-1.

FIG. 6 is a cross-sectional view taken along line C-C of FIG. 5A.

FIG. 7 is a partially enlarged plan view showing the first electrode sheet of Example 1-1.

FIG. 8 is a cross-sectional view showing a warp filament assembly of Example 1-1.

FIG. 9A is a partially enlarged plan view showing a first electrode sheet of Example 1-2, and FIG. 9B is a partially enlarged plan view showing a second electrode sheet of Example 1-2.

FIG. 10A is a partially enlarged plan view showing a first electrode sheet of Comparative Example 1-1, and FIG. 10B is a partially enlarged plan view showing a second electrode sheet of Comparative Example 1-1.

FIG. 11 is a graph showing a relationship between a stress and a strain in a tensile test on the first electrode sheet.

FIG. 12 is a graph showing a relationship between the stress and the strain in a tensile test on the sensor sheet.

FIG. 13A is a partially enlarged plan view of the first electrode sheet at an elongation rate of 0%, FIG. 13B is a partially enlarged plan view of the first electrode sheet at an elongation rate of 10%, FIG. 13C is a partially enlarged plan view of the first electrode sheet at an elongation rate of 20%, and FIG. 13D is a partially enlarged plan view of the first electrode sheet at an elongation rate of 30%, in Sample 1-2.

FIG. 14 is a graph showing a relationship between a DC resistance value change rate and the strain of the sensor sheet.

FIG. 15 is a graph showing a relationship between the DC resistance value change rate and the number of repetitions in the case where a 10% elongation tensile test is repeatedly performed on the sensor sheet.

FIG. 16 is a graph showing a relationship between the DC resistance value change rate and the number of repetitions in the case where a 20% elongation tensile test is repeatedly performed on the sensor sheet.

FIG. 17 is a cross-sectional view corresponding to a line C-C cross-section in FIG. 5A of a first electrode sheet in a modification example of Example 1-2.

FIG. 18 is a cross-sectional view corresponding to the line C-C cross-section in FIG. 5A of a first electrode sheet in Modification Example 2 of Example 1-2.

FIG. 19A is a partially enlarged plan view showing a first electrode sheet of Embodiment 2-1, and FIG. 19B is a partially enlarged plan view showing a second electrode sheet of Example 2-1.

FIG. 20 is a cross-sectional view taken along line C-C of FIG. 19A.

FIG. 21A is a partially enlarged plan view showing a first electrode sheet of Embodiment 2-2, and FIG. 21B is a partially enlarged plan view showing a second electrode sheet of Example 2-2.

FIG. 22 is a cross-sectional view taken along line D-D of FIG. 21A.

FIG. 23 is a cross-sectional view corresponding to line D-D in FIG. 21A of a first electrode sheet in Modification Example (1) of Example 2-2.

FIG. 24 is a cross-sectional view corresponding to line D-D in FIG. 21A of a first electrode sheet in Modification Example (2) of Example 2-2.

FIG. 25A is a partially enlarged plan view showing a first electrode sheet of Comparative Example 2-1, and FIG. 25B is a partially enlarged plan view showing a second electrode sheet of Comparative Example 2-1.

FIG. 26 is a cross-sectional view taken along line E-E of FIG. 25A.

FIG. 27 is a graph showing a relationship between the stress and the strain in the case where a tensile test is performed on the first electrode sheet.

FIG. 28 is a graph showing a relationship between the stress and the strain in the case where a tensile test is performed on the sensor sheet.

FIG. 29 is a partially enlarged plan view showing the first electrode sheet in the case where a tensile test is performed on the sensor sheet related to Embodiment 2-1.

FIG. 30 is a graph showing a relationship between the DC resistance value and the strain in the case where a tensile test is performed on the sensor sheet.

FIG. 31A is a partially enlarged plan view showing a first electrode sheet of Example 3-1, and FIG. 31B is a partially enlarged plan view showing a second electrode sheet of Example 3-1.

FIG. 32 is a cross-sectional view taken along line C-C of FIG. 31A.

FIG. 33 is a partially enlarged plan view showing the first electrode sheet of Example 3-1.

FIG. 34 is a cross-sectional view showing a warp filament assembly of the first electrode sheet of Example 3-1.

FIG. 35A is a partially enlarged plan view showing a first electrode sheet of Example 3-2, and FIG. 35B is a partially enlarged plan view showing a second electrode sheet of Example 3-2.

FIG. 36A is a partially enlarged plan view showing a first electrode sheet of Comparative Example 3-1, and FIG. 36B is a partially enlarged plan view showing a second electrode sheet of Comparative Example 3-1.

FIG. 37 is a cross-sectional view taken along line D-D of FIG. 36A.

FIG. 38 is a graph showing a relationship between the stress and the strain in a tensile test on the first electrode sheet.

FIG. 39 is a graph showing a relationship between the stress and the strain in a tensile test on the sensor sheet.

FIG. 40A is a partially enlarged plan view of the first electrode sheet at an elongation rate of 0%, FIG. 40B is a partially enlarged plan view of the first electrode sheet at an elongation rate of 10%, FIG. 40C is a partially enlarged plan view of the first electrode sheet at an elongation rate of 20%, and FIG. 40D is a partially enlarged plan view of the first electrode sheet at an elongation rate of 30%, in Sample 3-2.

FIG. 41 is a graph showing a relationship between the DC resistance value change rate and the strain of the sensor sheet.

FIG. 42 is a graph showing a relationship between the DC resistance value change rate and the number of repetitions in the case where a 10% elongation tensile test is repeatedly performed on the sensor sheet.

FIG. 43 is a graph showing a relationship between the DC resistance value change rate and the number of repetitions in the case where a 20% elongation tensile test is repeatedly performed on the sensor sheet.

FIG. 44 is a partially enlarged plan view showing a first electrode sheet of Embodiment 3-2.

FIG. 45 is a cross-sectional view taken along line E-E of FIG. 44.

FIG. 46 is a cross-sectional view taken along line F-F of FIG. 44.

FIG. 47 is a plan view showing a sensor sheet of Embodiment 3-2, schematically showing a weave pattern of multiple warp filament assemblies and multiple weft filament assemblies.

FIG. 48 is a cross-sectional view corresponding to a line E-E cross-section of FIG. 44, showing a first electrode sheet of Embodiment 3-3.

FIG. 49 is a cross-sectional view corresponding to a line F-F cross-section of FIG. 44, showing the first electrode sheet of Embodiment 3-3.

FIG. 50 is a partially enlarged plan view showing a first electrode sheet of Embodiment 3-4.

FIG. 51 is a partially enlarged plan view showing a first electrode sheet of Embodiment 3-5.

FIG. 52 is a partially enlarged plan view showing a first electrode sheet of Embodiment 3-6.

FIG. 53 is a partially enlarged plan view showing a first electrode sheet of Embodiment 3-7.

FIG. 54 is a plan view showing a sensor sheet of Embodiment 3-8.

FIG. 55 is a plan view showing a sensor sheet of Embodiment 3-9.

FIG. 56 is a cross-sectional view corresponding to the line B-B cross-section of FIG. 3, showing a first electrode sheet related to a modification example.

FIG. 57 is a plan view showing a sensor sheet of Embodiment 4-1.

FIG. 58 is a cross-sectional view taken along line B-B of FIG. 57.

FIG. 59A is a partially enlarged plan view showing a first electrode sheet of Example 4-1, and FIG. 59B is a partially enlarged plan view showing a second electrode sheet of Example 4-1.

FIG. 60 is a cross-sectional view taken along line C-C of FIG. 59A.

FIG. 61A is a partially enlarged plan view showing a first electrode sheet of Example 4-2, and FIG. 61B is a partially enlarged plan view showing a second electrode sheet of Example 4-2.

FIG. 62 is a graph showing a relationship between the stress and the strain in a tensile test on the first electrode sheet.

FIG. 63 is a graph showing a relationship between the stress and the strain in a tensile test on the sensor sheet.

FIG. 64A is a partially enlarged plan view of the first electrode sheet at an elongation rate of 0%, FIG. 64B is a partially enlarged plan view of the first electrode sheet at an elongation rate of 10%, FIG. 64C is a partially enlarged plan view of the first electrode sheet at an elongation rate of 20%, and FIG. 64D is a partially enlarged plan view of the first electrode sheet at an elongation rate of 30%, in Sample 4-2.

FIG. 65 is a graph showing a relationship between the DC resistance value change rate and the strain of the sensor sheet.

FIG. 66 is a graph showing a relationship between the DC resistance value change rate and the number of repetitions in the case where a 10% elongation tensile test is repeatedly performed on the sensor sheet.

FIG. 67 is a graph showing a relationship between the DC resistance value change rate and the number of repetitions in the case where a 20% elongation tensile test is repeatedly performed on the sensor sheet.

FIG. 68A is a partially enlarged plan view showing a first electrode sheet of a modification example of Embodiment 4-1, and FIG. 68B is a partially enlarged plan view showing a second electrode sheet of a modification example of Embodiment 4-1.

FIG. 69 is a cross-sectional view taken along line D-D of FIG. 68A.

FIG. 70 is a partially enlarged plan view showing a first electrode sheet in the case where a tensile test is performed on a modification example of Embodiment 4-1.

FIG. 71 is a cross-sectional view corresponding to the line B-B cross-sectional view in FIG. 57, showing a sensor sheet related to Embodiment 4-2.

FIG. 72 is a partially enlarged cross-sectional view showing the sensor sheet related to Embodiment 4-2.

FIG. 73 is a cross-sectional view corresponding to the line B-B cross-sectional view in FIG. 57, showing a sensor sheet related to Embodiment 4-3.

FIG. 74 is a partially enlarged cross-sectional view showing a sensor sheet related to Embodiment 4-3.

FIG. 75 is a cross-sectional view corresponding to the line B-B cross-sectional view in

FIG. 57, showing a sensor sheet related to Embodiment 4-4.

### DESCRIPTION OF THE EMBODIMENTS

Embodiments of the disclosure provide a sensor sheet in which a change in the electrical resistance value is suppressed, and a manufacturing method of the sensor sheet.

### Embodiment 1-1

### 1.1. Overview of Sensor Sheet and Steering Wheel

### 1.1.1. Overview of Sensor Sheet

A sensor sheet is of an electrostatic type and functions as a sensor that detects contact or approaching of a conductive body having an electric potential based on, for example, changes in an electrostatic capacitance between electrodes. Upon contact or approaching of a conductive body having an electric potential with respect to the sensor sheet, the electrostatic capacitance between the electrodes changes, and contact or approaching of the conductive body is detected by detecting a voltage corresponding to the changed electrostatic capacitance between the electrodes.

The sensor sheet is attached, for example, to a steering wheel of a vehicle to detect whether an occupant's hand (finger, palm, back of hand, etc.) contacts or approaches the steering wheel.

### 1.1.2. Overall Configuration of Steering Wheel 10

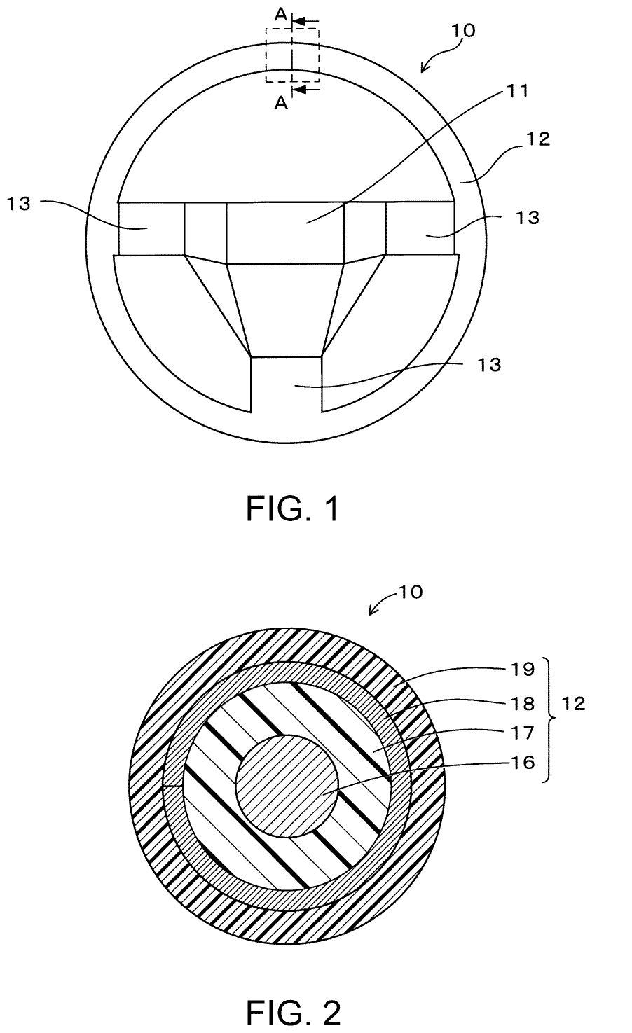

First, a structure of a steering wheel 10 will be described with reference to FIG. 1 to FIG. 2. As shown in FIG. 1, the steering wheel 10 includes a core part 11, a ring part 12, and multiple (three in the present embodiment) connecting parts 13 that connect between the core part 11 and the ring part 12.

The ring part 12 is formed in a circular ring shape. However, the ring part 12 is not limited to a circular shape and may be formed in any shape. As shown in FIG. 2, a cross-sectional shape of the ring part 12 perpendicular to an axis thereof is formed, for example, in a circular shape.

### 1.1.3. Detailed Configuration of Steering Wheel 10

A detailed configuration of the steering wheel 10 will be described with reference to FIG. 1 to FIG. 2. In particular, a detailed configuration of the ring part 12 will be described.

The ring part 12 includes a core body 16, a resin inner layer material 17, a sensor sheet 18, and a skin material 19. The core body 16 constitutes a central part of the ring part 12 and is formed in a shape corresponding to the shape of the ring part 12. That is, the core body 16 is formed in a circular ring shape and has a circular cross-section perpendicular to an axis thereof. Herein, the cross-sectional shape of the core body 16 perpendicular to the axis thereof is not limited to a circular shape and may be configured in any shape such as an elliptical shape, an oval shape, a U-shape, a C-shape, a polygonal shape, etc. In the present embodiment, the core body 16 is formed of a metal such as aluminum, magnesium, etc. and has conductivity. A material other than metal may be applied as the material of the core body 16.

The resin inner layer material 17 covers an outer surface of the core body 16 over an entire circumference of the ring shape of the core body 16 and over an entire circumference of the circular cross-sectional shape of the core body 16. In the present embodiment, a cross-section of the resin inner layer material 17 perpendicular to an axis thereof is formed in a circular shape. In the case where the core body 16 has a U-shaped cross-section perpendicular to the axis thereof, the resin inner layer material 17 is filled not only on a radially outer side of the cross-section of the core body 16 perpendicular to the axis thereof but is also filled in a U-shaped recess of the core body 16. The resin inner layer material 17 is formed by injection molding on the outer surface side of the core body 16 and is directly bonded to the outer surface of the core body 16. The cross-sectional shape of the resin inner layer material 17 perpendicular to the axis thereof is not limited to a circular shape and may be configured in any shape such as an oval shape, an elliptical shape, a polygonal shape, etc. The resin inner layer material 17 is formed, for example, of a foamed resin. The resin inner layer material 17 is formed using, for example, a foamed urethane resin. A non-foamed resin may also be used as the resin inner layer material 17.

The sensor sheet 18 is wrapped around an outer surface of the resin inner layer material 17. The sensor sheet 18 forms a C-shape in a state of being wrapped around the resin inner layer material 17. The sensor sheet 18 will be described in detail later.

The skin material 19 covers an outer surface of the sensor sheet 18 (a surface of the sensor sheet 18 on a side opposite to the resin inner layer material 17) over an entire circumference of the ring shape of the sensor sheet 18. That is, as will be described later, in the case where a first electrode sheet 25 is exposed on a first surface 27 side of an insulating sheet 24, the skin material 19 also functions as a covering material of the first electrode sheet 25. The skin material 19 is formed by injection molding and is wrapped around the outer surface side of the sensor sheet 18 to be bonded to the outer surface of the sensor sheet 18. The skin material 19 is formed, for example, of a urethane resin. An outer surface of the skin material 19 constitutes a design surface. A material of the skin material 19 is not particularly limited, and is preferably, for example, a non-foamed urethane resin or a slightly foamed urethane resin.

As another form of the skin material 19, leather or fabric may be used as the skin material 19 and wrapped around the outer surface side of the sensor sheet 18 to be bonded to the outer surface of the sensor sheet 18. To bond the skin material 19 and the sensor sheet 18, an adhesive material or an adhesive agent may be used, and furthermore, the skin material 19 may be sewn to cover around the steering wheel. In addition, the outer surface of the skin material 19 constitutes a design surface. The material of the skin material 19 is not particularly limited, and any material such as leather (natural leather, synthetic leather, etc.), fabric/rubber/resin, etc. may be selected, but the skin material 19 is preferably made of leather (natural leather, synthetic leather, etc.).

### 1.1.4. Overall Configuration of Sensor Sheet 18

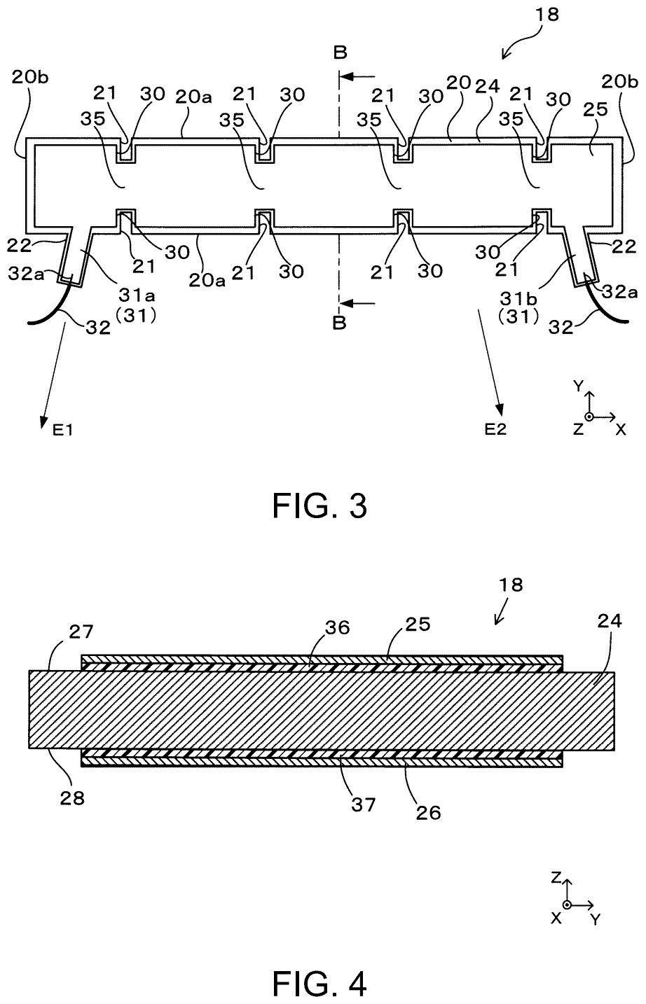

An overall configuration of the sensor sheet 18 of Embodiment 1-1 will be described with reference to FIG. 3 to FIG. 4. As shown in FIG. 3, the sensor sheet 18 is formed, as a whole, in a long shape in a longitudinal direction X. The sensor sheet 18 includes a sheet main body 20 formed in a rectangular shape as a whole. The sheet main body 20 includes a pair of long-side edges 20a extending along the longitudinal direction X, and a pair of short-side edges 20b extending in a direction intersecting the longitudinal direction X. In the following description, an arrow line X indicates the longitudinal direction of the sensor sheet 18, an arrow line Y indicates the intersecting direction intersecting the longitudinal direction, and an arrow line Z indicates a thickness direction of the sensor sheet 18.

Sheet recesses 21 recessed inward in the intersecting direction Y intersecting the longitudinal direction X are formed at the pair of long-side edges 20a of the sheet main body 20. The sheet recesses 21 are formed at positions including regions overlapping in the intersecting direction Y at the pair of long-side edges 20a of the sheet main body 20. However, the sheet recesses 21 may also be configured to be formed only at one of the pair of long-side edges 20a.

One long-side edge 20a is formed with multiple (four in the present embodiment) sheet recesses 21 arranged at intervals. However, one long-side edge 20a may also be formed with one sheet recess 21. In addition, one long-side edge 20a may also be formed with two to three or five or more sheet recesses 21.

At one of the pair of long-side edges 20a of the sheet main body 20, sheet extension parts 22 extending in a direction intersecting the longitudinal direction X from the one long-side edge 20a are formed at positions close to both ends of the sheet main body 20 in the longitudinal direction X.

FIG. 4 shows a cross-sectional view of the sensor sheet 18. The sensor sheet 18 includes an insulating sheet 24, a first electrode sheet 25, and a second electrode sheet 26. The first electrode sheet 25 and the second electrode sheet 26 have conductivity and are formed in a layer shape.

The first electrode sheet 25 is disposed on a first surface 27 side of the insulating sheet 24. Specifically, the first electrode sheet 25 is laminated on the first surface 27 of the insulating sheet 24. The first electrode sheet 25 is formed in a similar shape slightly smaller than the insulating sheet 24. Accordingly, end edges of the first surface 27 of the insulating sheet 24 are exposed from end edges of the first electrode sheet 25.

As shown in FIG. 3, in the first electrode sheet 25, recesses 30 recessed inward in the intersecting direction Y are formed at positions corresponding to the sheet recesses 21 of the sensor sheet 18. In the first electrode sheet 25, an extension part 31a extending in an extending direction E1 intersecting the longitudinal direction X and an extension part 31b extending in an extending direction E2 from a long-side edge extending along the longitudinal direction X of the first electrode sheet 25 are formed at positions corresponding to the sheet extension parts 22 of the sensor sheet 18. Core wires 32a exposed from ends of electric wires 32 are connected to the extension parts 31a and 31b. The core wires 32a and the extension parts 31a and 31b are electrically connected by a conventional method such as soldering, brazing, ultrasonic welding, etc. In the following description, in the case of not distinguishing between the extension part 31a and the extension part 31b, the extension part 31a and the extension part 31b may be referred to as an extension part 31.

As shown in FIG. 4, the second electrode sheet 26 is disposed on a second surface 28 side of the insulating sheet 24. Specifically, the second electrode sheet 26 is laminated on the second surface 28 of the insulating sheet 24. The second electrode sheet 26 is formed in a similar shape slightly smaller than the insulating sheet 24. Accordingly, end edges of the second surface 28 of the insulating sheet 24 are exposed from end edges of the second electrode sheet 26.

The first electrode sheet 25 and the second electrode sheet 26 may be of a same shape and a same size, or one may be in a similar shape slightly larger than the other. In the present embodiment, the first electrode sheet 25 and the second electrode sheet 26 have a substantially identical configuration.

Since the second electrode sheet 26 has a configuration substantially identical to the first electrode sheet 25, in the following description, repeated descriptions may be omitted.

The insulating sheet 24 is configured to have flexibility and to be capable of being elongated in a surface direction. The insulating sheet 24 may be formed to include, for example, a foamable resin as a main component, or may be formed to include an elastomer as a main component. Thus, the insulating sheet 24 is flexible.

In the case where the insulating sheet 24 is formed to include a foamable resin as a main component, the insulating sheet 24 may be manufactured from, for example, a foamed body of resin or elastomer. The elastomer includes crosslinked rubber and thermoplastic elastomer. For example, in addition to a urethane foam, examples may include a polystyrene foam, a polyethylene foam, a polypropylene foam, a polyolefin foamed body, an ethylene-vinyl acetate copolymer (EVA) foam, a PET foam, a phenol foam, an ethylene propylene diene rubber (EPDM) foam, a silicone foam, a polyvinyl chloride foam, an acrylic foam, a polyimide foam, a polylactic acid-based resin foamed body, a melamine foam, a polymethacrylimide foam, a fluororesin foam, etc.

In the case where the insulating sheet 24 is formed to include, for example, a thermoplastic material, particularly a thermoplastic elastomer, as a main component, the insulating sheet 24 may be formed by the thermoplastic elastomer itself, or may be formed to include, as a main component, an elastomer crosslinked by heating the thermoplastic elastomer as a material.

In addition, the insulating sheet 24 may include a rubber other than the thermoplastic elastomer, a resin, another material, etc. For example, in the case where the insulating sheet 24 includes rubber such as ethylene-propylene rubber (EPM, EPDM), flexibility of the insulating sheet 24 is improved. From the viewpoint of improving flexibility of the insulating sheet 24, a flexibility-imparting component such as a plasticizer may be included in the insulating sheet 24. Furthermore, the insulating sheet 24 may also be configured to include a reaction-curable elastomer or a thermosetting elastomer as a main component.

Furthermore, a material with good thermal conductivity is preferable as the insulating sheet 24. Thus, the insulating sheet 24 may be formed using a thermoplastic elastomer with high thermal conductivity, or may include a filler capable of enhancing thermal conductivity. In addition, the insulating sheet 24 may be configured with a foamed structure having fine air layers. Furthermore, the insulating sheet 24 may be configured to have perforations (regular physical holes represented by perforated holes) or slits (cuts, notches).

The first electrode sheet 25 is disposed on the first surface 27 of the insulating sheet 24, i.e., on an upper surface (upper surface in FIG. 4) side of the insulating sheet 24, and the second electrode sheet 26 is disposed on the second surface 28 of the insulating sheet 24, i.e., on a lower surface (lower surface in FIG. 4) side of the insulating sheet 24. At least the first electrode sheet 25 constitutes a detection electrode. The first electrode sheet 25 and the second electrode sheet 26 have conductivity. Furthermore, the first electrode sheet 25 and the second electrode sheet 26 are flexible. In other words, the first electrode sheet 25 and the second electrode sheet 26 are configured to have flexibility and to be capable of being elongated in the surface direction.

### 1.1.5. Bonding Structure of First Electrode Sheet 25 and Second Electrode Sheet 26 with Insulating Sheet 24

As shown in FIG. 4, the first electrode sheet 25 is bonded to the first surface 27 side of the insulating sheet 24 by a first bonding part 36. A material constituting the first bonding part 36 is not particularly limited, and may be appropriately selected from any material such as, for example, an acrylic adhesive, a silicone adhesive, a urethane adhesive, a rubber-based adhesive, etc. In addition, as shown in FIG. 4, the second electrode sheet 26 is bonded to the second surface 28 side of the insulating sheet 24 by a second bonding part 37. Since a material constituting the second bonding part 37 is the same as that of the first bonding part 36, repeated descriptions will be omitted.

### 1.1.6. Configuration of Electrode Sheet

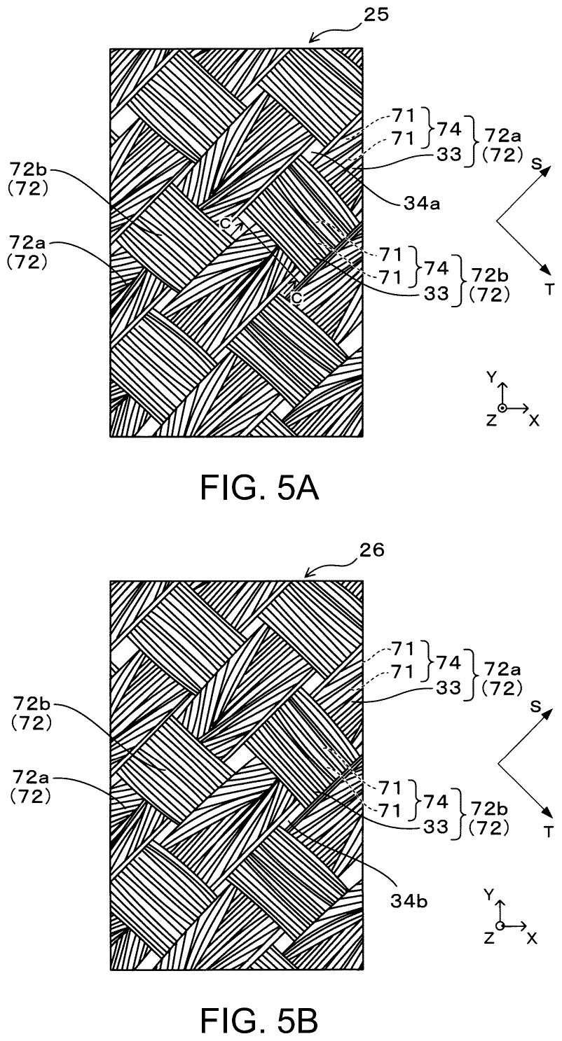

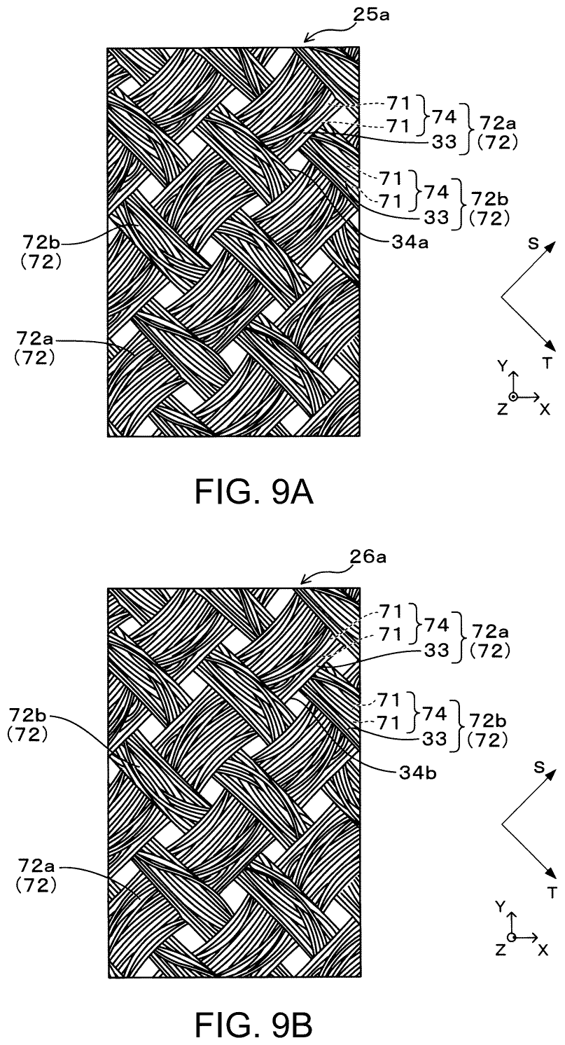

A configuration of the electrode sheet will be described with reference to FIG. 5A to FIG. 5B and FIG. 9A to FIG. 9B. First electrode sheets 25 and 25a shown in FIG. 5A to FIG. 5B and second electrode sheets 26 and 26a shown in FIG. 9A to FIG. 9B are conductive cloths having conductivity. The first electrode sheets 25 and 25a and the second electrode sheets 26 and 26a have both conductivity and flexibility. The first electrode sheets 25 and 25a and the second electrode sheets 26 and 26a have stretchability in the longitudinal direction X and the intersecting direction Y.

The first electrode sheet 25 and the second electrode sheet 26 are conductive cloths woven with multiple filament assemblies 72. The filament assembly 72 includes multiple filaments 71 and a plating layer 33 formed on at least a part of a surface of the filament 71.

As shown in FIG. 5A to FIG. 5B and FIG. 9A to FIG. 9B, the first electrode sheets 25 and 25a and the second electrode sheets 26 and 26a are manufactured by forming the plating layer 33 on a base fabric woven with multiple non-twisted bundles 74. Each non-twisted bundle 74 is formed by bundling multiple filaments 71 in an untwisted state.

Examples of a resin constituting the filament 71 may include, for example, polyolefin such as polyethylene and polypropylene, polyester such as polyethylene terephthalate and polybutylene terephthalate, and polyamide such as nylon 6 and nylon 6,6. However, the resin constituting the filament 71 is not limited to the above, and any resin may be selected as appropriate. The second electrode sheet 26 also includes the same configuration.

A method of forming the plating layer 33 is not particularly limited, may be, for example, electroplating, may be electroless plating, may be electroplating performed after performing electroless plating, or may be electroless plating performed after performing electroplating, and any method may be selected as appropriate.

Any metal or alloy, such as copper, nickel, tin, solder, etc., may be appropriately selected as a metal constituting the plating layer 33 formed on the surface of the base fabric. The plating layer 33 formed on the surface of the base fabric may be composed of one metal species or may be composed of multiple metal species. For example, copper alone may be plated on the surface of the base fabric, nickel alone may be plated on the surface of the base fabric, or a copper plating layer composed of copper may be formed on the surface of the base fabric and a nickel plating layer composed of nickel may be formed on the surface of the copper plating layer. The plating layer 33 formed on the surface of the base fabric may be formed by electroplating or may be formed by electroless plating. The second electrode sheet 26 also includes the same configuration.

As shown in FIG. 5A and FIG. 9A, the first electrode sheets 25 and 25a include first openings 34a that are opened between the multiple filament assemblies 72. The first openings 34a penetrate through the first electrode sheet 25. A first opening ratio, which is a ratio of an opening area of the first openings 34a formed in the first electrode sheets 25 and 25a to an area of the first electrode sheets 25 and 25a, is 1% or more and 40% or less.

As shown in FIG. 5B and FIG. 9B, the second electrode sheets 26 and 26a include second openings 34b that are opened between the multiple filament assemblies 72. The second openings 34b penetrate through the second electrode sheet 26. A second opening ratio, which is a ratio of an opening area of the second openings 34b formed in the second electrode sheets 26 and 26a to an area of the second electrode sheets 26 and 26a, is 1% or more and 40% or less.

### 1.1.7. Examples, Comparative Examples, and Samples

### 1.1.7.1. Example 1-1 and Sample 1-1

### Example 1-1 and Sample 1-1

Example 1-1 will be described with reference to FIG. 5A to FIG. 8. As shown in FIG. 5A, the first electrode sheet 25 related to Example 1-1 is a conductive cloth woven with multiple filament assemblies 72. The multiple filament assemblies 72 include a non-twisted bundle 74 in which multiple filaments 71 are bundled in an untwisted state, and a plating layer 33 formed on at least a part of the surface of the non-twisted bundle 74. The filament assembly 72 is formed in a shape that is flat in the thickness direction of the first electrode sheet 25b.

The first electrode sheet 25 related to the present Example 1-1 is formed by weaving a warp, in which multiple filaments 71 are bundled in an untwisted state, and a weft, in which multiple filaments 71 are bundled in an untwisted state, to form the base fabric, and forming the plating layer 33 on the surface of the base fabric. However, the manufacturing method of the first electrode sheet 25 is not limited to the above method.

As shown in FIG. 5A, the first electrode sheet 25 of the present embodiment includes multiple warp filament assemblies 72a and multiple weft filament assemblies 72b. The first electrode sheet 25 includes first openings 34a that are opened between the multiple filament assemblies 72. The first openings 34a penetrate through the first electrode sheet 25. In the present Example 1-1, an opening ratio, which is a ratio of the opening area of the first openings 34a formed in the first electrode sheet 25 to the area of the first electrode sheet 25, is about 3%. The opening ratio is a ratio of a total opening area of the multiple first openings 34a formed in a target region of the first electrode sheet 25 to an area of the target region of the first electrode sheet 25. The opening ratio is calculated, for example, by specifying a 10 mm×10 mm target region in the first electrode sheet 25, totaling the areas of the first openings 34a within the target region, and dividing the total area by the area of the target region.

As shown in FIG. 5B, the second electrode sheet 26 of the present embodiment includes multiple warp filament assemblies 72a and multiple weft filament assemblies 72b. The second electrode sheet 26 of the present embodiment includes second openings 34b that are opened between the multiple filament assemblies 72. The second openings 34b penetrate through the second electrode sheet 26. In the present Example 1-1, an opening ratio, which is a ratio of the opening area of the second openings 34b formed in the second electrode sheet 26 to the area of the second electrode sheet 26 of the present embodiment, is about 3%.

The number of the filaments 71 included in the filament assembly 72 constituting the first electrode sheet 25 is not particularly limited. The filament assembly 72 related to the present embodiment include 75 filaments 71, but the number may be any number.

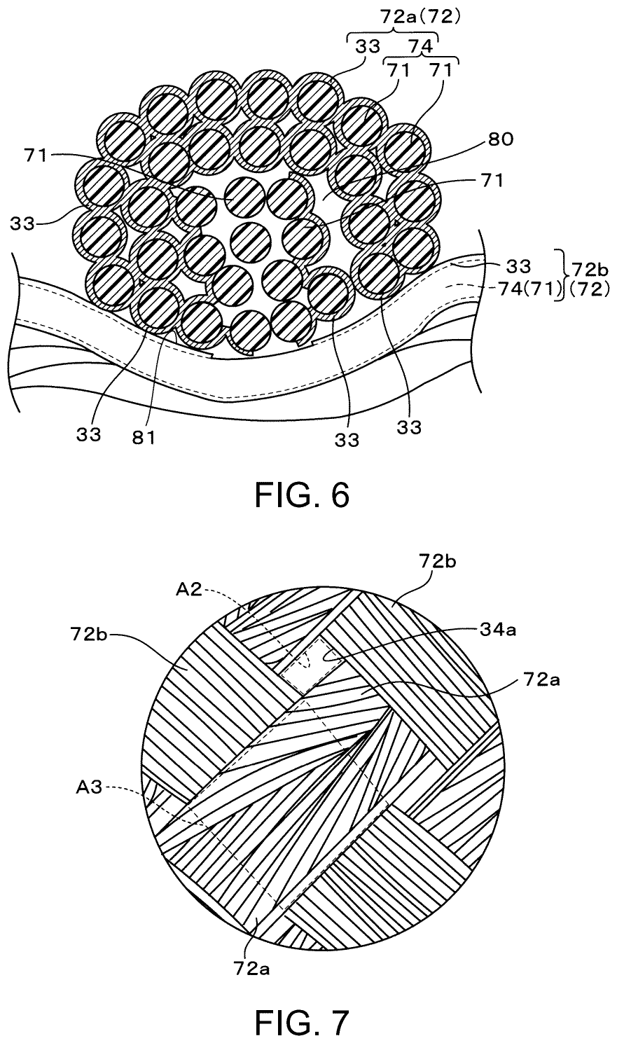

As shown in FIG. 6, the plating layer 33 is formed on at least a part of a surface of a twisted wire 73 constituting the filament assembly 72. The warp filament assembly 72a and the weft filament assembly 72b are electrically connected by contact between the plating layer 33 of the warp filament assembly 72a and the plating layer 33 of the weft filament assembly 72b.

As shown in FIG. 5A, a longitudinal direction S of the multiple warp filament assemblies 72a and the longitudinal direction X of the first electrode sheet 25 are configured to intersect each other In addition, a longitudinal direction T of the multiple weft filament assemblies 72b and the longitudinal direction X of the first electrode sheet 25 are configured to intersect each other. Specifically, the longitudinal direction S of the multiple warp filament assemblies 72a forms an acute angle that is substantially 45° with respect to the longitudinal direction X of the first electrode sheet 25. In addition, the longitudinal direction T of the multiple weft filament assemblies 72b forms an acute angle that is substantially 45° with respect to the longitudinal direction X of the first electrode sheet 25a. “An angle being substantially 45°” includes cases where the angle is 45°, and also includes cases where the angle can be considered substantially 45°.

In the case where the longitudinal direction S of a warp 41 is parallel to the longitudinal direction X of the first electrode sheet 25 (in the case where the acute angle is substantially 0°), upon stretching the first electrode sheet 25 in a direction parallel to the direction X, the warp 41 itself is extended, and a large load is required.

In contrast, in the case where the longitudinal direction S of the warp 41 is inclined at an inclination of 45° with respect to the longitudinal direction X of the first electrode sheet 25 (i.e., in the case where the acute angle is substantially 45°), upon stretching the first electrode sheet 25 in a direction parallel to the longitudinal direction X, square or rectangular grids composed of wefts 42 and warps 41 deform into a rhombic shape, and since the warp 41 or the weft 42 itself is not extended, a large load is not required. In other words, in the case where the acute angle is substantially 45°, structural flexibility is imparted. Furthermore, the higher the opening ratio is, the more easily the square or rectangular grids deform into a rhombic shape, and the less likely it is for structural flexibility to be compromised.

However, the longitudinal direction S of the multiple warp filament assemblies 72a may also form an acute angle that is different from 45° with respect to the longitudinal direction X of the first electrode sheet 25. In addition, the longitudinal direction T of the multiple weft filament assemblies 72b may also form an acute angle that is different from 45° with respect to the longitudinal direction X of the first electrode sheet 25.

The number of the multiple filaments 71 constituting the warp filament assembly 72a and the number of the multiple filaments 71 constituting the weft filament assembly 72b may be the same as or different from each other. In the present Embodiment 1-1, the number of the multiple filaments 71 constituting the warp filament assembly 72a and the number of the multiple filaments 71 constituting the weft filament assembly 72b are set to be substantially the same. “Substantially the same” includes case where the numbers are the same, and also includes cases where the numbers, although not the same, can be considered substantially the same. Since the above also applies to the weft filament assembly 72b, repeated descriptions will be omitted.

As shown in FIG. 6, the warp filament assembly 72a is composed of multiple filaments 71. The warp filament assembly 72a includes an internal space 80 formed in at least a part between the filaments 71 adjacent to each other. The multiple filaments 71 are disposed in each of the surface direction of the sheet surface of the first electrode sheet 25 and a normal direction of the sheet surface.

The internal space 80 is formed in at least a part between the filaments 71 adjacent to each other in the surface direction of the sheet surface of the first electrode sheet 25, and in at least a part between the filaments 71 adjacent to each other in the normal direction of the sheet surface of the first electrode sheet 25. However, the internal space 80 may also be formed only in at least a part between the filaments 71 adjacent to each other in the surface direction of the sheet surface of the first electrode sheet 25, or may also be formed only in at least a part between the filaments 71 adjacent to each other in the normal direction of the sheet surface of the first electrode sheet 25.

The plating layer 33 is formed on at least a part of a portion of the surface of the filament 71 that is exposed to the internal space 80. At a portion of the surface of the filament 71 that is exposed to the internal space 80 and is not formed with the plating layer 33, the surface of the filament 71 is exposed.

As shown in FIG. 6, the plating layer 33 is formed at at least a part of a non-exposed portion 81 at which the warp filament assembly 72a and the weft filament assembly 72b are opposed to and intersect each other. In contrast, at a portion of the surface of the filament 71 that is exposed to the non-exposed portion 81 and is not formed with the plating layer 33, the surface of the filament 71 is exposed.

At the portion at which the warp filament assembly 72a and the weft filament assembly 72b intersect each other, the plating layer 33 is formed at at least a part of the portion at which the filament 71 exposed on an outer surface of the warp filament assembly 72a and the filament exposed on an outer surface of the weft filament assembly 72b are opposed to each other. At the portion at which the plating layer 33 is not formed, the outer surface of the filament 71 is exposed.

At the portion at which the warp filament assembly 72a and the weft filament assembly 72b are opposed to and intersect each other, the plating layer 33 is formed at a part, and at the portion at which the plating layer 33 is not formed, the surface of the filament 71 is exposed. Of the portion at which the warp filament assembly 72a and the weft filament assembly 72b are opposed to and intersect each other, the plating layer 33 is formed in a region close to the portion exposed to outside, and at the portion close to inside, a portion formed with the plating layer 33 and a portion not formed with the plating layer 33 are both present.

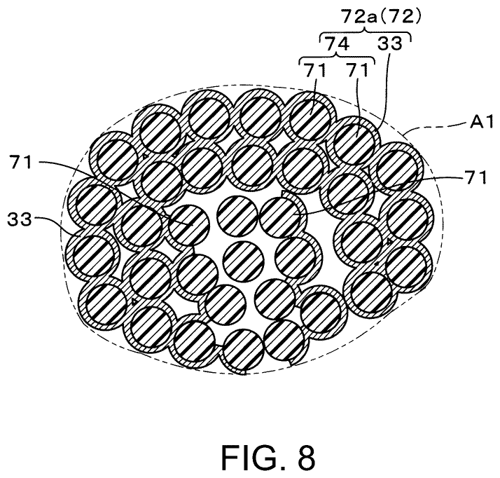

As shown in FIG. 8, a cross-sectional area A1 of each warp filament assembly 72a is larger than an opening area A2 of the first opening 34a in a state in which no strain is generated in the first electrode sheet 25 as shown in FIG. 7. The cross-sectional area A1 of the warp filament assembly 72a refers to a cross-sectional area formed by an outer contour line of the warp filament assembly 72a. Hereinafter, the same also applies to the weft filament assembly 72b. In addition, although not shown in detail, a cross-sectional area A1 of each weft filament assembly 72b is larger than the opening area A2 of the first opening 34a in a state in which no strain is generated in the first electrode sheet 25. In addition, although not shown in detail, in the second electrode sheet 26, a cross-sectional area A1 of each warp filament assembly 72a and a cross-sectional area A1 of each weft filament assembly 72b are larger than an opening area A2 of the second opening 34b in a state in which no strain is generated in the second electrode sheet 26.

As shown in FIG. 7, upon viewing from the thickness direction of the first electrode sheet 25, an intersection area A3, which is an area of a portion at which the warp filament assembly 72a and the weft filament assembly 72b intersect each other, is larger than the opening area A2 of the first opening 34a shown in FIG. 7. In addition, although not shown in detail, upon viewing from the thickness direction of the second electrode sheet 26, an intersection area A3, which is an area of a portion at which the warp filament assembly 72a and the weft filament assembly 72b intersect each other, is larger than the opening area A2 of the second opening 34b.

Since the above also applies to the weft filament assembly 72b, repeated descriptions will be omitted.

In the present Embodiment 1-1, the resin constituting the filament 71 is polyethylene terephthalate (PET), and a diameter of the filament 71 is about 10 μm. The metal constituting the plating layer 33 is formed in a three-layer structure, with an outermost layer being Ni, an intermediate layer being Cu, and an innermost layer (filament 71 side) being Ni. A diameter of the warp filament assembly 72a is about 185 μm, and a diameter of the weft filament assembly 72b is about 185 μm.

As shown in FIG. 4, the first electrode sheet 25 described above is bonded to the first surface 27 of the insulating sheet 24 via the first bonding part 36. In addition, the second electrode sheet 26, which includes the same configuration as the first electrode sheet 25, is bonded to the second surface 28 of the insulating sheet 24 via the second bonding part 37. The insulating sheet 24 is an ether-based polyurethane foamed body. The first bonding part 36 is an acrylic adhesive manufactured by Nogawa Chemical Co., Ltd. A thickness of the first bonding part 36 is 50 μm. Since the first bonding part 36 and the second bonding part 37 are identical, repeated descriptions will be omitted. In this manner, Sample 1 of the sensor sheet 18 related to the first electrode sheet 25 and the second electrode sheet 26b of Example 1-1 is prepared.

### 1.1.7.2. Example 1-2 and Sample 1-2

### Example 1-2 and Sample 1-2

Next, configurations of the first electrode sheet 25a and the second electrode sheet 26a related to Example 1-2 will be described with reference to FIG. 9A to FIG. 9B. In the first electrode sheet 25a related to the present Example 1-2, the number of the filaments 71 constituting the warp filament assembly 72a and the number of the filaments 71 constituting the weft filament assembly 72b are different from each other. In the present Example 1-2, the number of the filaments 71 constituting the warp filament assembly 72a is greater than the number of the filaments 71 constituting the weft filament assembly 72b. However, the number of the filaments 71 constituting the warp filament assembly 72a may also be configured to be less than the number of the filaments 71 constituting the weft filament assembly 72b.

In the present Example 1-2, the number of the filaments 71 constituting the warp filament assembly 72a is set to be about twice the number of the filaments 71 constituting the weft filament assembly 72b. However, the difference between the number of the filaments 71 constituting the warp filament assembly 72a and the number of the filaments 71 constituting the weft filament assembly 72b is not limited to the above.

Since the second electrode sheet 26a has the same configuration as the first electrode sheet 25a, repeated descriptions will be omitted.

In the present Example 1-2, the resin constituting the filament 71 is polyethylene terephthalate (PET), and the diameter of the filament 71 is about 10 μm. The metal constituting the plating layer 33 is one layer of Ni. The diameter of the warp filament assembly 72a is about 180 μm, and the diameter of the weft filament assembly 72b is about 90 μm.

Since configurations other than the above are the same as those in Example 1-1, repeated descriptions will be omitted.

In addition, in the present Sample 1-2, the insulating sheet 24 is an ether-based polyurethane foamed body. The first bonding part 36 is an acrylic adhesive. The thickness of the first bonding part 36 is about 50 μm. Since the first bonding part 36 and the second bonding part 37 are identical, repeated descriptions will be omitted. Except for the above, Sample 1-2 of the sensor sheet 18 related to the first electrode sheet 25a and the second electrode sheet 26a of Example 1-2 is prepared in the same manner as Sample 1-1. Descriptions overlapping with Sample 1-1 will be omitted.

### 1.1.7.3. Comparative Example 1-1 and Sample 1-3

### Comparative Example 1-1 and Sample 1-3

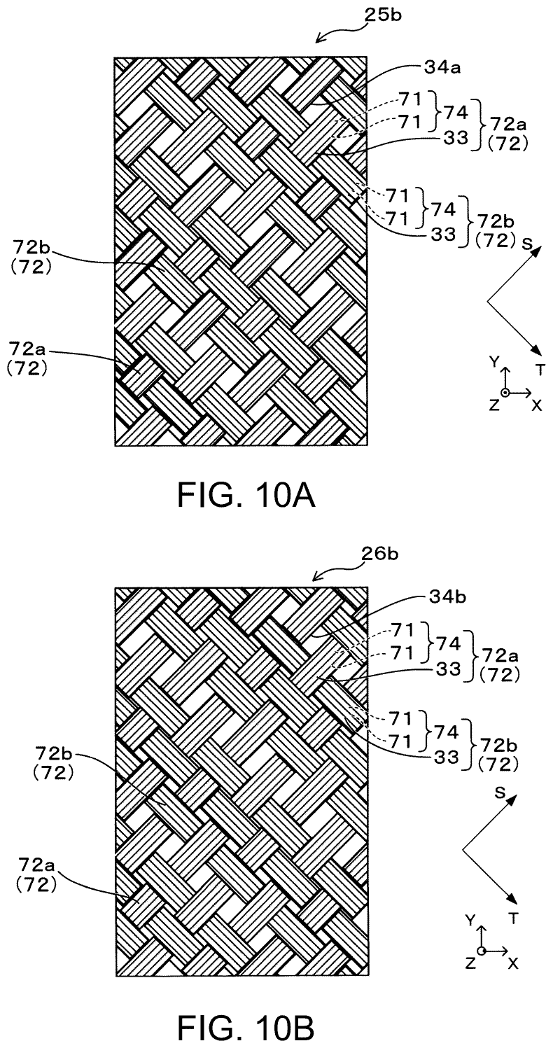

Next, Comparative Example 1-1 will be described with reference to FIG. 10A to FIG. 10B. The warp filament assembly 72a and the weft filament assembly 72b related to Comparative Example 1-1 include 6 filaments 71.

As shown in FIG. 10A, the first electrode sheet 25b of the present embodiment includes multiple warp filament assemblies 72a and multiple weft filament assemblies 72b. The first electrode sheet 25b includes first openings 34a that are opened between the multiple filament assemblies 72. The first openings 34a penetrate through the first electrode sheet 25b. In the present Comparative Example 1-1, an opening ratio, which is a ratio of the opening area of the first openings 34a formed in the first electrode sheet 25b to the area of the first electrode sheet 25b, is 20%.

As shown in FIG. 10B, the second electrode sheet 26b of the present embodiment includes multiple warp filament assemblies 72a and multiple weft filament assemblies 72b. The second electrode sheet 26b of the present embodiment includes second openings 34b that are opened between the multiple filament assemblies 72. The second openings 34b penetrate through the second electrode sheet 26b. In the present Comparative Example 1-1, an opening ratio, which is a ratio of the opening area of the second openings 34b formed in the second electrode sheet 26b to the area of the second electrode sheet 26 of the present embodiment, is 20%.

In the present Comparative Example 1-1, the resin constituting the filament 71 is polyethylene terephthalate (PET), and the diameter of the filament 71 is 10 to 20 μm. The metal constituting the plating layer 33 is formed in a three-layer structure, with the outermost layer being Ni, the intermediate layer being Cu, and the innermost layer (filament 71 side) being Ni. The diameter of the warp filament assembly 72a is about 70 μm, and the diameter of the weft filament assembly 72b is about 70 μm.

Since configurations other than the above are the same as those in Embodiment 1-1, repeated descriptions will be omitted.

In addition, in the present Comparative Example 1-1, the insulating sheet 24 is an ether-based polyurethane foamed body. The first bonding part 36 is an acrylic adhesive manufactured by Nogawa Chemical Co., Ltd. The thickness of the first bonding part 36 is 50 μm. Since the first bonding part 36 and the second bonding part 37 are identical, repeated descriptions will be omitted. Sample 1-3 of the sensor sheet 18 related to the first electrode sheet 25b and the second electrode sheet 26b is prepared in the same manner as Sample 1-1. Descriptions overlapping with Sample 1-1 will be omitted.

### 1.1.7.4. Tensile Test of First Electrode Sheet

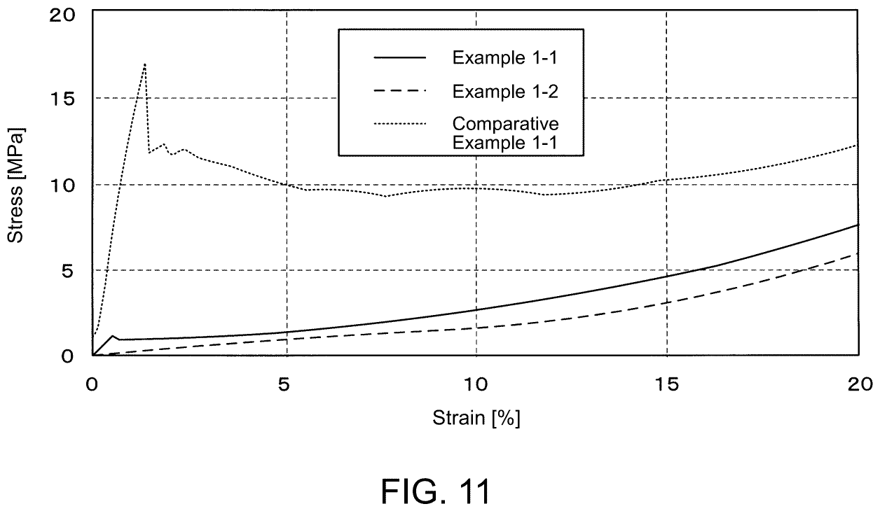

Next, a tensile test performed on the first electrode sheet will be described with reference to FIG. 11. Test pieces were prepared by cutting the first electrode sheets related to Examples 1-1 to 1-2 and Comparative Example 1-1 into a strip shape of 150 mm×20 mm. The thickness of the first electrode sheet is different among Examples 1-1 to 1-2 and Comparative Example 1-1 but is about 0.1 mm. The angle formed between the longitudinal direction of the test piece and the longitudinal direction of the warp filament assembly 72a is set to 45°.

The test piece is held by a pair of chucks. A distance between the pair of chucks is 70 mm. The tensile test is performed on the test piece at a tensile speed of 1 mm/sec, and a stress is calculated by dividing a load by a cross-sectional area of the test piece. The tensile testing machine is AGS-X 1 kN manufactured by Shimadzu Corporation. The tensile test is performed in a range with a strain being 0 to 20%. FIG. 11 is a graph showing changes in the stress with respect to the strain.

In Example 1-1 and Example 1-2, in a region with the strain being 0 to 20%, the stress increased gradually and monotonically. In the stress-strain curve in the tensile test, Example 1-1 and Example 1-2 do not have a yield point showing a local maximum value in a range with the strain being 0.5 to 10%.

Example 1-1 shows a stress of about 1.4 MPa at a strain of 5%, and shows a stress of about 7.5 MPa at a strain of 20%. Example 1-2 shows a stress of about 0.9 MPa at a strain of 5%, and shows a stress of about 5.9 MPa at a strain of 20%. In the first electrode sheets 25 and 25a related to Example 1-1 and Example 1-2, a maximum value of the stress at a strain of 0 to 5% is 3 MPa or less, and a maximum value of the stress at a strain of 0 to 20% is 15 MPa or less.

In the stress-strain curve in the tensile test, Comparative Example 1-1 has a yield point showing a local maximum value in a range with the strain being 0.5 to 10%. In a region with the strain being 0 to about 1%, the stress increased linearly and monotonically. At a strain of about 1%, the stress showed about 17 MPa which is a local maximum value, and rapidly decreased to about 12 MPa. In this manner, in Comparative Example 1-1, before and after the strain of about 1%, the stress changed from an increasing trend to a decreasing trend. Thereafter, in a region with the strain being about 1 to about 13%, the stress monotonically decreased from about 12 to about 10 MPa. Thereafter, in a region with the strain being about 13 to 20%, the stress monotonically increased from about 10 to about 12 MPa. In this manner, in Comparative Example 1-1, in the stress-strain curve, the maximum value of the stress at a strain of 0 to 5% is greater than 3 MPa, and the maximum value of the stress at a strain of 0 to 20% is greater than 15 MPa.

### 1.1.7.5. Tensile Test of Sensor Sheet

Next, a tensile test performed on the sensor sheet will be described. Test pieces are prepared by cutting the sensor sheets related to Samples 1-1 to 1-2 and Sample 1-3 into a strip shape of 90 mm×20 mm. The thickness of the sensor sheets is different among Samples 1-1 to 1-2 and Sample 1-3 but is about 1 mm. The angle formed between the longitudinal direction of the test piece and the longitudinal direction of the warp filament assembly 72a constituting the first electrode sheet and the second electrode sheet is set to 45°.

An electric wire is connected to one end of the first electrode sheet in the longitudinal direction and is connected to a DC power supply. An electric wire is connected to the other end of the first electrode sheet in the longitudinal direction and is connected to a voltage measuring instrument.

The test piece is held by a pair of chucks. The distance between the pair of chucks is 50 mm. The tensile test is performed on the test piece at a tensile speed of 1 mm/sec, and a stress is calculated by dividing a load by a cross-sectional area of the test piece. In addition, during the tensile test, a DC resistance value (an example of an electrical resistance value) of the sensor sheet is calculated from a voltage of the DC power supply and a voltage drop of the sensor sheet.

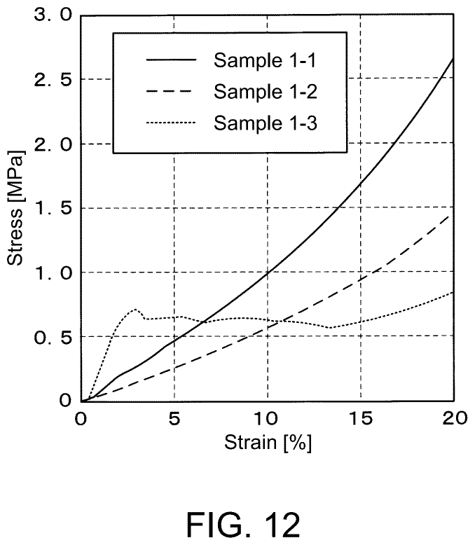

FIG. 12 shows a stress-strain curve in the tensile test performed on the sensor sheet. FIG. 12 shows a graph of a region with the strain being 0 to 20%. The stress of Samples 1-1 to 1-2 increased monotonically in the region with the strain being 0 to 20%. In the stress-strain curve in the tensile test, Sample 1-1 and Sample 1-2 do not have a yield point showing a local maximum value in a range with the strain being 0.5 to 10%.

Sample 1-1 shows a stress of about 0.5 MPa at a strain of 5%, and shows about 2.6 MPa, which is a maximum value of the stress, at a strain of 20%. Sample 1-2 shows a stress of about 0.3 MPa at a strain of 5%, and shows about 1.5 MPa, which is a maximum value of the stress, at a strain of 20%. In Sample 1-1 and Sample 1-2, in the stress-strain curve, the maximum value of the stress at a strain of 0 to 5% is 0.5 MPa or less, and the maximum value of the stress at a strain of 0 to 20% is 3 MPa or less.

In Sample 1-1 and Sample 1-2, in the stress-strain curve, the stress at a strain of 0 to 5% is 0.5 MPa or less, and the maximum value of the stress at a strain of 0 to 20% is 3 MPa or less.

In the stress-strain curve in the tensile test, Sample 1-3 has a yield point showing a local maximum value in a range with the strain being 0.5 to 10%. In a region with the strain being 0 to about 3%, the stress increased linearly and monotonically. At a strain of about 3%, the stress showed about 0.7 MPa which is a local maximum value, and rapidly decreased to about 0.6 MPa. In this manner, in Sample 1-3, before and after the strain of about 3%, the stress changed from an increasing trend to a decreasing trend. Thereafter, in a region with the strain being about 1 to about 13%, the stress decreased slightly. Thereafter, in a region with the strain being about 13 to 20%, the stress increased monotonically from about 0.6 to about 0.8 MPa. In this manner, in Sample 1-3, in the stress-strain curve, the maximum value of the stress at a strain of 0 to 5% is greater than 0.5 MPa, and the maximum value of the stress at a strain of 0 to 20% is greater than 0.7 MPa.

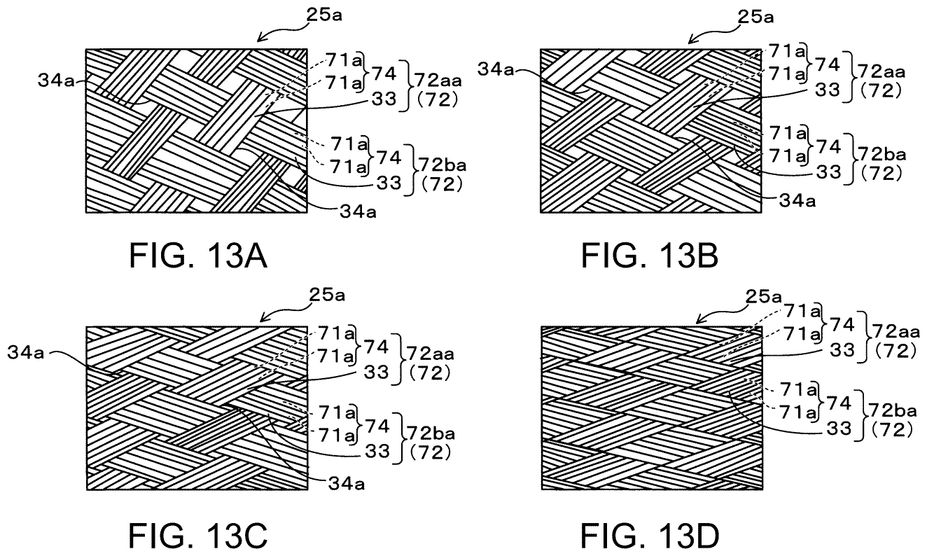

Upon application of a tensile force to Sample 1-1 and Sample 1-2, the first openings 34a of the first electrode sheet elongate in the tensile direction and contract in a direction intersecting the tensile direction. FIG. 13A to FIG. 13D show states of deformation of the first openings 34a, taking Sample 1-2 as an example. As shown in FIG. 13A, in the state of an elongation rate of 0%, the first openings 34a are open, but as the elongation rate increases to 10% (refer to FIG. 13B), 20% (refer to FIG. 13C), and 30% (refer to FIG. 13D), the gaps between the fibers of the conductive cloth decrease, and in the state of the elongation rate of 30%, the first openings 34a almost disappear. It is thought that since stretching readily occurs due to such changes in the fiber shape, the stress generated during stretching is small. In other words, it is thought that the presence of the first openings 34a contributes to the expression of such structural stretchability and flexibility of the fibers. Since the above configuration is the same in the second electrode sheet, descriptions will be omitted. Since the same also applies to Sample 1-1, descriptions will be omitted.

Since Sample 1-2 has an opening ratio larger than Sample 1-1, structural stretchability and flexibility is exerted due to a decrease in the opening area associated with spatial arrangement changes in the entire filaments 71 during stretching. Thus, the stress generated is smaller than in Sample 1-1.

It is thought that the smaller the stress generated is, the smaller the tensile strain applied to the filament 71 itself is. Thus, compared to Sample 1-1, Sample 1-2 is expected to be capable of suppressing damage to the plating layer 33 formed on the surface of the filaments 71, and capable of suppressing a change in the electrical resistance value even in the case where a tensile force is applied to the sensor sheet 18.

In Sample 1-1 and Sample 1-2, it is thought that, in the case where a tensile force is applied to the sensor sheet, the tensile force is absorbed by gradual deformation of the first openings 34a. Accordingly, at the portion at which the warp filament assembly 72a and the weft filament assembly 72b intersect each other, it is thought that since relative positions between the warp filament assembly 72a and the weft filament assembly 72b do not change much, an electrical connection state between the warp filament assembly 72a and the weft filament assembly 72b is maintained. Accordingly, in Sample 1-1 and Sample 1-2, it is thought that the DC resistance value hardly changes even in the case where a tensile force is applied to the sensor sheet.

In addition, Sample 1-1 and Sample 1-2 do not have a yield point showing a local maximum value in a range with the strain being 0.5 to 5%. This is thought to be because, in Sample 1-1 and Sample 1-2, in the range with the strain being 0.5 to 5%, no significant change occurs in the structure of the plating layer 33 formed on the first electrode sheet and the second electrode sheet. Accordingly, a change in the electrical resistance value of the sensor sheet 18 is suppressed.

In contrast, Sample 1-3 has a yield point showing a local maximum value in the range with the strain being 0.5 to 5%. In Sample 1-3, in a range from the strain of 0% to the yield point, it is thought that elastic deformation occurs by maintaining of the plating layer 33 formed at the portion at which the warp filament assembly 72a and the weft filament assembly 72b intersect each other. Thereafter, it is thought that, at the yield point, the plating layer 33 formed at the portion at which the warp filament assembly 72a and the weft filament assembly 72b intersect each other is destroyed.

Thereafter, in a range in which the stress does not change much (a range with the strain being about 5 to about 15%), it is thought that the tensile force is absorbed by deformation of the first openings 34a and the second openings 34b, in a manner similar to Sample 1-1 and Sample 1-2.

Thereafter, as the strain becomes greater than about 15%, since the first opening ratio and the second opening ratio of Sample 1-3 are 20%, it is thought that the first openings 34a and the second openings 34b become completely closed, and the tensile force acting on the first electrode sheet and the second electrode sheet can no longer be absorbed. Accordingly, it is thought that the stress increases.

### 1.1.7.6. DC Resistance Value Change Rate of Sensor Sheet

Next, the DC resistance value change rate of the sensor sheet was measured. A test piece was prepared by cutting the sensor sheet into a strip shape of 90 mm×20 mm. The angle formed between the longitudinal direction of the test piece and the longitudinal direction of the warp filament assembly 72a is set to 45°.

The test piece is held by a pair of chucks. The distance between the pair of chucks is 50 mm. The tensile test is performed on the test piece at a tensile speed of 1 mm/sec. Electric wires were connected respectively to both ends of the first electrode sheet, and the DC resistance value between the two electric wires was measured. The DC resistance value change rate is calculated based on Formula (1) below for the DC resistance value at this time. Measurement of the DC resistance value is performed using a digital multimeter 2000 series manufactured by KEITHLEY. The above test is performed for Samples 1-1 to 1-2 and Sample 1-3.

$$\begin{matrix}[ Math . 1 ] & \\ DC resistance value change rate = \frac{Difference in DC resistance value before and after stretching}{Initial DC resistance value before stretching} \times 1 \; 00 [ \% ] & ( 1 )\end{matrix}$$

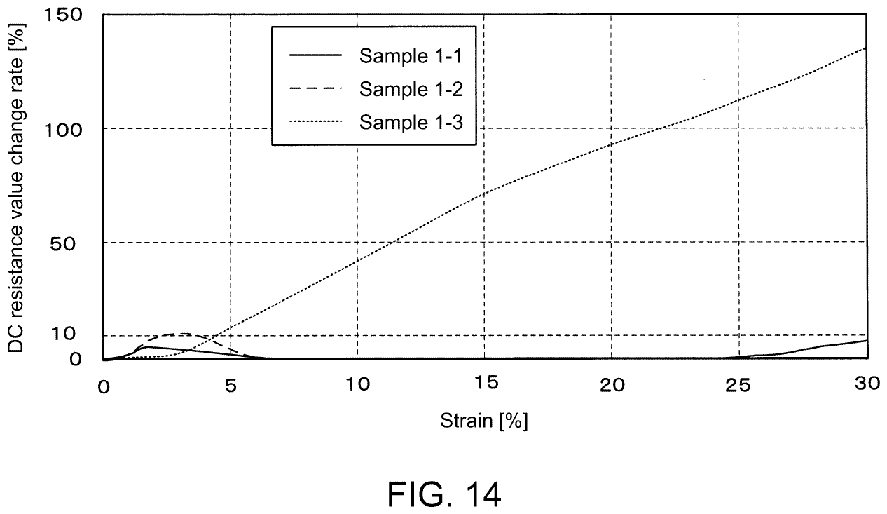

FIG. 14 is a graph showing changes in the DC resistance value change rate with respect to the strain. The DC resistance value change rate of Sample 1-1 increased in a range with the strain being 0 to about 2%, and the DC resistance value change rate became about 5% at a strain of about 2%. Thereafter, decreasing in a range of about 2 to about 5%, the DC resistance value change rate became about 0%. Thereafter, at a strain of about 25% or more, the DC resistance value change rate gradually increased, and the DC resistance value change rate became about 7% at a strain of 30%. In this manner, the DC resistance value change rate of Sample 1-1 was 10% or less in a range with the strain being 0 to 30%.

The DC resistance value change rate of Sample 1-2 increased in a range with the strain being 0 to about 3%, and the DC resistance value change rate became about 10% at a strain of about 3%. Thereafter, decreasing in a range of about 3 to about 5%, the DC resistance value change rate became about 0%. Thereafter, even at a strain of 30%, the DC resistance value change rate was about 0%. In this manner, the DC resistance value change rate of Sample 1-2 was 10% or less in the range with the strain being 0 to 30%.

The DC resistance value change rate of Sample 1-3 was about 2% in a range with the strain being 0 to about 3%. Thereafter, the DC resistance value change rate increased monotonically in a range with the strain being about 3 to 30%, and became about 130% at a strain of 30%. In this manner, the DC resistance value change rate of Sample 1-3 was greater than 10% in the range with the strain being 0 to 30%, and compared to Sample 1-1 and Sample 1-2, the resistance change during stretching was extremely large.

### 1.7.7. DC Resistance Value Change Rate of Sensor Sheet During 10% Elongation

Next, the DC resistance value change rate of the sensor sheet during 10% elongation was measured. When measuring the DC resistance value change rate of the sensor sheet described above, with respect to a reference length (50 mm) of the state before applying a tensile force to the sensor sheet, a test of elongating the sensor sheet by 10%, then returning to the reference length, and again elongating by 10% is repeated for a predetermined number of times. The number of repetitions in this test is 1 time, 5 times, and 10 times. The DC resistance value change rate is calculated based on Formula (1) above for the DC resistance value at this time. The above test is performed for Samples 1-1 to 1-2 and Sample 1-3.

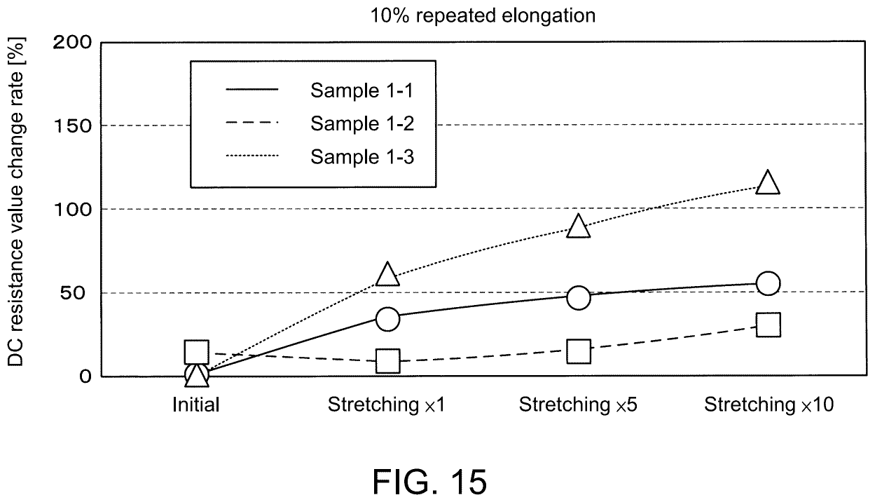

FIG. 15 shows a graph related to a relationship between the number of repetitions of the tensile test and the DC resistance value change rate. In Sample 1-1, the DC resistance value change rate at the initial measurement was about 0%. Thereafter, as the number of repetitions increased, the DC resistance value change rate increased to about 36% upon 1 repetition, to about 48% upon 5 repetitions, and to about 57% upon 10 repetitions. Upon 10 repetitions, the DC resistance value change rate of Sample 1-1 was 60% or less.

In Sample 1-2, the DC resistance value change rate at the initial measurement was about 14% and was larger than that of Sample 1-1. However, the DC resistance value change rate did not increase much even though the number of repetitions increased, with the DC resistance value change rate being about 9% upon 1 repetition and about 15% upon 5 repetitions. Upon 10 repetitions, the DC resistance value change rate was about 30%. Upon 10 repetitions, the DC resistance value change rate of Sample 1-2 was 50% or less.

In Sample 1-3, the DC resistance value change rate at the initial measurement was equivalent to that of Sample 1-1 and was about 0%. However, compared to Sample 1-1 and Sample 1-2, the DC resistance value change rate increased more as the number of repetitions increased, with the DC resistance value change rate being about 61% upon 1 repetition, being about 89% upon 5 repetitions, and being about 115% upon 10 repetitions.

As described above, it was learned that a change in the DC resistance value of the sensor sheets related to Samples 1-1 and 1-2 is small compared to Sample 1-3, even in the case where the 10% elongation test was repeated.

### 1.1.7.8. DC Resistance Value Change Rate of Sensor Sheet During 20% Elongation

Next, the DC resistance value change rate of Samples 1-1 to 1-2 and Sample 1-3 in the case of elongating the sensor sheet by 20% is measured.

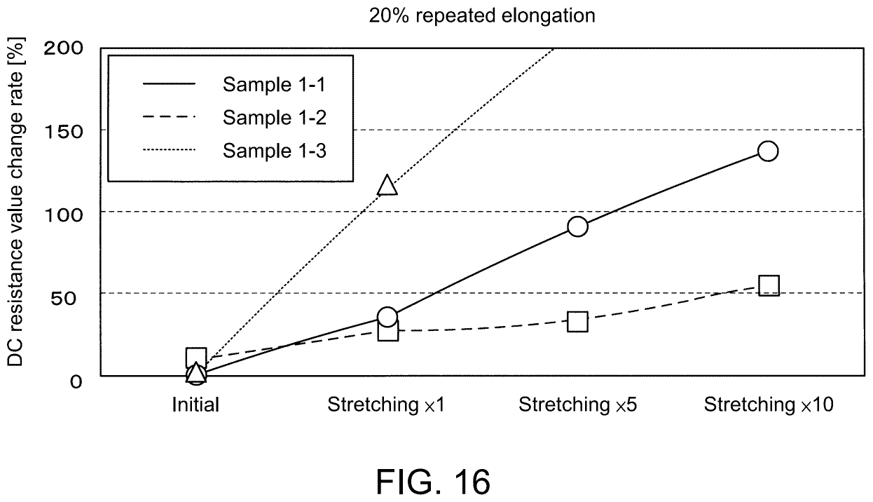

FIG. 16 shows a graph related to a relationship between the number of repetitions of the tensile test and the DC resistance value change rate. In Sample 1-1, the DC resistance value change rate at the initial measurement was about 0%. Thereafter, as the number of repetitions increased, the DC resistance value change rate increased to about 35% upon 1 repetition and to about 91% upon 5 repetitions. Upon 10 repetitions, the DC resistance value change rate was about 137%.

In Sample 1-2, the DC resistance value change rate at the initial measurement was about 10% and was larger than that of Sample 1-1. However, the DC resistance value change rate did not increase much even though the number of repetitions increased, with the DC resistance value change rate being about 27% upon 1 repetition and being about 32% upon 5 repetitions. Upon 10 repetitions, the DC resistance value change rate of Sample 1-2 was about 55%.

In Sample 1-3, the DC resistance value change rate at the initial measurement was about 0% and was equivalent to that of Sample 1-1. However, the DC resistance value change rate showed about 114% upon 1 repetition and exceeded 200% upon 5 repetitions.

As described above, it was learned that a change in the DC resistance value of the sensor sheets related to Samples 1-1 and 1-2 is small compared to Sample 1-3, even in the case where the 20% elongation test was repeated.

### 1.1.7.9 Modification Example 1 of Embodiment 1-1

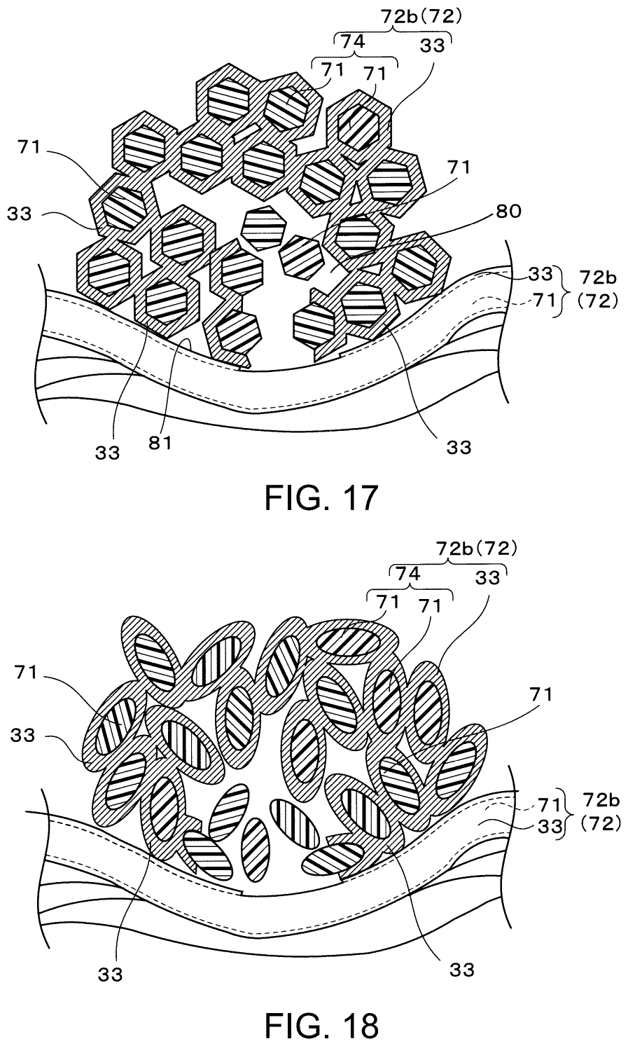

As shown in FIG. 17, the cross-sectional shape of a filament 71 related to Modification Example 1 of Embodiment 1-1 is formed in a hexagonal shape. However, the cross-sectional shape of the filament 71 may also be triangular, quadrilateral, pentagonal, or a polygonal shape with seven or more sides. In addition, the cross-sectional shape of the filament 71 does not need to be a regular polygon. In addition, the cross-sectional shapes of multiple filaments 71 do not need to be of a same type, and may also be configured such that, for example, a part is formed in a quadrilateral shape and another part is formed in a pentagonal shape.

### 1.1.7.10 Modification Example 2 of Embodiment 1-1

As shown in FIG. 18, the cross-sectional shape of a filament 71 related to Modification Example 2 of Embodiment 1-1 may be a non-circular shape, and, for example, may be an elongated circle shape. In addition, the cross-sectional shape of the filament 71 may be selected from any shape, such as a track shape, or an irregular shape with different maximum diameters of inscribed circles.

Furthermore, the cross-sectional shapes of multiple filaments 71 do not need to be of a same type, and may be configured such that, for example, a part is formed in a polygonal shape and another part is formed in an elongated circle shape.

### 1.1.8. Actions and Effects of Present Embodiment

Next, actions and effects of the present embodiment will be described. The sensor sheet 18 related to the present embodiment includes an insulating sheet 24, a first electrode sheet 25, a first bonding part 36, a second electrode sheet 26, and a second bonding part 37. The insulating sheet 24 has a first surface 27 and a second surface 28 and is formed of a foamed body. The first electrode sheet 25 has conductivity, is disposed on the first surface 27 side of the insulating sheet 24, and has first openings 34a penetrating through the first electrode sheet 25. The first bonding part 36 bonds the insulating sheet 24 and the first electrode sheet 25 to each other. The second electrode sheet 26 has conductivity, is disposed on the second surface 28 side of the insulating sheet 24, and has second openings 34b penetrating through the second electrode sheet 26. The second bonding part 37 bonds the insulating sheet 24 and the second electrode sheet 26 to each other. The first electrode sheet 25 and the second electrode sheet 26 are conductive cloths woven with multiple filament assemblies 72. The multiple filament assemblies 72 include multiple filaments 71 and a plating layer 33 formed on at least a part of a surface of the filament 71. The first electrode sheet 25 includes the first openings 34a that are opened between the multiple filament assemblies 72. The second electrode sheet 26 includes the second openings 34b that are opened between the multiple filament assemblies 72. The sensor sheet 18 is configured not to have a yield point showing a local maximum value in a range with a strain being 0.5 to 10% in a stress-strain curve in a tensile test. An opening ratio, which is a ratio of an opening area of the first openings 34a to an area of the first electrode sheet 25, is 1% or more and 50% or less. An opening ratio, which is a ratio of an opening area of the second openings 34b to an area of the second electrode sheet 26, is 1% or more and 50% or less.

According to the present embodiment, upon application of a tensile force to the sensor sheet, the first openings 34a of the first electrode sheet 25 deform, and the opening area of the first openings 34a deforms to decrease. As a result, new conductive paths are formed between the multiple filament assemblies 72 which were separated by the first openings. Accordingly, even in the case where a tensile force is applied to the sensor sheet 18, a change in the electrical resistance value can be suppressed. The above also applies to the second openings 34b of the second electrode sheet 26.

The opening ratio of the first openings 34a is preferably 1% or more and 50% or less. With the opening ratio being 50% or less, in the case where the opening area of the first openings 34a deforms in a decreasing direction, it becomes easy for the multiple filament assemblies 72 to contact each other. In this manner, since it becomes easy for the multiple filament assemblies 72 to contact each other, the opening ratio of the first openings 34a is preferably 1% or more and 50% or less, more preferably 1% or more and 40% or less, and even more preferably 1% or more and 30% or less. The opening ratio of the second openings 34b is the same as that of the first openings 34a.

In addition, the sensor sheet related to the present embodiment is configured not to have a yield point showing a local maximum value in the range with the strain being 0.5 to 10% in the stress-strain curve in the tensile test. Accordingly, since breakage of the plating layer in the range with the strain being 0.5 to 10% can be suppressed, a change in the electrical resistance value of the sensor sheet can be suppressed. In addition, in the region with a relatively small strain of 0.5 to 10%, a large stress does not occur, and a rapid change in the stress is suppressed. As a result, efficiency of a work of assembling the sensor sheet 18 to the steering wheel 10 can be improved. Furthermore, by not having a yield point showing a local maximum value in a range with the strain being 0.5 to 5%, since a large stress does not occur and the stress does not change when the sensor sheet 18 is slightly pulled, workability is further improved, which is more preferable.

Upon application of a tensile force to the sensor sheet 18, the first openings 34a of the first electrode sheet 25 deform, and the opening area of the first openings 34a deforms to decrease. In other words, the tensile strain does not concentrate on the filament 71 itself, and stretching is possible due to changes in spatial arrangements of the entirety of the filaments 71. Specifically, since structural stretchability and flexibility are exerted due to a decrease in the opening area associated with changes in the spatial arrangements of the entirety of the filaments 71, the tensile strain applied to the filament 71 itself is small, and damage to the plating layer 33 formed on the filament 71 can be suppressed. Thus, even in the case where a tensile force is applied to the sensor sheet 18, a change in the electrical resistance value can be suppressed.

The opening ratio of the first openings 34a is preferably 1% or more and 50% or less. With the opening ratio being 50% or less, in the case where the opening area of the first openings 34a deforms in a decreasing direction, it becomes easy for the multiple filament assemblies 72 to contact each other. In this manner, since it becomes easy for the multiple filament assemblies 72 to contact each other, the opening ratio of the first openings 34a is preferably 1% or more and 50% or less, more preferably 1% or more and 40% or less, and even more preferably 1% or more and 30% or less. The second openings 34b are the same as the first openings 34a.

The sensor sheet 18 related to the present embodiment is configured such that, in the stress-strain curve, a maximum value of the stress at a strain of 0 to 5% is 0.5 MPa or less. In addition, the sensor sheet 18 is configured such that, in the stress-strain curve, a maximum value of the stress at a strain of 0 to 20% is 3 MPa or less. Accordingly, in the case where a tensile force is applied to the sensor sheet 18, application of an excessively large stress to the first electrode sheet 25, 25a can be suppressed. As a result, since destruction of the structure of the first electrode sheet 25, 25a can be suppressed, a change in the electrical resistance value of the sensor sheet 18 can be suppressed.

From the viewpoint of reducing the stress applied to the first electrode sheet 25, 25a, or from the viewpoint of reducing the stress applied to the second electrode sheet 26, 26a, in the stress-strain curve, the maximum value of the stress of the sensor sheet 18 at a strain of 0 to 5% is preferably 0.5 MPa or less, more preferably 0.4 MPa or less, and even more preferably 0.3 MPa or less.

Similarly, from the viewpoint of reducing the stress applied to the first electrode sheet 25, 25a, or from the viewpoint of reducing the stress applied to the second electrode sheet 26, 26a, in the stress-strain curve, the maximum value of the stress of the sensor sheet 18 at a strain of 0 to 20% is preferably 3 MPa or less, more preferably 2 MPa or less, and even more preferably 1.5 MPa or less.

In addition, the first electrode sheet 25, 25a related to the present embodiment is configured such that, in the stress-strain curve, a maximum value of a stress of the first electrode sheet 25, 25a at a strain of 0 to 5% is 3 MPa or less. In addition, the first electrode sheet 25, 25a is configured such that, in the stress-strain curve, a maximum value of the stress at a strain of 0 to 20% is 15 MPa or less. The same also applies to the second electrode sheet 26, 26a.

From the viewpoint of reducing the stress applied to the first electrode sheet 25, 25a, or from the viewpoint of reducing the stress applied to the second electrode sheet 26, 26a, in the stress-strain curve, the maximum value of the stress of the first electrode sheet 25, 25a or the second electrode sheet 26, 26a at a strain of 0 to 5% is preferably 3 MPa or less, more preferably 2 MPa or less, and even more preferably 1 MPa or less.

Similarly, from the viewpoint of reducing the stress applied to the first electrode sheet 25, 25a, or from the viewpoint of reducing the stress applied to the second electrode sheet 26, 26a, the maximum value of the stress of the first electrode sheet 25, 25a or the second electrode sheet, 26, 26a at a strain of 0 to 20% is preferably 15 MPa or less, more preferably 10 MPa or less, and even more preferably 7 MPa or less.

The stress-strain curve of the sensor sheet 18 related to the present embodiment is a stress-strain curve in the case of holding a test piece of 20 mm×90 mm and performing a tensile test at a tensile speed of 1 mm/s.

In addition, a cross-sectional shape of the filament 71 may be a non-circular shape or may be a polygonal shape. Accordingly, irregular spaces are formed between the multiple filaments 71. With the filaments 71 moving within such spaces, the tensile force applied to the sensor sheet 18 is absorbed, so application of an excessively large stress to the sensor sheet 18 can be suppressed. As a result, a change in the electrical resistance value of the sensor sheet 18 can be suppressed.

In addition, in the filament assembly 72 related to the present embodiment, a portion electrically connected by mutual contact between the plating layers 33 formed on surfaces of the filaments 71 adjacent to each other is also present on outer surfaces of the multiple filaments 71 located inside a non-twisted bundle 74 formed in a bundle shape. Thus, in the case where a tensile force is applied to the sensor sheet 18, even if the plating layer 33 formed on the outer surfaces of the filaments 71 located on the surface of the non-twisted bundle 74 breaks, the plating layer 33 formed on the outer surfaces of the multiple filaments 71 located inside the non-twisted bundle 74 is still present. As a result, due to mutual contact between the plating layers 33 formed on the outer surfaces of the multiple filaments 71 located inside the non-twisted bundle 74, a change in the electrical resistance value can be suppressed even in the case where a tensile force is applied to the sensor sheet 18.

In addition, the filament assembly 72 related to the present embodiment includes an internal space 80 formed in at least a part between the filaments 71 adjacent to each other. Within the internal space 80, since the filaments 71 can move freely, in the case where a tensile force is applied to the sensor sheet 18, the stress can be absorbed by the movement of the filaments 71 within the internal space 80. Accordingly, since application of an excessively large stress to the sensor sheet 18 can be suppressed, a change in the electrical resistance value of the sensor sheet 18 can be suppressed.

In addition, in the filament assembly 72 related to the present embodiment, the multiple filaments 71 are disposed in each of a surface direction of a sheet surface of the first electrode sheet 25 and a normal direction of the sheet surface. The internal space 80 is formed in at least a part between the filaments 71 adjacent to each other in the surface direction and in at least a part between the filaments 71 adjacent to each other in the normal direction. Accordingly, since the filaments 71 are capable of moving in the surface direction and the normal direction, the stress applied to the sensor sheet 18 can be efficiently absorbed by the filaments 71. As a result, a change in the electrical resistance value of the sensor sheet 18 can be suppressed.

In addition, the plating layer 33 is formed at at least a part of a portion of the surfaces of the filaments 71 that is exposed to the internal space 80, and at a portion of the surfaces of the filaments 71 that is exposed to the internal space 80 and is not formed with the plating layer 33, the surfaces of the filaments are exposed. Accordingly, the filaments 71 exposed to the internal space 80 can move freely without being constrained by the plating layer 33. Accordingly, since the filaments 71 are capable of moving within the internal space 80, the stress applied to the sensor sheet 18 can be efficiently absorbed by the filaments 71. As a result, a change in the electrical resistance value of the sensor sheet 18 can be suppressed.

In addition, the plating layer 33 is formed at at least a part of a non-exposed portion 81 at which a warp filament assembly 72a and a weft filament assembly 72b are opposed to and intersect each other. Accordingly, since the warp filament assembly 72a and the weft filament assembly 72b are electrically connected to each other, a conductive path of the sensor sheet 18 can be formed.

In addition, the plating layer 33 is formed on at least a part of the surfaces of the filaments 71 exposed on an outer surface of the filament assembly 72. At a portion of the surfaces of the filaments 71 that is exposed on the outer surface of the filament assembly 72 and is not formed with the plating layer 33, the surfaces of the filaments 71 are exposed. Since the plating layer 33 is formed on at least a part of the surfaces of the filaments 71 exposed on the outer surface of the filament assembly 72, the filaments 71 are electrically connected to each other by the contact between the plating layer 33 formed on the surface of one filament 71 and the plating layer 33 formed on the surface of another filament 71. In addition, at the portion of the surfaces of the filaments 71 that is not formed with the plating layer, since the filaments 71 can move relatively freely, the tensile force applied to the sensor sheet 18 can be absorbed. Accordingly, since application of an excessive stress to the sensor sheet 18 can be suppressed, a change in the electrical resistance value of the sensor sheet 18 can be suppressed.

The multiple filament assemblies 72 related to the present embodiment include warp filament assemblies 72a and weft filament assemblies 72b. At a portion at which the warp filament assembly 72a and the weft filament assembly 72b intersect each other, the plating layer 33 is formed at at least a part of a portion at which the filaments 71 exposed on an outer surface of the warp filament assembly 72a and the filaments 71 exposed on an outer surface of the weft filament assembly 72b are opposed to each other, and at a portion that is not formed with the plating layer 33, the outer surfaces of the filaments 71 are exposed.

The plating layer 33 related to the present embodiment is one layer composed of nickel, or multiple layers including a layer composed of copper and a layer composed of nickel.

In addition, a manufacturing method of the sensor sheet 18 related to the present embodiment includes:
a process of forming a filament assembly 72 by bundling multiple filaments 71;
a process of forming a base fabric by weaving multiple filament assemblies 72;
a process of forming a conductive cloth by performing a plating treatment on the base fabric; and
a process of forming the sensor sheet 18 by bonding the conductive cloth to a first surface 27 of an insulating sheet 24 made of elastomer having the first surface 27 and a second surface 28.

According to the manufacturing method of the sensor sheet 18 described above, there are filaments 71 that are electrically connected by the mutual contact between the plating layers 33 formed on the surfaces of the filaments 71 adjacent to each other, and filaments 71 that can move freely relative to each other without forming the plating layer 33 on the surfaces of the filaments 71 adjacent to each other. Accordingly, in the case where a tensile force is applied to the sensor sheet 18, with the stress absorbed by the filaments 71 that can move freely relative to each other, application of an excessively large stress to the sensor sheet 18 can be suppressed. As a result, since electrical connection of the sensor sheet 18 is maintained by the filaments 71 that are electrically connected to each other, a change in the electrical resistance value of the sensor sheet 18 can be suppressed.

### Embodiment 2-1

Next, Embodiment 2-1 will be described. Since Embodiment 2-1 includes configurations identical to the configurations described in sections 1.1.1 to 1.1.5 of Embodiment 1-1, the descriptions of sections 1.1.1 to 1.1.5 will be read as sections 2.1.1 to 2.1.5, and repeated descriptions will be omitted.

### 2.1.6. Configuration of Electrode Sheet

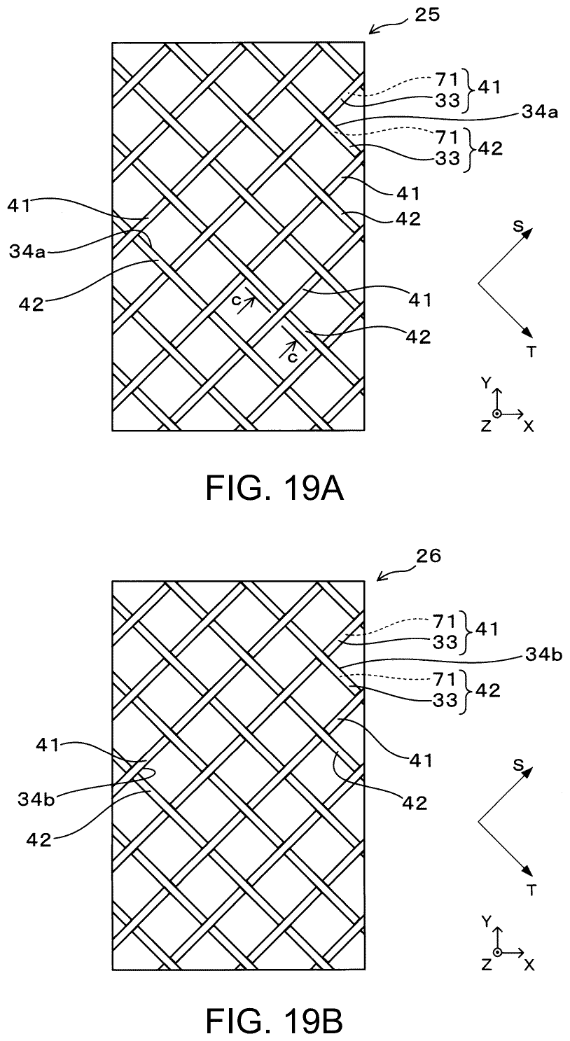

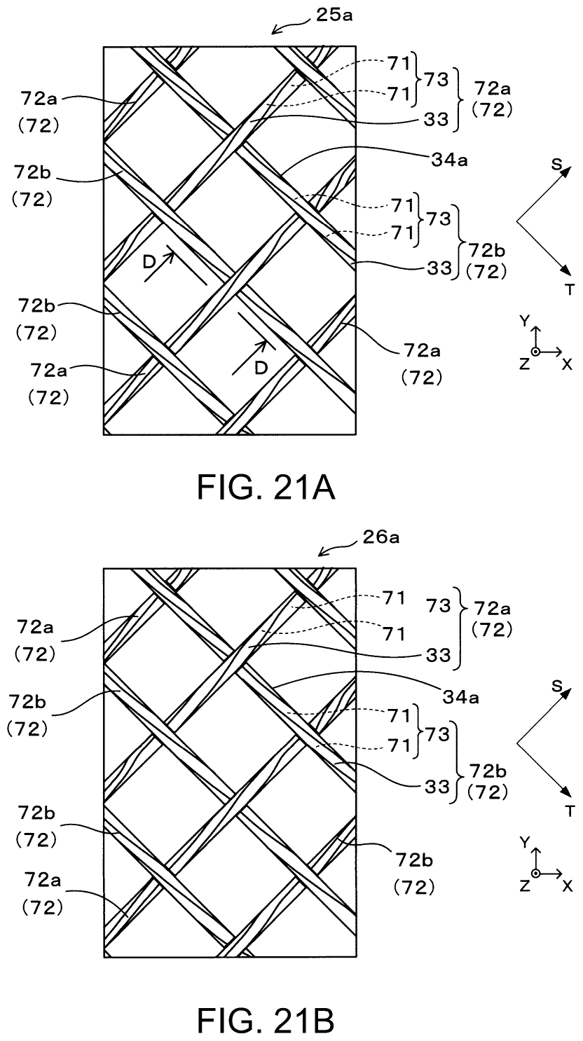

The first electrode sheets 25 and 25a and the second electrode sheets 26 and 26a will be described with reference to FIG. 19A, FIG. 19B, FIG. 21A, and FIG. 21B. The first electrode sheets 25 and 25a and the second electrode sheets 26 and 26a are conductive cloths having conductivity. The first electrode sheets 25 and 25a and the second electrode sheets 26 and 26a have both conductivity and flexibility. The first electrode sheets 25 and 25a and the second electrode sheets 26 and 26a have stretchability in the longitudinal direction X and the intersecting direction Y.

As shown in FIG. 19A and FIG. 19B, the first electrode sheet 25 and the second electrode sheet 26 are manufactured by forming a plating layer 33 on a base fabric woven with multiple filaments 71. In addition, as shown in FIG. 21A and FIG. 21B, the first electrode sheet 25a and the second electrode sheet 26a are manufactured by forming a plating layer 33 on a base fabric woven with multiple twisted wires 73. Each twisted wire 73 is formed by twisting multiple filaments 71.

Examples of a resin constituting the filament 71 include, for example, polyolefin such as polyethylene and polypropylene, polyester such as polyethylene terephthalate and polybutylene terephthalate, and polyamide such as nylon 6 and nylon 6,6. However, the resin constituting a warp 41 and a weft 42 is not limited to the above, and any resin may be selected as appropriate. The second electrode sheet 26 also includes the same configuration.

A method of forming the plating layer 33 is not particularly limited, may be, for example, electroplating, may be electroless plating, may be electroplating performed after performing electroless plating, or may be electroless plating performed after performing electroplating, and any method may be selected as appropriate.

Any metal or alloy, such as copper, nickel, tin, solder, etc., may be appropriately selected as a metal constituting the plating layer 33 formed on the surface of the base fabric. The plating layer 33 formed on the surface of the base fabric may be composed of one metal species or may be composed of multiple metal species. For example, copper alone may be plated on the surface of the base fabric, nickel alone may be plated on the surface of the base fabric, or a copper plating layer composed of copper may be formed on the surface of the base fabric and a nickel plating layer composed of nickel may be formed on the surface of the copper plating layer. The plating layer 33 formed on the surface of the base fabric may be formed by electroplating or may be formed by electroless plating. The second electrode sheet 26 also includes the same configuration.

### 2.1.7. Examples, Comparative Examples, and Samples

### 2.1.7.1. Example 2-1 and Sample 2-1

### Example 2-1 and Sample 2-1

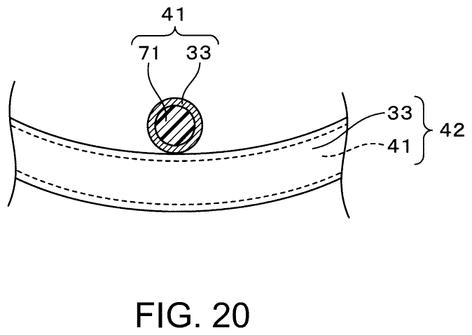

Example 2-1 will be described with reference to FIG. 19A to FIG. 20. As shown in FIG. 19A, the first electrode sheet 25 of the present Example 2-1 includes multiple warps 41 and multiple wefts 42. The first electrode sheet 25 is formed by weaving the warps 41 and the multiple wefts 42. The warp 41 is composed of one filament 71 and a plating layer 33 formed on the surface of the filament 71, and the weft 42 is composed of one filament 71 and a plating layer 33 formed on the surface of the filament 71. Since the first electrode sheet 25 and the second electrode sheet 26 have a substantially identical configuration, in the following description, repeated descriptions will be omitted unless specifically stated.

The first electrode sheet 25 includes a first opening 34a that is opened between two adjacent warps 41 among the multiple warps 41 and two adjacent wefts 42 among the multiple wefts 42. The first opening 34a penetrates through the first electrode sheet 25. In the present Example 2-1, an opening ratio, which is a ratio of the opening area of the first openings 34a formed in the first electrode sheet 25 to the area of the first electrode sheet 25, is about 63%. The opening ratio is a ratio of a total opening area of the multiple first openings 34a formed in a target region of the first electrode sheet 25 to an area of the target region of the first electrode sheet 25. The opening ratio is calculated, for example, by specifying a 10 mm×10 mm target region in the first electrode sheet 25, totaling the areas of the first openings 34a within the target region, and dividing the total area by the area of the target region.

As shown in FIG. 19B, the second electrode sheet 26 of the present Example 2-1 includes multiple warps 41 and multiple wefts 42. The second electrode sheet 26 is formed by weaving the warps 41 and the multiple wefts 42. The warp 41 is composed of one filament 71, and the weft 42 is composed of one filament 71.

The second electrode sheet 26 includes a second opening 34b that is opened between two adjacent warps 41 among the multiple warps 41 and two adjacent wefts 42 among the multiple wefts 42. In the present Example 2-1, an opening ratio, which is a ratio of an opening area of the second openings 34b formed in the second electrode sheet 26 to an area of the second electrode sheet 26, is about 63%.

As shown in FIG. 19A, the longitudinal direction S of the multiple warps 41 and the longitudinal direction X of the first electrode sheet 25 are configured to intersect each other. In addition, the longitudinal direction T of the multiple wefts 42 and the longitudinal direction X of the first electrode sheet 25 are configured to intersect each other. Specifically, the longitudinal direction S of the multiple warps 41 forms an acute angle that is substantially 45° with respect to the longitudinal direction X of the first electrode sheet 25. In addition, the longitudinal direction T of the multiple wefts 42 forms an acute angle that is substantially 45° with respect to the longitudinal direction X of the first electrode sheet 25. “An angle being substantially 45°” includes cases where the angle is 45°, and also includes cases where the angle can be considered substantially 45°.

In the case where the longitudinal direction S of the warp 41 is parallel to the longitudinal direction X of the first electrode sheet 25 (in the case where the acute angle is substantially 0°), upon stretching the first electrode sheet 25 in a direction parallel to the direction X, the warp 41 itself is extended, and a large load is required.

In contrast, in the case where the longitudinal direction S of the warp 41 is inclined at an inclination of 45° with respect to the longitudinal direction X of the first electrode sheet 25 (in the case where the acute angle is substantially 45°), upon stretching the first electrode sheet 25 in a direction parallel to the longitudinal direction X, the square or rectangular grids composed of the wefts 42 and the warps 41 deform into a rhombic shape, and since the warp 41 or the weft 42 itself is not extended, a large load is not required. In other words, in the case where the acute angle is substantially 45°, structural flexibility is imparted. Furthermore, the higher the opening ratio is, the more easily the square or rectangular grids deform into a rhombic shape, and the less likely it is for structural flexibility to be compromised.

However, the longitudinal direction S of the multiple warps 41 may also form an acute angle that is different from 45° with respect to the longitudinal direction X of the first electrode sheet 25. Similarly, the longitudinal direction T of the multiple wefts 42 may also form an acute angle that is different from 45° with respect to the longitudinal direction X of the first electrode sheet 25. Since the second electrode sheet 26 is the same as the first electrode sheet 25, repeated descriptions will be omitted.

As shown in FIG. 19A, in the present embodiment, the multiple warps 41 are disposed at substantially equal intervals. “Substantially equal intervals” includes cases of equal intervals, and also includes cases where the intervals, although not equal, can be considered substantially equal. The intervals between the multiple warps 41 may also be different from each other.

In addition, in the present embodiment, the multiple wefts 42 are disposed at substantially equal intervals. “Substantially equal intervals” includes cases of equal intervals, and also includes cases where the intervals, although not equal, can be considered substantially equal. The intervals between the multiple wefts 42 may also be different from each other.

As shown in FIG. 19B, since the configuration of the second electrode sheet 26 is the same as the first electrode sheet 25, repeated descriptions will be omitted.

As shown in FIG. 20, the plating layer 33 is formed at at least a part of the warp 41. The plating layer 33 may be formed on the entire surface of the warp 41, or the plating layer 33 may be formed on a part of the surface of the warp 41.

In addition, the plating layer 33 is formed at at least a part of the weft 42. The plating layer 33 may be formed on the entire surface of the weft 42, or the plating layer 33 may be formed on a part of the surface of the weft 42.

In the present example, the warp 41 and the weft 42 are electrically connected to each other by the contact between the plating layer 33 formed on the surface of the warp 41 and the plating layer 33 formed on the surface of the weft 42.

In the present Example 2-1, the resin constituting the filament 71 is polyethylene terephthalate (PET), and the diameter of the filament 71 is 60 to 65 μm. The metal constituting the plating layer 33 is formed in a three-layer structure, with the outermost layer being Ni, the intermediate layer being Cu, and the innermost layer (filament 71 side) being Ni.

As shown in FIG. 4, the first electrode sheet 25 described above is bonded, via the first bonding part 36, to the first surface 27 of the insulating sheet 24 formed to include a foaming resin as a main component. The insulating sheet 24 is an ether-based polyurethane foamed body.

The thickness of the insulating sheet is about 1.0 mm. The first bonding part 36 is an acrylic adhesive manufactured by Nogawa Chemical Co., Ltd. The thickness of the first bonding part 36 is 50 μm. In addition, the second electrode sheet 26 including the same configuration as the first electrode sheet 25 is bonded to the second surface 28 of the insulating sheet 24 via the second bonding part 37. Since the first bonding part 36 and the second bonding part 37 are identical, repeated descriptions will be omitted. In this manner, Sample 2-1 of the sensor sheet 18 related to the first electrode sheet 25 and the second electrode sheet 26 of Example 2-1 is prepared.

### 2.1.7.2. Example 2-2 and Sample 2-2

### Example 2-2 and Sample 2-2

Next, configurations of the first electrode sheet 25a and the second electrode sheet 26a related to Example 2-2 will be described with reference to FIG. 21A to FIG. 21B. The first electrode sheet 25a related to the present embodiment is a conductive cloth woven with multiple filament assemblies 72. The multiple filament assemblies 72 include a twisted wire 73 obtained by twisting multiple filaments 71, and a plating layer 33 formed on at least a part of the surface of the twisted wire 73. In addition, the multiple filament assemblies 72 include warp filament assemblies 72a and weft filament assemblies 72b. In the following description, in the case of describing without distinguishing between the warp filament assembly 72a and the weft filament assembly 72b, the warp filament assembly 72a and the weft filament assembly 72b may be referred to as a filament assembly 72. Among reference signs used hereinafter, reference signs identical to those used in the previous embodiments represent the same constituent elements as those in the previous embodiments unless otherwise stated.

The first electrode sheet 25a related to the present embodiment is formed by weaving a twisted wire 73, which constitutes a warp formed by twisting multiple filaments 71, and a twisted wire 73, which constitutes a weft formed by twisting multiple filaments 71, to form the base fabric, and forming the plating layer 33 on the surface of the base fabric. However, the manufacturing method of the first electrode sheet 25a is not limited to the above method. Since the first electrode sheet 25a and the second electrode sheet 26a include a substantially identical configuration, in the following description, repeated descriptions will be omitted unless specifically stated.

As shown in FIG. 21A, the first electrode sheet 25a of the present embodiment includes multiple warp filament assemblies 72a and multiple weft filament assemblies 72b. The first electrode sheet 25a includes first openings 34a that are opened between the multiple filament assemblies 72. The first openings 34a penetrate through the first electrode sheet 25a. In the present Example 2-2, an opening ratio, which is a ratio of the opening area of the first openings 34a formed in the first electrode sheet 25a to the area of the first electrode sheet 25a, is 63%.

As shown in FIG. 21B, the second electrode sheet 26a of the present embodiment is substantially identical to the first electrode sheet 25a except that the second electrode sheet 26a includes second openings 34b that are opened between the multiple filament assemblies 72, so repeated descriptions will be omitted. In the present Example 2-2, an opening ratio, which is a ratio of the opening area of the second openings 34b formed in the second electrode sheet 26a to the area of the second electrode sheet 26a of the present embodiment, is 63%.

The number of the filaments 71 included in the filament assembly 72 constituting the first electrode sheet 25a is not particularly limited. The filament assembly 72 related to the present embodiment includes 6 filaments 71, but may also include 2 to 5 filaments, or 7 or more filaments.

As shown in FIG. 21A, the longitudinal direction S of the multiple warp filament assemblies 72a and the longitudinal direction X of the first electrode sheet 25a are configured to intersect each other. In addition, the longitudinal direction T of the multiple weft filament assemblies 72b and the longitudinal direction X of the first electrode sheet 25a are configured to intersect each other. Specifically, the longitudinal direction S of the multiple warp filament assemblies 72a forms an acute angle that is substantially 45° with respect to the longitudinal direction X of the first electrode sheet 25a. In addition, the longitudinal direction T of the multiple weft filament assemblies 72b forms an acute angle that is substantially 45° with respect to the longitudinal direction X of the first electrode sheet 25a. “An angle being substantially 45°” includes cases where the angle is 45°, and also includes cases where the angle can be considered substantially 45°.

However, the longitudinal direction S of the multiple warp filament assemblies 72a may also form an acute angle that is different from 45° with respect to the longitudinal direction X of the first electrode sheet 25a. In addition, the longitudinal direction T of the multiple weft filament assemblies 72b may also form an acute angle that is different from 45° with respect to the longitudinal direction X of the first electrode sheet 25a.

As shown in FIG. 21A, the multiple warp filament assemblies 72a related to the present embodiment are disposed at substantially equal intervals. “Substantially equal intervals” includes cases of equal intervals, and also includes cases where the intervals, although not equal, can be considered substantially equal. In addition, the multiple weft filament assemblies 72b are also disposed at substantially equal intervals.

In the present embodiment, the intervals between the multiple warp filament assemblies 72a and the intervals between the multiple weft filament assemblies 72b are set to be substantially the same. However, the intervals between the multiple warp filament assemblies 72a and the intervals between the multiple weft filament assemblies 72b may also be different from each other.

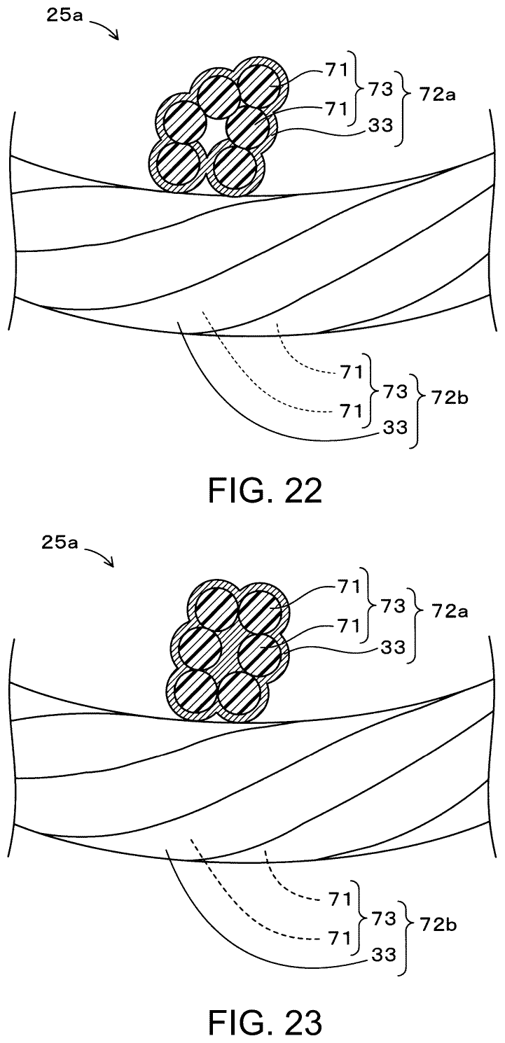

As shown in FIG. 22, the plating layer 33 is formed on at least a part of the surface of the twisted wire 73 constituting the filament assembly 72. In the present embodiment, the plating layer 33 is formed on the surfaces of the filaments 71 that are exposed to outside on the surface of the twisted wire 73.

The warp filament assembly 72a and the weft filament assembly 72b are electrically connected to each other by the contact between the plating layer 33 of the warp filament assembly 72a and the plating layer 33 of the weft filament assembly 72b.

In addition, in the present embodiment, among the surfaces of the filaments 71 constituting the twisted wire 73, the plating layer 33 is not formed on a part of the surfaces of the filaments 71 exposed inside the twisted wire 73. Accordingly, the surfaces of the filaments 71 exposed inside the twisted wire 73 are in a state exposed to the internal space of the twisted wire 73. In contrast, in the present embodiment, among the surfaces of the filaments 71 constituting the twisted wire 73, the plating layer 33 is formed on another part of the surfaces of the filaments 71 exposed inside the twisted wire 73. In this manner, in the present embodiment, the surfaces of the filaments 71 exposed inside the twisted wire 73 include a portion at which the surfaces of the filaments 71 are exposed and a portion at which the plating layer 33 is formed.

The portion at which the plating layer 33 is not formed and the surfaces of the filaments 71 are exposed is configured to move easily compared to the portion at which the plating layer 33 is formed. Accordingly, in the case where a stress is applied to the sensor sheet, the stress can be absorbed by the filaments 71 which easily move relatively freely.

In the present Example 2-2, the resin constituting the filament 71 is polyethylene terephthalate (PET), and the diameter of the filament 71 is about 20 μm. The metal constituting the plating layer 33 is formed with an outermost layer being Ni and an innermost layer (filament 71 side) being Cu. The twisted wire 73 is composed of 6 filaments 71.

Sample 2-2 of the sensor sheet 18 related to the first electrode sheet 25a and the second electrode sheet 26a of Example 2-2 is prepared in the same manner as Sample 2-1. Descriptions overlapping with Sample 2-1 will be omitted.

### Modification Example 1 of Example 2-2

Next, Modification Example 1 of Example 2-2 will be described with reference to FIG. 23. As shown in FIG. 23, the plating layer 33 is formed on at least a part of the surfaces of the filaments 71. In the present Modification Example 1, the plating layer 33 is formed on the surface of each filament 71, excluding contact points at which the filaments 71 adjacent to each other are in contact with each other. In the present Modification Example 1, among the surfaces of the filaments 71, the plating layer 33 is also formed on the surfaces of the filaments 71 located on the inner side of the twisted wire 73.

### Modification Example 2 of Example 2-2

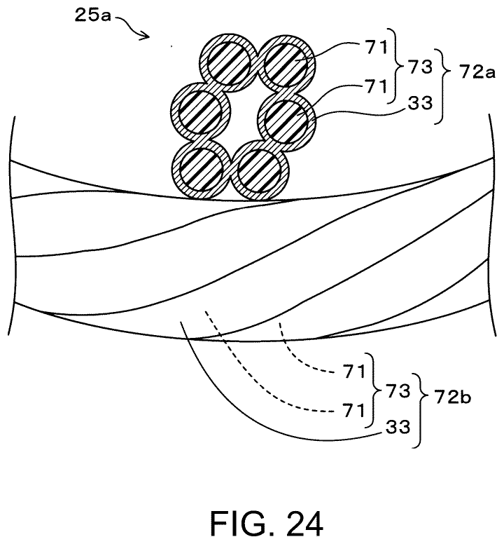

Next, Modification Example 2 of Example 2-2 will be described with reference to FIG. 24. As shown in FIG. 24, the plating layer 33 is formed on the entire circumference of the surfaces of the multiple filaments 71 constituting the twisted wire 73. The filaments 71 adjacent to each other are electrically connected to each other by the contact of the plating layer 33 formed on the surfaces of the filaments 71 adjacent to each other.

### 2.1.7.3. Comparative Example 2-1 and Sample 2-3

### Comparative Example 2-1 and Sample 2-3

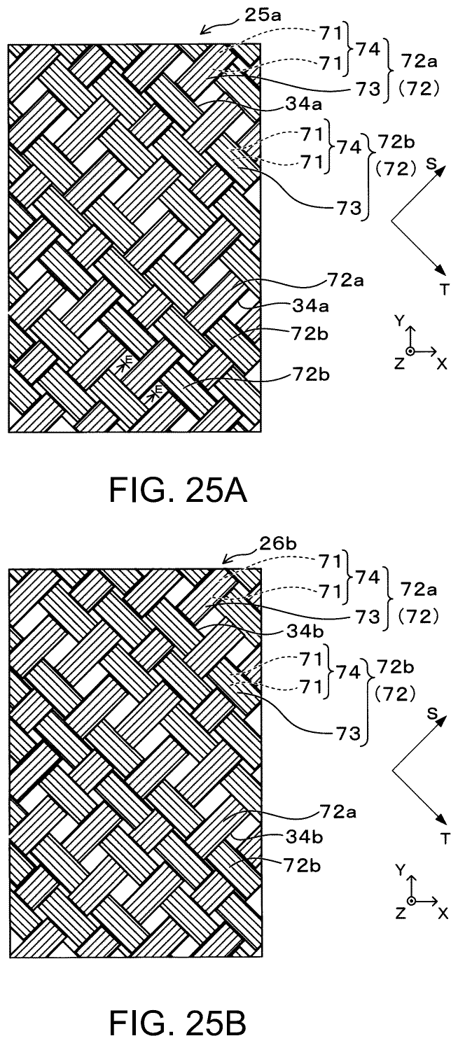

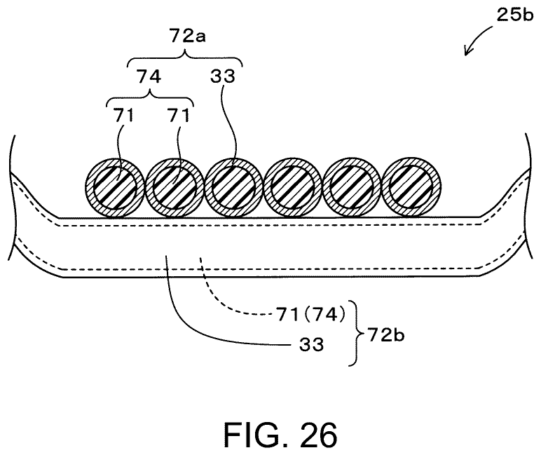

Next, Comparative Example 2-1 will be described with reference to FIG. 25A to FIG. 26. As shown in FIG. 25A, a first electrode sheet 25b related to Comparative Example 2-1 is a conductive cloth woven with multiple filament assemblies 72. The multiple filament assemblies 72 include a non-twisted bundle 74 in which multiple filaments 71 are bundled in an untwisted state, and a plating layer 33 formed on at least a part of the surface of the non-twisted bundle 74. The filament assembly 72 is formed in a shape that is flat in the thickness direction of the first electrode sheet 25b.

The first electrode sheet 25b related to the present Comparative Example 2-1 is formed by weaving a warp 41, in which multiple filaments 71 are bundled in an untwisted state, and a weft 42, in which multiple filaments 71 are bundled in an untwisted state, to form the base fabric, and forming the plating layer 33 on the surface of the base fabric. However, the manufacturing method of the first electrode sheet 25b is not limited to the above method. Since the first electrode sheet 25b includes a configuration substantially identical to that of the second electrode sheet 26b, in the following description, repeated descriptions will be omitted unless specifically stated.

As shown in FIG. 25A, the first electrode sheet 25b of the present embodiment includes multiple warp filament assemblies 72a and multiple weft filament assemblies 72b. The first electrode sheet 25b includes first openings 34a that are opened between the multiple filament assemblies 72. The first openings 34a penetrate through the first electrode sheet 25b. In the present Comparative Example 2-1, an opening ratio, which is a ratio of the opening area of the first openings 34a formed in the first electrode sheet 25b to the area of the first electrode sheet 25b, is about 20%.

As shown in FIG. 25B, the second electrode sheet 26b of the present embodiment is substantially identical to the first electrode sheet 25b except that the second electrode sheet 26b includes second openings 34b that are opened between the multiple filament assemblies 72, so repeated descriptions will be omitted. An opening ratio, which is a ratio of the opening area of the second openings 34b formed in the second electrode sheet 26b to the area of the second electrode sheet 26b of the present embodiment, is about 20%.

The number of the filaments 71 included in the filament assembly 72 constituting the first electrode sheet 25b is not particularly limited. The filament assembly 72 related to the present embodiment includes 6 filaments 71, but may also include 2 to 5 filaments, or 7 or more filaments. The multiple filaments 71 included in the filament assembly 72 are disposed in a state of being arranged in one layer.

As shown in FIG. 26, the plating layer 33 is formed on at least a part of the surface of the non-twisted bundle 74 constituting the filament assembly 72. In the present embodiment, the plating layer 33 is formed on the entire circumference of the surface of the non-twisted bundle 74.

The warp filament assembly 72a and the weft filament assembly 72b are electrically connected to each other by the contact between the plating layer 33 of the warp filament assembly 72a and the plating layer 33 of the weft filament assembly 72b.

As shown in FIG. 25A, the longitudinal direction S of the multiple warp filament assemblies 72a and the longitudinal direction X of the first electrode sheet 25a are configured to intersect each other. In addition, the longitudinal direction T of the multiple weft filament assemblies 72b and the longitudinal direction X of the first electrode sheet 25a are configured to intersect each other. Specifically, the longitudinal direction S of the multiple warp filament assemblies 72a forms an acute angle that is substantially 45° with respect to the longitudinal direction X of the first electrode sheet 25a. In addition, the longitudinal direction T of the multiple weft filament assemblies 72b forms an acute angle that is substantially 45° with respect to the longitudinal direction X of the first electrode sheet 25a. “An angle being substantially 45°” includes cases where the angle is 45°, and also includes cases where the angle can be considered substantially 45°.

However, the longitudinal direction S of the multiple warp filament assemblies 72a may also form an acute angle that is different from 45° with respect to the longitudinal direction X of the first electrode sheet 25a. In addition, the longitudinal direction T of the multiple weft filament assemblies 72b may also form an acute angle that is different from 45° with respect to the longitudinal direction X of the first electrode sheet 25a.

In the present Sample 2-3, the resin constituting the filament 71 is polyethylene terephthalate (PET), and the diameter of the filament 71 is 10 to 20 μm. The metal constituting the plating layer 33 has a three-layer structure, with the outermost layer being Ni, the intermediate layer being Cu, and the innermost layer (filament 71 side) being Ni. The non-twisted bundle 74 is composed of 6 filaments 71.

Sample 2-3 of the sensor sheet 18 related to the first electrode sheet 25b and the second electrode sheet 26b of Comparative Example 2-1 is prepared in the same manner as Sample 2-1. Descriptions overlapping with Sample 2-1 will be omitted.

### 2.1.7.4. Tensile Test of First Electrode Sheet

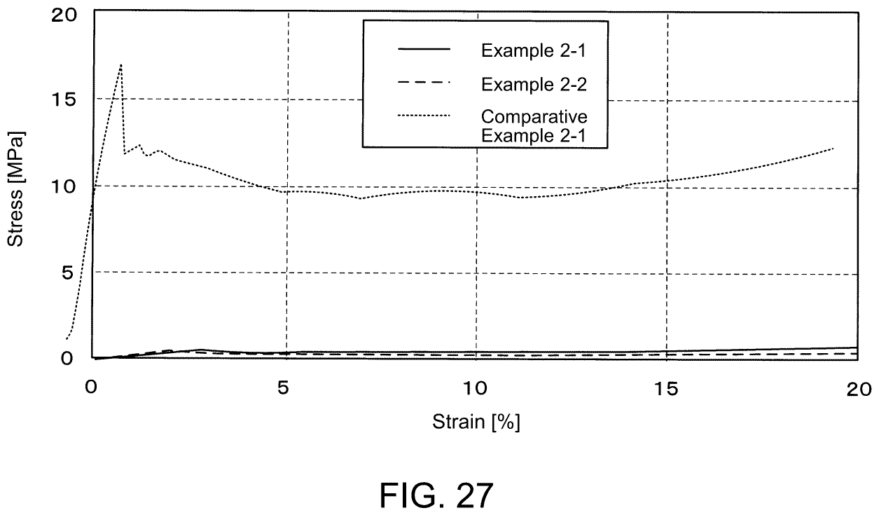

Next, the tensile test performed on the first electrode sheet will be described with reference to FIG. 27. Test pieces were prepared by cutting the first electrode sheets related to Examples 2-1 to 2-2 and Comparative Example 2-1 into a strip shape of 150 mm×20 mm. The thickness of the first electrode sheet is about 0.1 mm. The angle formed between the longitudinal direction of the test piece and the longitudinal direction of the warp 41 or the warp filament assembly 72a is set to 45°.

The test piece is held by a pair of chucks. The distance between the pair of chucks is 70 mm. The tensile test is performed on the test piece at a tensile speed of 1 mm/sec, and a stress is calculated by dividing a load by a cross-sectional area of the test piece. The tensile testing machine is AGS-X 1 kN manufactured by Shimadzu Corporation. The tensile test is performed in a range with a strain being 0 to 20%. FIG. 27 is a graph showing changes in the stress with respect to the strain.

In Example 2-1 and Example 2-2, in a region with the strain being 0 to 20%, the stress increased extremely gradually and monotonically. In the stress-strain curve in the tensile test, Example 2-1 and Example 2-2 do not have a yield point showing a local maximum value in a range with the strain being 0.5 to 10%.

Example 2-1 shows a stress of about 0.4 MPa at a strain of 5%, and shows about 0.8 MPa, which is a maximum value of the stress, at a strain of 20%. Thus, the maximum value of the stress of Example 2-1 in the tensile test is 1 MPa or less. Similarly, Example 2-2 shows a stress of about 0.3 MPa at a strain of 5%, and shows about 0.5 MPa, which is a maximum value of the stress, at a strain of 20%. Thus, in Example 2-2 as well, the maximum value of the stress in the tensile test is 1 MPa or less. In Example 2-1 and Example 2-2, in the stress-strain curve, the maximum value of the stress at a strain of 0 to 5% is 3 MPa or less, and the maximum value of the stress at a strain of 0 to 20% is 15 MPa or less.

In the stress-strain curve in the tensile test, Comparative Example 2-1 has a yield point showing a local maximum value in a range with the strain being 0.5 to 10%. In a region with the strain being 0 to about 1%, the stress increased linearly and monotonically. At a strain of about 1%, the stress showed about 17 MPa which is a local maximum value, and rapidly decreased to about 12 MPa. In this manner, in Comparative Example 2-1, before and after the strain of about 1%, the stress changed from an increasing trend to a decreasing trend. Thereafter, in a region with the strain being about 1 to about 13%, the stress monotonically decreased from about 12 to about 10 MPa. Thereafter, in a region with the strain being about 13 to 20%, the stress monotonically increased from about 10 to about 12 MPa. In this manner, in Comparative Example 2-1, in the stress-strain curve, the maximum value of the stress at a strain of 0 to 5% is greater than 3 MPa, and the maximum value of the stress at a strain of 0 to 20% is greater than 15 MPa.

### 2.1.7.5. Tensile Test of Sensor Sheet

Next, the tensile test performed on the sensor sheet will be described. Test pieces are prepared by cutting the sensor sheets related to Samples 2-1 to 2-2 and Sample 2-3 into a strip shape of 90 mm×20 mm. The thickness of the sensor sheet is about 1 mm. The angle formed between the longitudinal direction of the test piece and the longitudinal direction of the warp 41 or the warp filament assembly 72a constituting the first electrode sheet and the second electrode sheet is set to 45°.

An electric wire is connected to one end of the first electrode sheet in the longitudinal direction and is connected to a DC power supply. An electric wire is connected to the other end of the first electrode sheet in the longitudinal direction and is connected to a voltage measuring instrument.

The test piece is held by a pair of chucks. The distance between the pair of chucks is 50 mm. The tensile test is performed on the test piece at a tensile speed of 1 mm/sec, and a stress is calculated by dividing a load by a cross-sectional area of the test piece. In addition, during the tensile test, a DC resistance value (an example of the electrical resistance value) of the sensor sheet is calculated from a voltage of the DC power supply and a voltage drop of the sensor sheet. Measurement of the DC resistance value is performed using a digital multimeter 2000 series manufactured by KEITHLEY.

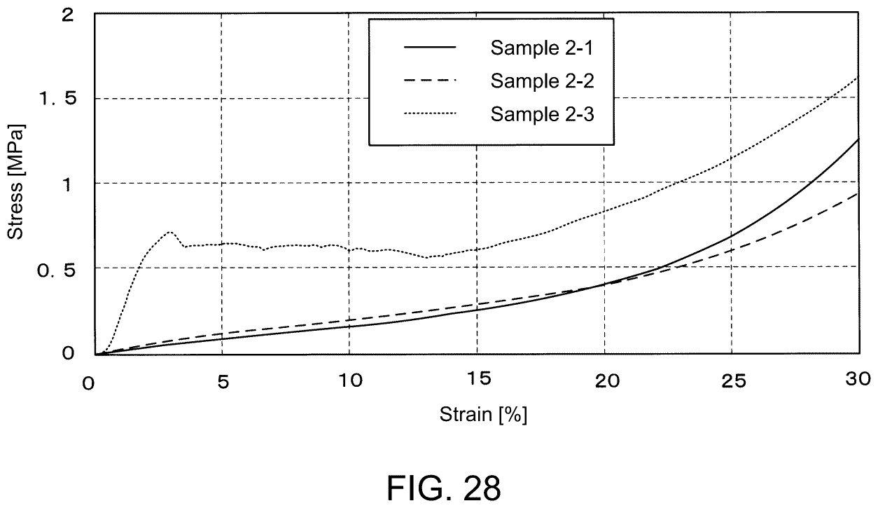

As shown in FIG. 28, Sample 2-1 shows a stress of about 0.1 MPa at a strain of 5%, shows a stress of about 0.4 MPa at a strain of 20%, and shows a stress of about 1.3 MPa, which is a maximum value of the stress, at a strain of 30%.

Sample 2-2 shows a stress of about 0.1 MPa at a strain of 5%, shows a stress of about 0.4 MPa at a strain of 20%, and shows a stress of about 0.9 MPa, which is a maximum value of the stress, at a strain of 30%.

In Sample 2-1 and Sample 2-2, in the stress-strain curve, the stress at a strain of 0 to 5% is 0.5 MPa or less, and the maximum value of the stress at a strain of 0 to 20% is 3 MPa or less.

In the stress-strain curve in the tensile test, Sample 2-3 has a yield point showing a local maximum value in a range with the strain being 0.5 to 10%. In a region with the strain being 0 to about 3%, the stress increased linearly and monotonically. At a strain of about 3%, the stress showed about 0.7 MPa which is a local maximum value, and rapidly decreased to about 0.6 MPa. In this manner, in Sample 2-3, before and after the strain of about 1%, the stress changed from an increasing trend to a decreasing trend. Thereafter, in a region with the strain being about 1 to about 13%, the stress decreased slightly. Thereafter, in a region with the strain being about 13 to 30%, the stress increased monotonically from about 0.6 to about 1.7 MPa. In this manner, in Sample 2-3, in the stress-strain curve, the maximum value of the stress at a strain of 0 to 5% is greater than 0.5 MPa, and the maximum value of the stress at a strain of 0 to 20% is greater than 0.7 MPa.

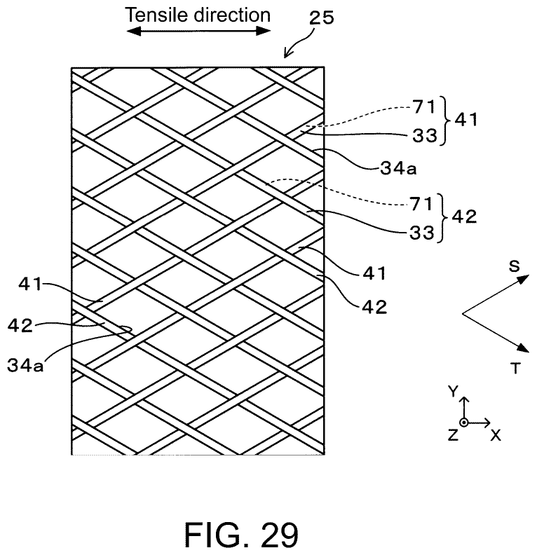

Upon application of a tensile force to Sample 2-1 and Sample 2-2, the first openings 34a of the first electrode sheet elongate in the tensile direction and contract in the direction intersecting the tensile direction. FIG. 29 shows a state of deformation of the first openings 34a, taking Sample 2-1 as an example. Accordingly, it is thought that since the tensile force is absorbed, a change in the stress is small. Since the same also applies to Sample 2-2, descriptions will be omitted.

In Sample 2-1 and Sample 2-2, even in the case where a tensile force is applied to the sensor sheet, at the portion at which the warp 41 and the weft 42 intersect each other, it is thought that since relative positions between the warp 41 and the weft 42 do not change much, an electrical connection state between the warp 41 and the weft 42 is maintained. Accordingly, in Sample 2-1 and Sample 2-2, it is thought that the DC resistance value hardly changes even in the case where a tensile force is applied to the sensor sheet.

In contrast, Sample 2-3 has a yield point showing a local maximum value in a range with the strain being 0.5 to 5%. In Sample 2-3, it is thought that, in a range from the strain of 0% to the yield point, elastic deformation occurs by maintaining of the plating layer 33 formed at the portion at which the warp 41 and the weft 42 intersect each other. Thereafter, at the yield point, it is thought that the plating layer 33 formed at the portion at which the warp 41 and the weft 42 intersect each other is destroyed.

Thereafter, in a range in which the stress does not change much (a range with the strain being about 5 to about 15%), it is thought that the tensile force is absorbed by deformation of the first openings 34a and the second openings 34b, in a manner similar to Sample 2-1 and Sample 2-2.

Thereafter, as the strain becomes greater than about 15%, since the first opening ratio and the second opening ratio of Sample 2-3 are 20%, it is thought that the first openings 34a and the second openings 34b become completely closed, and the tensile force acting on the first electrode sheet and the second electrode sheet can no longer be absorbed. Accordingly, it is thought that the stress increases.

### 2.1.7.6. DC Resistance Value of Sensor Sheet

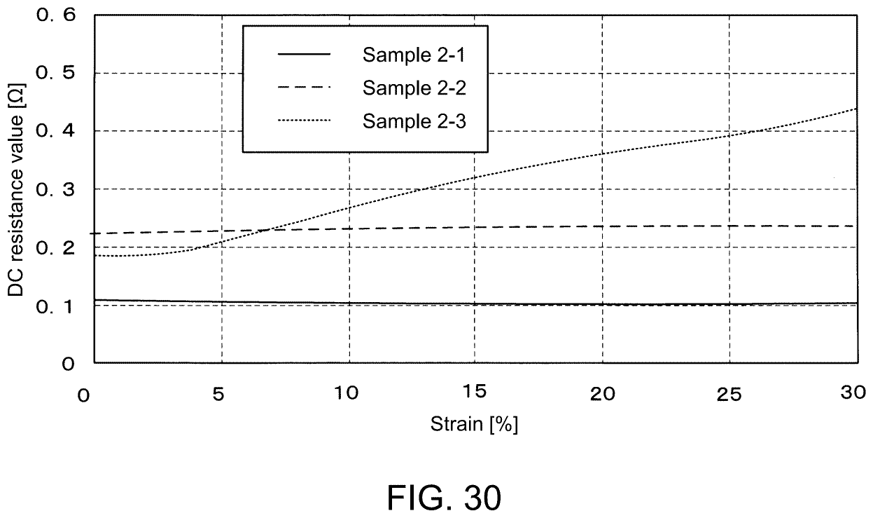

FIG. 30 is a graph showing changes in the DC resistance value with respect to the strain. FIG. 30 shows the DC resistance value in a region with the strain being 0 to 30%.

In Sample 2-1, in the region with the strain being 0 to 30%, the DC resistance value was about 0.1Ω and hardly changed. In Sample 2-2, in the region with the strain being 0 to 30%, the DC resistance value was about 0.2Ω and hardly changed.

In Sample 2-3, in a region with the strain being 0 to about 3%, the DC resistance value was about 0.2Ω and hardly changed. With the strain exceeding about 3%, the DC resistance value of Sample 2-3 increased monotonically, and at a strain of 30%, the DC resistance value was about 0.44Ω. In this manner, the DC resistance value of Sample 2-3 changed from about 0.2 to about 0.44Ω.

In the process of assembling the sensor sheet 18 to the steering wheel 10, the sensor sheet 18 is assembled to the steering wheel 10 while being pulled and extended. The sensor sheet 18 is fixed to the steering wheel 10 in a pulled and extended state. Thus, the sensor sheet 18 in the state assembled to the steering wheel 10 is maintained in a state in which a tension is applied. As time passes, it is anticipated that a residual stress in materials (metal, resin, etc.) constituting the sensor sheet 18 relaxes, and the tension applied to the sensor sheet 18 changes. Upon changing of the tension, there is a risk that the electrical resistance value of the sensor sheet 18 may change.

As described above, a tensile force acts on the sensor sheet, and the tensile force may change over time. Thus, in the case of applying a tensile force to the sensor sheet 18, upon changing of the DC resistance value of the sensor sheet 18, sensitivity of the sensor sheet 18 changes, which is not preferable.

In Sample 2-1 and Sample 2-2, in the region with the strain being 0 to 30%, the DC resistance value hardly changes, which is preferable.

In contrast, in Sample 2-3, in the region with the strain being 0 to 30%, the DC resistance value changes from about 0.2 to about 0.44Ω, which is not preferable.

### 2.1.8. Actions and Effects of Present Embodiment

Next, actions and effects of the present embodiment will be described. The sensor sheet 18 related to the present embodiment includes an insulating sheet 24, a first electrode sheet 25, 25a, a first bonding part 36, a second electrode sheet 26, 26a, and a second bonding part 37. The insulating sheet 24 has a first surface 27 and a second surface 28 and is formed of a foamed body. The first electrode sheet 25, 25a is disposed on the first surface 27 side of the insulating sheet 24 and has first openings 34a penetrating through the first electrode sheet 25, 25a. The first electrode sheet 25, 25a has conductivity. The first bonding part 36 bonds the insulating sheet 24 and the first electrode sheet 25 to each other. The second electrode sheet 26, 26a is disposed on the second surface 28 side of the insulating sheet 24 and has second openings 34b penetrating through the second electrode sheet 26, 26a. The second electrode sheet 26, 26a has conductivity. The second bonding part 37 bonds the insulating sheet 24 and the second electrode sheet 26, 26a to each other. The sensor sheet 18 is configured not to have a yield point showing a local maximum value in a range with a strain being 0.5 to 10% in a stress-strain curve in a tensile test. An opening ratio, which is a ratio of an opening area of the first openings 34a to an area of the first electrode sheet 25, 25a, is 40% or more. An opening ratio, which is a ratio of an opening area of the second openings 34b to an area of the second electrode sheet 26, 26a, is 40% or more.

Since the opening ratio, which is the ratio of the opening area of the first openings 34a to the area of the first electrode sheet 25, 25a, is 40% or more, and the opening ratio, which is the ratio of the opening area of the second openings 34b to the area of the second electrode sheet 26, 26a, is 40% or more, a tensile force applied to the sensor sheet 18 can be absorbed by deformation of the first openings 34a and the second openings 34b. Accordingly, since influence of the tensile force applied to the sensor sheet 18 can be reduced, an increase in the electrical resistance value of the sensor sheet 18 can be suppressed. To easily absorb the tensile force applied to the sensor sheet 18, the opening ratio is preferably 50% or more, and more preferably 60% or more.

The sensor sheet 18 related to the present embodiment is configured not to have a yield point showing a local maximum value in the range with the strain being 0.5 to 10% in the stress-strain curve in the tensile test. Accordingly, in the region with a relatively small strain of 0.5 to 10%, a large stress does not occur, and a rapid change in the stress is suppressed. As a result, efficiency of a work of assembling the sensor sheet 18 to the steering wheel 10 can be improved. Furthermore, by not having a yield point showing a local maximum value in a range with the strain being 0.5 to 5%, since a large stress does not occur and the stress does not change when the sensor sheet 18 is slightly pulled, workability is further improved, which is more preferable.

In addition, the first electrode sheet 25a and the second electrode sheet 26a related to the present embodiment are conductive cloths woven with multiple filament assemblies 72. The filament assembly 72 includes a twisted wire 73 in which multiple filaments 71 are twisted, and a plating layer 33 formed on at least a part of a surface of the twisted wire 73. The first electrode sheet 25a includes first opening 34a that are opened between the multiple filament assemblies 72. The second electrode sheet 26a includes second openings 34b that are opened between the multiple filament assemblies 72.

By forming the plating layer 33 on at least a part of the surface of the twisted wire 73 in which the multiple filaments 71 are twisted, multiple conductive paths are formed on the surface of the filament assembly 72. Accordingly, even if a part of the conductive paths is broken due to application of a tensile force to the sensor sheet 18 and destruction of a part of the plating layer 33, electrical connection can be maintained by other conductive paths. Accordingly, a change in the electrical resistance value of the sensor sheet 18 can be suppressed.

According to the present embodiment, in the stress-strain curve in the tensile test, in the range with the strain being 0.5 to 10%, since the grids composed of the warp 41 and the weft 42 deform into a rhombic shape, deformation is possible without requiring a large load, and the tensile strain on the warp 41 and the weft 42 themselves at this time is also suppressed. Thus, the strain applied to the plating layer 33 formed on the threads is also small, and destruction of the plating layer is suppressed. In other words, by disposing the conductive cloth at a 45° inclination with respect to the tensile direction, structural flexibility is expressed. As a result, since destruction of the plating layer 33 formed on the warp 41 or the weft 42 of the conductive cloth during stretching is suppressed, a change in the electrical resistance value of the sensor sheet 18 can be suppressed.

The sensor sheet 18 related to the present embodiment is configured such that, in the stress-strain curve, a maximum value of the stress at a strain of 0 to 5% is 0.5 MPa or less. In addition, the sensor sheet 18 is configured such that, in the stress-strain curve, a maximum value of the stress at a strain of 0 to 20% is 3 MPa or less. Accordingly, in the case where a tensile force is applied to the sensor sheet 18, application of an excessively large stress to the first electrode sheet 25, 25a can be suppressed. As a result, since destruction of the structure of the first electrode sheet 25, 25a can be suppressed, a change in the electrical resistance value of the sensor sheet 18 can be suppressed.

From the viewpoint of reducing the stress applied to the first electrode sheet 25, 25a, in the stress-strain curve, the maximum value of the stress of the sensor sheet 18 at a strain of 0 to 5% is preferably 0.5 MPa or less, more preferably 0.4 MPa or less, and even more preferably 0.3 MPa or less.

Similarly, from the viewpoint of reducing the stress applied to the first electrode sheet 25, 25a, in the stress-strain curve, the maximum value of the stress of the sensor sheet 18 at a strain of 0 to 20% is preferably 3 MPa or less, more preferably 2 MPa or less, and even more preferably 1.5 MPa or less.

In addition, the first electrode sheet 25, 25a related to the present embodiment is configured such that, in a stress-strain curve, a maximum value of a stress of the first electrode sheet 25, 25a at a strain of 0 to 5% is 3 MPa or less. In addition, the first electrode sheet 25, 25a is configured such that, in the stress-strain curve, a maximum value of the stress at a strain of 0 to 20% is 15 MPa or less.

From the viewpoint of reducing the stress applied to the first electrode sheet 25, 25a, in the stress-strain curve, the maximum value of the stress of the first electrode sheet 25, 25a at a strain of 0 to 5% is preferably 3 MPa or less, more preferably 2 MPa or less, and even more preferably 1 MPa or less.

Similarly, from the viewpoint of reducing the stress applied to the first electrode sheet 25, 25a, the maximum value of the stress at a strain of 0 to 20% is preferably 10 MPa or less, more preferably 7 MPa or less, and even more preferably 3 MPa or less.

By configuring the sensor sheet 18 or the first electrode sheet 25, 25a as described above, in the case where a tensile force is applied to the sensor sheet 18, application of an excessively large stress to the first electrode sheet 25, 25a can be suppressed. Accordingly, since destruction of the structure of the first electrode sheet 25, 25a can be suppressed, a change in the electrical resistance value of the sensor sheet 18 can be suppressed.

The plating layer 33 related to the present embodiment is formed on at least a part of the surface of the twisted wire 73, and is not formed at at least a part of inside of the twisted wire 73. Accordingly, inside the twisted wire 73, there are filaments 71 that are freely movable without being fixed by the plating layer 33. As a result, even in the case where a tensile force is applied to the sensor sheet 18, since the stress can be absorbed by the freely movable filaments 71, application of an excessively large stress to the first electrode sheet 25, 25a and the second electrode sheet 26, 26a can be suppressed. As a result, a change in the electrical resistance value of the sensor sheet 18 can be suppressed.

### Embodiment 3-1

Next, Embodiment 3-1 will be described. Since Embodiment 3-1 includes configurations identical to the configurations described in sections 1.1.1 to 1.1.5 of Embodiment 1-1, the descriptions in sections 1.1.1 to 1.1.5 will be read as sections 3.1.1 to 3.1.5, and repeated descriptions will be omitted.

### 3.1.6. Configuration of Electrode Sheet

The first electrode sheet 25 and the second electrode sheet 26 are conductive cloths having conductivity. The first electrode sheet 25 and the second electrode sheet 26 have both conductivity and flexibility. The first electrode sheet 25 and the second electrode sheet 26 have stretchability in the longitudinal direction X and the intersecting direction Y.

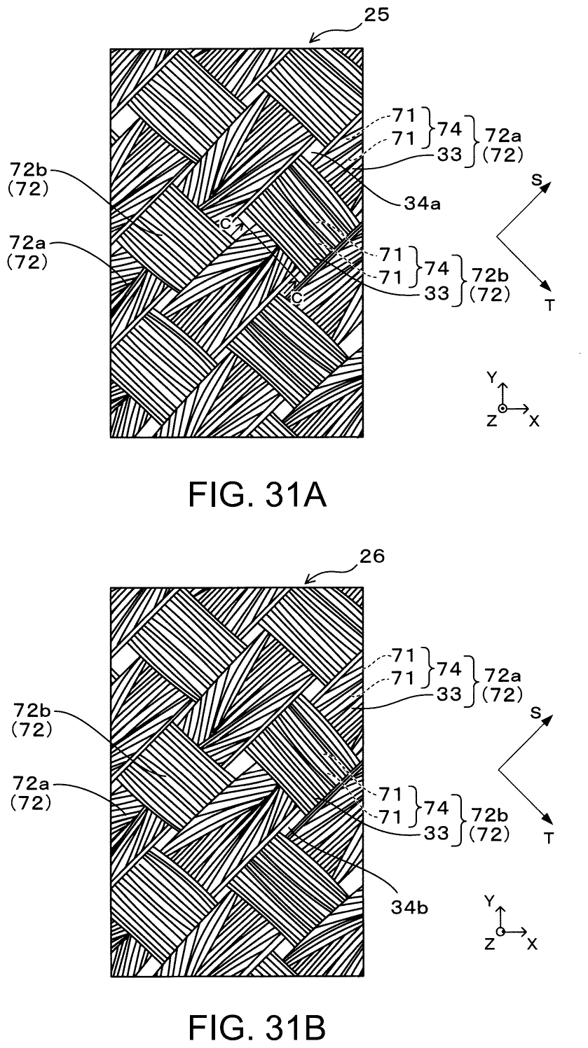

As shown in FIG. 31A and FIG. 31B, the first electrode sheet 25 and the second electrode sheet 26 are conductive cloths woven with multiple filament assemblies 72. The filament assembly 72 includes multiple filaments 71 and a plating layer 33 formed on at least a part of a surface of the filament 71.

As shown in FIG. 31A to FIG. 31B, the first electrode sheet 25 and the second electrode sheet 26 are manufactured by forming the plating layer 33 on a base fabric woven with multiple non-twisted bundles 74. Each non-twisted bundle 74 is formed by bundling multiple filaments 71 in an untwisted state.

Examples of a resin constituting the filament 71 may include, for example, polyolefin such as polyethylene and polypropylene, polyester such as polyethylene terephthalate and polybutylene terephthalate, and polyamide such as nylon 6 and nylon 6,6. However, the resin constituting the filament 71 is not limited to the above, and any resin may be selected as appropriate. The second electrode sheet 26 also includes the same configuration.

The plating layer 33 is formed on the surface of the base fabric woven with multiple filament assemblies 72. A method of forming the plating layer 33 is not particularly limited, may be, for example, electroplating, may be electroless plating, may be electroplating performed after performing electroless plating, or may be electroless plating performed after performing electroplating, and any method may be selected as appropriate.

Any metal or alloy, such as copper, nickel, tin, solder, etc., may be appropriately selected as a metal constituting the plating layer 33 formed on the surface of the base fabric. The plating layer 33 formed on the surface of the base fabric may be composed of one metal species or may be composed of multiple metal species. For example, copper alone may be plated on the surface of the base fabric, nickel alone may be plated on the surface of the base fabric, or a copper plating layer composed of copper may be formed on the surface of the base fabric and a nickel plating layer composed of nickel may be formed on the surface of the copper plating layer. The plating layer 33 formed on the surface of the base fabric may be formed by electroplating or may be formed by electroless plating. The second electrode sheet 26 also includes the same configuration.

As shown in FIG. 31A, the first electrode sheet 25 includes first openings 34a that are opened between the multiple filament assemblies 72. The first openings 34a penetrate through the first electrode sheet 25. A first opening ratio, which is a ratio of an opening area of the first openings 34a formed in the first electrode sheet 25 to an area of the first electrode sheet 25, is 1% or more and 40% or less.

As shown in FIG. 31B, the second electrode sheet 26 includes second openings 34b that are opened between the multiple filament assemblies 72. The second openings 34b penetrate through the second electrode sheet 26. A second opening ratio, which is a ratio of an opening area of the second openings 34b formed in the second electrode sheet 26 to an area of the second electrode sheet 26, is 1% or more and 40% or less.

### 3.1.7. Examples, Comparative Examples, and Samples

### 3.1.7.1. Example 3-1 and Sample 3-1

### Example 3-1 and Sample 3-1

Example 3-1 will be described with reference to FIG. 31A to FIG. 34. As shown in FIG. 31A, the first electrode sheet 25 related to Example 3-1 is a conductive cloth woven with multiple filament assemblies 72. The multiple filament assemblies 72 include a non-twisted bundle 74 in which multiple filaments 71 are bundled in an untwisted state, and a plating layer 33 formed on at least a part of the surface of the non-twisted bundle 74. The filament assembly 72 is formed in a shape that is flat in the thickness direction of the first electrode sheet 25b. Since the first electrode sheet 25 and the second electrode sheet 26 include a substantially identical configuration, repeated descriptions will be omitted unless specifically stated.

The first electrode sheet 25 related to the present Example 3-1 is formed by weaving a warp, in which multiple filaments 71 are bundled in an untwisted state, and a weft, in which multiple filaments 71 are bundled in an untwisted state, to form the base fabric, and forming the plating layer 33 on the surface of the base fabric. However, the manufacturing method of the first electrode sheet 25 is not limited to the above method.

As shown in FIG. 31A, the first electrode sheet 25 of the present embodiment includes multiple warp filament assemblies 72a and multiple weft filament assemblies 72b. The first electrode sheet 25 includes first openings 34a that are opened between the multiple filament assemblies 72. The first openings 34a penetrate through the first electrode sheet 25. In the present Example 3-1, an opening ratio, which is a ratio of the opening area of the first openings 34a formed in the first electrode sheet 25 to the area of the first electrode sheet 25, is about 3%. The opening ratio is a ratio of a total opening area of the multiple first openings 34a formed in a target region of the first electrode sheet 25 to an area of the target region of the first electrode sheet 25. The opening ratio is calculated, for example, by specifying a 10 mm×10 mm target region in the first electrode sheet 25, totaling the areas of the first openings 34a within the target region, and dividing the total area by the area of the target region.

As shown in FIG. 31B, the second electrode sheet 26 of the present embodiment includes multiple warp filament assemblies 72a and multiple weft filament assemblies 72b. The second electrode sheet 26 of the present embodiment includes second openings 34b that are opened between the multiple filament assemblies 72. The second openings 34b penetrate through the second electrode sheet 26. In the present Example 3-1, an opening ratio, which is a ratio of the opening area of the second openings 34b formed in the second electrode sheet 26 to the area of the second electrode sheet 26 of the present embodiment, is about 3%.

The number of the filaments 71 included in the filament assembly 72 constituting the first electrode sheet 25 is not particularly limited. The filament assembly 72 related to the present embodiment includes 75 filaments 71, but the number of the filaments 71 may be any number. In addition, the second electrode sheet 26 is the same as the first electrode sheet 25.

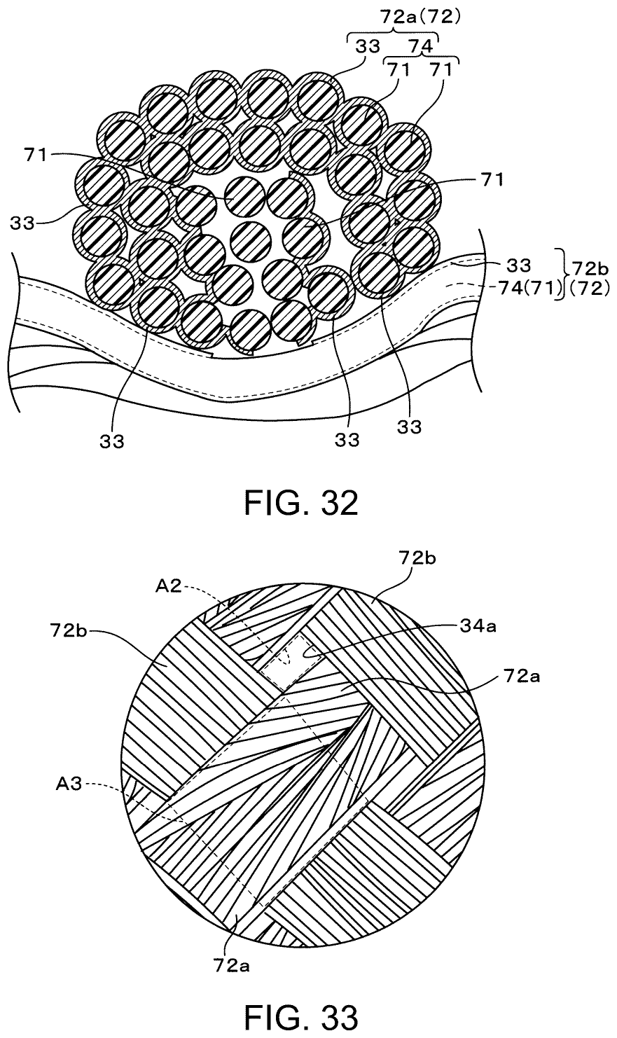

As shown in FIG. 32, the plating layer 33 is formed on at least a part of the surface of the non-twisted bundle 74 constituting the filament assembly 72. The warp filament assembly 72a and the weft filament assembly 72b are electrically connected to each other by the contact between the plating layer 33 of the warp filament assembly 72a and the plating layer 33 of the weft filament assembly 72b.

As shown in FIG. 31A, the longitudinal direction S of the multiple warp filament assemblies 72a and the longitudinal direction X of the first electrode sheet 25 are configured to intersect each other. In addition, the longitudinal direction T of the multiple weft filament assemblies 72b and the longitudinal direction X of the first electrode sheet 25 are configured to intersect each other. Specifically, the longitudinal direction S of the multiple warp filament assemblies 72a forms an acute angle that is substantially 45° with respect to the longitudinal direction X of the first electrode sheet 25. In addition, the longitudinal direction T of the multiple weft filament assemblies 72b forms an acute angle that is substantially 45° with respect to the longitudinal direction X of the first electrode sheet 25a. “An angle being substantially 45°” includes cases where the angle is 45°, and also includes cases where the angle can be considered substantially 45°. Since the second electrode sheet 26 also includes the same configuration as the first electrode sheet 25, repeated descriptions will be omitted.

In the case where the longitudinal direction S of the warp filament assembly 72a is parallel to the longitudinal direction X of the first electrode sheet 25 (in the case where the acute angle is substantially 0°), upon stretching the first electrode sheet 25 in a direction parallel to the direction X, the warp filament assembly 72a itself is extended, and a large load is required.

In contrast, in the case where the longitudinal direction S of the warp filament assembly 72a is inclined at an inclination of 45° with respect to the longitudinal direction X of the first electrode sheet 25 (in the case where the acute angle is substantially 45°), upon stretching the first electrode sheet 25 in a direction parallel to the direction X, the square or rectangular grids (openings 34) composed of the warp filament assemblies 72a and the weft filament assemblies 72b deform into a rhombic shape, and since the warp filament assembly 72a or the weft filament assembly 72b itself is not extended, a large load is not required. In other words, in the case where the acute angle is substantially 45°, structural flexibility is imparted. Furthermore, the higher the opening ratio is, the more easily the square or rectangular grids deform into a rhombic shape, and the less likely it is for structural flexibility to be compromised.

However, the longitudinal direction S of the multiple warp filament assemblies 72a may also form an acute angle that is different from 45° with respect to the longitudinal direction X of the first electrode sheet 25. In addition, the longitudinal direction T of the multiple weft filament assemblies 72b may also form an acute angle that is different from 45° with respect to the longitudinal direction X of the first electrode sheet 25.

The number of the multiple filaments 71 constituting the warp filament assembly 72a and the number of the multiple filaments 71 constituting the weft filament assembly 72b may be the same as or different from each other. In the present Embodiment 3-1, the number of the multiple filaments 71 constituting the warp filament assembly 72a and the number of the multiple filaments 71 constituting the weft filament assembly 72b are set to be substantially the same. “Substantially the same” includes case where the numbers are the same, and also includes cases where the numbers, although not the same, can be considered substantially the same. Since the above also applies to the weft filament assembly 72b, repeated descriptions will be omitted. In the present Example 3-1, the number of the filaments 71 is set to 75. However, the number of the filaments 71 is not limited to the above number.

As shown in FIG. 32, the plating layer 33 is formed at at least a part of the multiple filaments 71 constituting the warp filament assembly 72a. For example, the plating layer 33 is formed on the surfaces of the filaments 71 exposed on the outer surface of the warp filament assembly 72a. Among the filaments 71 located inside the warp filament assembly 72a, the plating layer 33 is not formed on the surfaces of a part of the filaments 71. At the portion at which the plating layer 33 is not formed, the surfaces of the filaments 71 are exposed. Since the above also applies to the weft filament assembly 72b, repeated descriptions will be omitted.

At a portion at which the warp filament assembly 72a and the weft filament assembly 72b are opposed to and intersect each other, the plating layer 33 is formed at a part, and at the portion at which the plating layer 33 is not formed, the surfaces of the filaments 71 are exposed. Of the portion at which the warp filament assembly 72a and the weft filament assembly 72b are opposed to and intersect each other, the plating layer 33 is formed in a region close to the portion exposed to outside, and at the portion close to inside, a portion formed with the plating layer 33 and a portion not formed with the plating layer 33 are both present. Since the weft filament assembly 72b also includes the same configuration as the warp filament assembly 72a, repeated descriptions will be omitted.

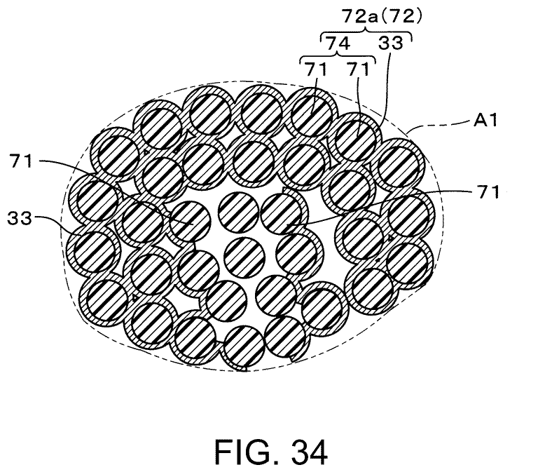

As shown in FIG. 34, a cross-sectional area A1 of each warp filament assembly 72a is larger than an opening area A2 of the first opening 34a in a state in which no strain is generated in the first electrode sheet 25 as shown in FIG. 33. The cross-sectional area A1 of the warp filament assembly 72a refers to a cross-sectional area formed by an outer contour line of the warp filament assembly 72a. The same also applies to the weft filament assembly 72b. In addition, although not shown in detail, a cross-sectional area A1 of each weft filament assembly 72b is larger than the opening area A2 of the first opening 34a in a state in which no strain is generated in the first electrode sheet 25. In addition, although not shown in detail, in the second electrode sheet 26, a cross-sectional area A1 of each warp filament assembly 72a and a cross-sectional area A1 of each weft filament assembly 72b are larger than an opening area A2 of the second opening 34b in a state in which no strain is generated in the second electrode sheet 26.

As shown in FIG. 33, upon viewing from the thickness direction of the first electrode sheet 25, an intersection area A3, which is an area of a portion at which the warp filament assembly 72a and the weft filament assembly 72b intersect each other, is larger than the opening area A2 of the first opening 34a shown in FIG. 33. In addition, although not shown in detail, upon viewing from the thickness direction of the second electrode sheet 26, an intersection area A3, which is an area of a portion at which the warp filament assembly 72a and the weft filament assembly 72b intersect each other, is larger than the opening area A2 of the second opening 34b.

In the present Embodiment 3-1, the resin constituting the filament 71 is polyethylene terephthalate (PET), and the diameter of the filament 71 is about 10 μm. The metal constituting the plating layer 33 is formed in a three-layer structure, with the outermost layer being Ni, the intermediate layer being Cu, and the innermost layer (filament 71 side) being Ni. The diameter of the warp filament assembly 72a is 185 μm, and the diameter of the weft filament assembly 72b is 185 μm. Since the second electrode sheet 26 includes a configuration substantially identical to that of the first electrode sheet 25, repeated descriptions will be omitted.

As shown in FIG. 4, the first electrode sheet 25 described above is bonded to the first surface 27 of the insulating sheet 24 via the first bonding part 36. In addition, the second electrode sheet 26, which includes the same configuration as the first electrode sheet 25, is bonded to the second surface 28 of the insulating sheet 24 via the second bonding part 37. The insulating sheet 24 is an ether-based polyurethane foamed body. The first bonding part 36 is an acrylic adhesive manufactured by Nogawa Chemical Co., Ltd. A thickness of the first bonding part 36 is 50 μm. Since the first bonding part 36 and the second bonding part 37 are identical, repeated descriptions will be omitted. In this manner, the sensor sheet 18 related to Sample 3-1 is prepared.

### 3.1.7.2. Example 3-2 and Sample 3-2

### Example 3-2 and Sample 3-2

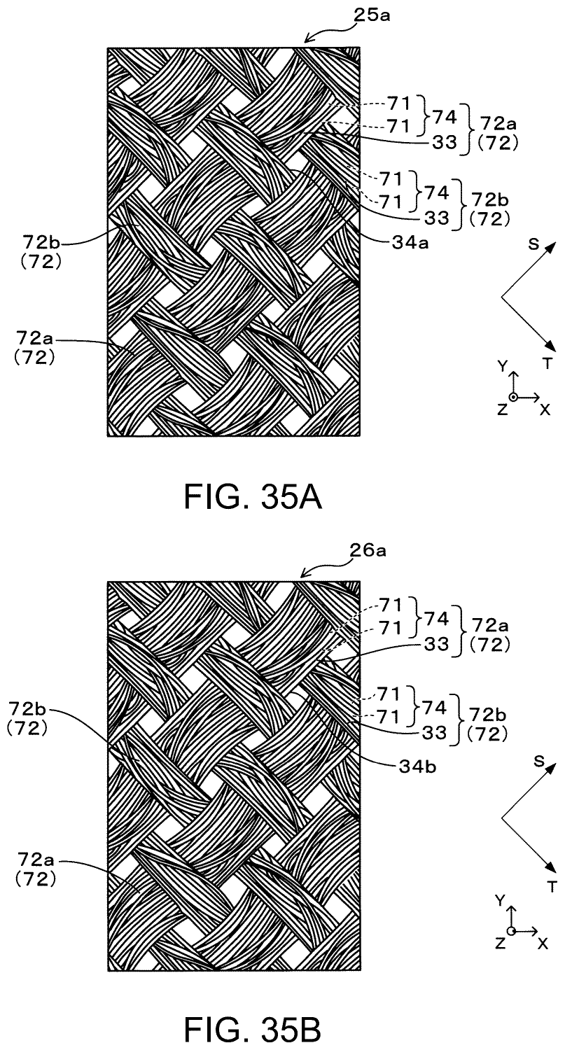

Next, configurations of the first electrode sheet 25a and the second electrode sheet 26a related to Example 3-2 will be described with reference to FIG. 35A to FIG. 35B. In the first electrode sheet 25a related to the present Example 3-2, the number of filaments 71a constituting a warp filament assembly 72aa and the number of filaments 71a constituting a weft filament assembly 72ba are different from each other. In the present Example 3-2, the number of the filaments 71a constituting the warp filament assembly 72aa is greater than the number of the filaments 71a constituting the weft filament assembly 72ba. However, the number of the filaments 71a constituting the warp filament assembly 72aa may also be configured to be less than the number of the filaments 71a constituting the weft filament assembly 72ba.

In the present Example 3-2, the number of the filaments 71a constituting the warp filament assembly 72aa is set to about twice the number of the filaments 71a constituting the weft filament assembly 72ba. In the present Example 3-2, the number of the filaments 71a constituting the warp filament assembly 72aa is set to about 80, and the number of the filaments 71a constituting the weft filament assembly 72ba is set to about 40. However, the difference between the number of the filaments 71a constituting the warp filament assembly 72aa and the number of the filaments 71a constituting the weft filament assembly 72ba is not limited to the above.

An opening ratio, which is a ratio of the opening area of the first openings 34a formed in the first electrode sheet 25a related to the present Example 3-2 to the area of the first electrode sheet 25a, is about 10%. In addition, an opening ratio, which is a ratio of the opening area of the second openings 34b formed in the second electrode sheet 26a to the area of the second electrode sheet 26a, is about 10%.

Since the second electrode sheet 26a has the same configuration as the first electrode sheet 25a, repeated descriptions will be omitted.

In the present Example 3-2, the resin constituting the filament 71a is polyethylene terephthalate (PET), and the diameter of the filament 71a is about 10 μm. The metal constituting the plating layer 33 has a one-layer structure and is configured as one layer of Ni. The diameter of the warp filament assembly 72aa is about 180 μm, and the diameter of the weft filament assembly 72ba is about 90 μm.

Since configurations other than the above are the same as those in Example 3-1, repeated descriptions will be omitted.

In addition, in the present Example 3-2, the insulating sheet 24 is an ether-based polyurethane foamed body. The first bonding part 36 is an acrylic adhesive. The thickness of the first bonding part 36 is about 50 μm. Since the first bonding part 36 and the second bonding part 37 are identical, repeated descriptions will be omitted. Except for the above, Sample 3-2 of the sensor sheet 18 related to the first electrode sheet 25a and the second electrode sheet 26a of Example 3-2 is prepared in the same manner as Sample 3-1. Descriptions overlapping with Sample 3-1 will be omitted.

### 3.1.7.3. Comparative Example 3-1 and Sample 3-3

### Comparative Example 3-1 and Sample 3-3

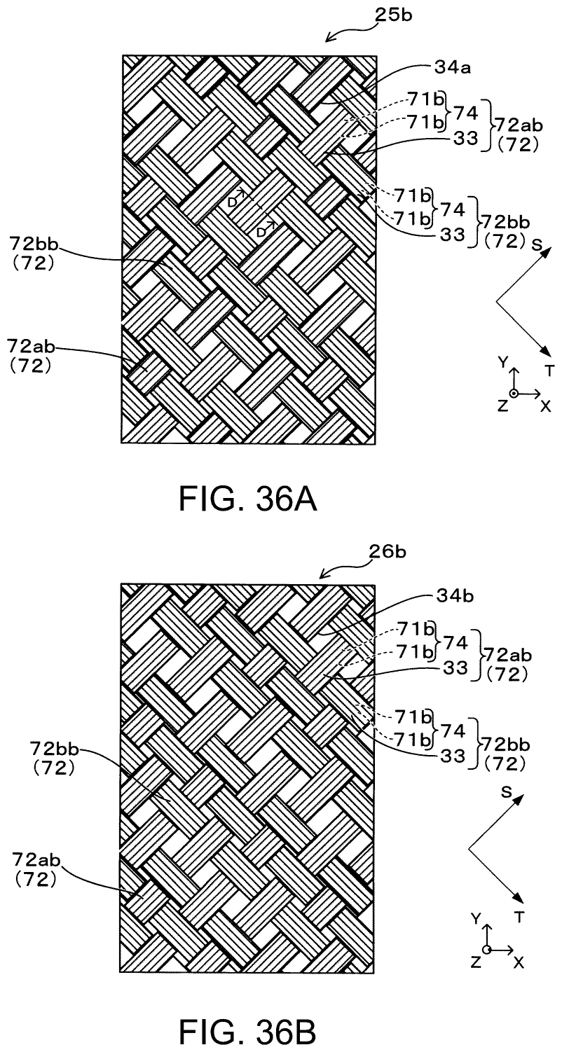

Next, Comparative Example 3-1 will be described with reference to FIG. 36A to FIG. 36B. A warp filament assembly 72ab and a weft filament assembly 72bb related to Comparative Example 3-1 include 6 filaments 71b.

As shown in FIG. 36A, the first electrode sheet 25b of the present embodiment includes multiple warp filament assemblies 72ab and multiple weft filament assemblies 72bb. The first electrode sheet 25b includes first openings 34a that are opened between the multiple warp filament assemblies 72ab and the multiple weft filament assemblies 72bb. The first openings 34a penetrate through the first electrode sheet 25b. In the present Comparative Example 3-1, an opening ratio, which is a ratio of the opening area of the first openings 34a formed in the first electrode sheet 25b to the area of the first electrode sheet 25b, is 20%.

As shown in FIG. 36B, the second electrode sheet 26b of the present embodiment is substantially identical to the first electrode sheet 25a except that the second electrode sheet 26b includes second openings 34b that are opened between the multiple warp filament assemblies 72ab and the multiple weft filament assemblies 72bb, so repeated descriptions will be omitted. In the present Comparative Example 3-1, an opening ratio, which is a ratio of the opening area of the second openings 34b formed in the second electrode sheet 26b to the area of the second electrode sheet 26 of the present embodiment, is 20%.

In the present Comparative Example 3-1, the resin constituting the filament 71 is polyethylene terephthalate (PET), and the diameter of the filament 71 is 10 to 20 μm. The metal constituting the plating layer 33 has a three-layer structure, with the outermost layer being Ni, the intermediate layer being Cu, and the innermost layer (filament 71b side) being Ni. The diameter of the warp filament assembly 72a is about 70 μm, and the diameter of the weft filament assembly 72b is about 70 μm.

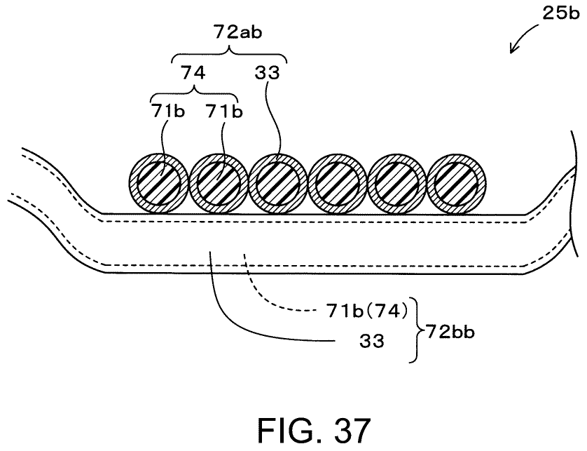

As shown in FIG. 37, the plating layer 33 is formed on at least a part of a surface of a non-twisted bundle 74b constituting the warp filament assembly 72ab and the weft filament assembly 72bb. In the present embodiment, the plating layer 33 is formed on the entire circumference of the surface of the non-twisted bundle 74b.

The warp filament assembly 72ab and the weft filament assembly 72bb are electrically connected to each other by the contact between the plating layer 33 of the warp filament assembly 72ab and the plating layer 33 of the weft filament assembly 72bb.

Since configurations other than the above are the same as those in Example 3-1, repeated descriptions will be omitted.

In addition, in the present Comparative Example 3-1, the insulating sheet 24 is an ether-based polyurethane foamed body. The first bonding part 36 is an acrylic adhesive manufactured by Nogawa Chemical Co., Ltd. The thickness of the first bonding part 36 is 50 μm. Since the first bonding part 36 and the second bonding part 37 are identical, repeated descriptions will be omitted. Sample 3-3 of the sensor sheet 18 related to the first electrode sheet 25b and the second electrode sheet 26b of Comparative Example 3-1 is prepared in the same manner as Sample 3-1. Descriptions overlapping with Sample 3-1 will be omitted.

### 3.1.7.4. Tensile Test of First Electrode Sheet

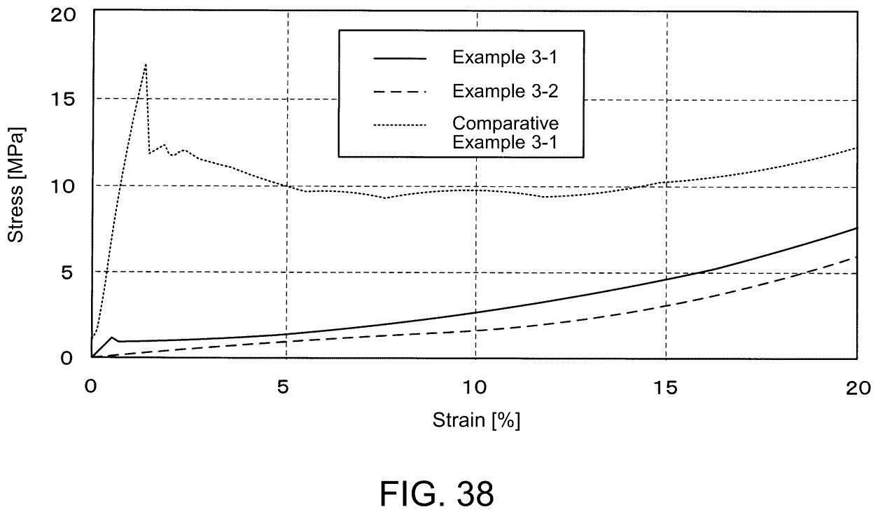

Next, the tensile test performed on the first electrode sheet will be described with reference to FIG. 38. Test pieces were prepared by cutting the first electrode sheets related to Examples 3-1 to 3-2 and Comparative Example 3-1 into a strip shape of 150 mm×20 mm. The thickness of the first electrode sheet is different among Examples 3-1 to 3-2 and Comparative Example 3-1 but is about 0.1 mm. The angle formed between the longitudinal direction of the test piece and the longitudinal direction of the warp filament assembly 72a is set to 45°.

The test piece is held by a pair of chucks. The distance between the pair of chucks is 70 mm. The tensile test is performed on the test piece at a tensile speed of 1 mm/sec, and a stress is calculated by dividing a load by a cross-sectional area of the test piece. The tensile testing machine is AGS-X 1 kN manufactured by Shimadzu Corporation. The tensile test is performed in a range with a strain being 0 to 20%. FIG. 38 is a graph showing changes in the stress with respect to the strain.

In Example 3-1 and Example 3-2, in a region with the strain being 0 to 20%, the stress increased gradually and monotonically. In the stress-strain curve in the tensile test, Example 3-1 and Example 3-2 do not have a yield point showing a local maximum value in a range with the strain being 0.5 to 10%.

Example 3-1 shows a stress of about 1.4 MPa at a strain of 5%, and shows a stress of about 7.5 MPa at a strain of 20%. Example 3-2 shows a stress of about 0.9 MPa at a strain of 5%, and shows a stress of about 5.9 MPa at a strain of 20%. In the first electrode sheets 25 and 25a related to Example 3-1 and Example 3-2, a maximum value of the stress at a strain of 0 to 5% is 3 MPa or less, and a maximum value of the stress at a strain of 0 to 20% is 15 MPa or less.

In the stress-strain curve in the tensile test, Comparative Example 3-1 has a yield point showing a local maximum value in the range with the strain being 0.5 to 10%. In a region with the strain being 0 to about 1%, the stress increased linearly and monotonically. At a strain of about 1%, the stress showed about 17 MPa which is a local maximum value, and rapidly decreased to about 12 MPa. In this manner, in Comparative Example 3-1, before and after the strain of about 1%, the stress changed from an increasing trend to a decreasing trend. Thereafter, in a region with the strain being about 1 to about 13%, the stress monotonically decreased from about 12 to about 10 MPa. Thereafter, in a region with the strain being about 13 to 20%, the stress monotonically increased from about 10 to about 12 MPa. In this manner, in Comparative Example 3-1, in the stress-strain curve, the maximum value of the stress at a strain of 0 to 5% is greater than 3 MPa, and the maximum value of the stress at a strain of 0 to 20% is greater than 15 MPa.

### 3.1.7.5. Tensile Test of Sensor Sheet

Next, the tensile test performed on the sensor sheet will be described. Test pieces are prepared by cutting the sensor sheets related to Samples 3-1 to 3-2 and Sample 3-3 into a strip shape of 90 mm×20 mm. The thickness of the sensor sheet is different among Samples 3-1 to 3-2 and Sample 3-3 but is about 1 mm. The angle formed between the longitudinal direction of the test piece and the longitudinal direction of the warp filament assembly 72a constituting the first electrode sheet and the second electrode sheet is set to 45°.

An electric wire is connected to one end of the first electrode sheet in the longitudinal direction and is connected to a DC power supply. An electric wire is connected to the other end of the first electrode sheet in the longitudinal direction and is connected to a voltage measuring instrument.

The test piece is held by a pair of chucks. The distance between the pair of chucks is 50 mm. The tensile test is performed on the test piece at a tensile speed of 1 mm/sec, and a stress is calculated by dividing a load by a cross-sectional area of the test piece. In addition, during the tensile test, a DC resistance value (an example of the electrical resistance value) of the sensor sheet is calculated from a voltage of the DC power supply and a voltage drop of the sensor sheet.

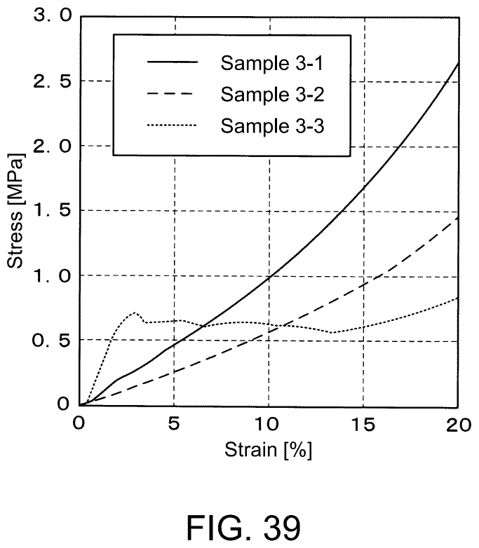

FIG. 39 shows a stress-strain curve in the tensile test performed on the sensor sheet. FIG. 39 shows a graph of a region with the strain being 0 to 20%. The stress of Samples 3-1 to 3-2 increased monotonically in the region with the strain being 0 to 20%. In the stress-strain curve in the tensile test, Sample 3-1 and Sample 3-2 do not have a yield point showing a local maximum value in a range with the strain being 0.5 to 10%.

Sample 3-1 shows a stress of about 0.5 MPa at a strain of 5%, and shows about 2.6 MPa, which is a maximum value of the stress, at a strain of 20%. Sample 3-2 shows a stress of about 0.3 MPa at a strain of 5%, and shows about 1.5 MPa, which is a maximum value of the stress, at a strain of 20%. In Sample 3-1 and Sample 3-2, in the stress-strain curve, a maximum value of the stress at a strain of 0 to 5% is 0.5 MPa or less, and a maximum value of the stress at a strain of 0 to 20% is 3 MPa or less. In Sample 3-1 and Sample 3-2, in the stress-strain curve, the stress at a strain of 0 to 5% is 0.5 MPa or less, and the maximum value of the stress at a strain of 0 to 20% is 3 MPa or less.

In the stress-strain curve in the tensile test, Sample 3-3 has a yield point showing a local maximum value in a range with the strain being 0.5 to 10%. In a region with the strain being 0 to about 3%, the stress increased linearly and monotonically. At a strain of about 3%, the stress showed about 0.7 MPa which is a local maximum value, and rapidly decreased to about 0.6 MPa. In this manner, in Sample 3-3, before and after the strain of about 3%, the stress changed from an increasing trend to a decreasing trend. Thereafter, in a region with the strain being about 1 to about 13%, the stress slightly decreased. Thereafter, in a region with the strain being about 13 to 20%, the stress monotonically increased from about 0.6 to about 0.8 MPa. In this manner, in Sample 3-3, in the stress-strain curve, the maximum value of the stress at a strain of 0 to 5% is greater than 0.5 MPa, and the maximum value of the stress at a strain of 0 to 20% is greater than 0.7 MPa.

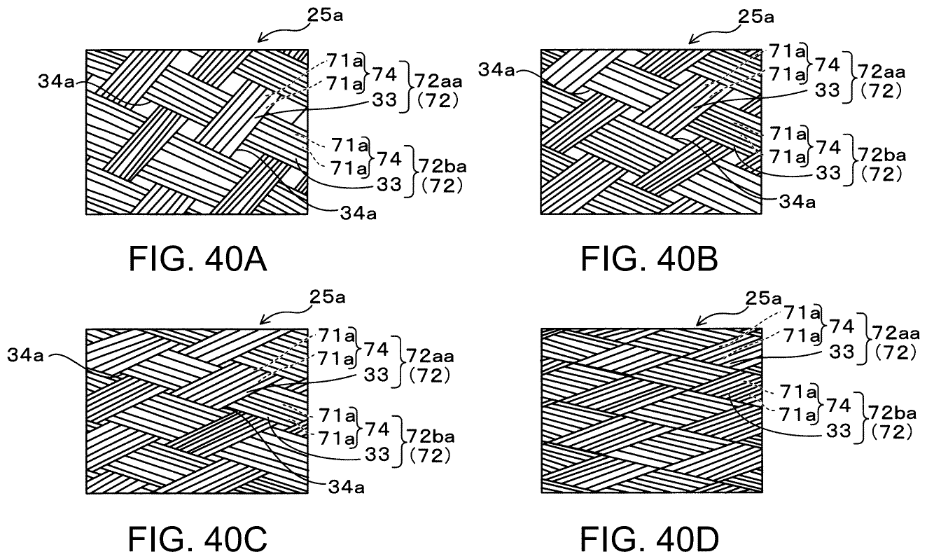

Upon application of a tensile force to Sample 3-1 and Sample 3-2, the first openings 34a of the first electrode sheet elongate in the tensile direction and contract in the direction intersecting the tensile direction. FIG. 40A to FIG. 40D show states of deformation of the first openings 34a, taking Sample 3-2 as an example. As shown in FIG. 40A, in the state of an elongation rate of 0%, the first openings 34a are open, but as the elongation rate increases to 10% (refer to FIG. 40B), 20% (refer to FIG. 40C), and 30% (refer to FIG. 40D), the gaps between the fibers of the conductive cloth decrease, and in the state of the elongation rate of 30%, the first openings 34a almost disappear. It is thought that since stretching readily occurs due to such changes in the fiber shape, the stress generated during stretching is small. In other words, it is thought that the presence of the first openings 34a contributes to the expression of such structural stretchability and flexibility of the fibers. Since the above configuration is the same in the second electrode sheet, descriptions will be omitted. Since the same also applies to Sample 3-1, descriptions will be omitted.

In Sample 3-1 and Sample 3-2, it is thought that, in the case where a tensile force is applied to the sensor sheet, the tensile force is absorbed by gradual deformation of the first openings 34a. Accordingly, at the portion at which the warp filament assembly 72a and the weft filament assembly 72b intersect each other, it is thought that since relative positions between the warp filament assembly 72a and the weft filament assembly 72b do not change much, an electrical connection state between the warp filament assembly 72a and the weft filament assembly 72b is maintained. Accordingly, in Sample 3-1 and Sample 3-2, it is thought that the DC resistance value hardly changes even in the case where a tensile force is applied to the sensor sheet.

In addition, Sample 3-1 and Sample 3-2 do not have a yield point showing a local maximum value in a range with the strain being 0.5 to 5%. This is thought to be because, in Sample 3-1 and Sample 3-2, in the range with the strain being 0.5 to 5%, no significant change occurs in the structure of the plating layer 33 formed on the first electrode sheet and the second electrode sheet. Accordingly, a change in the electrical resistance value of the sensor sheet 18 is suppressed.

In contrast, Sample 3-3 has a yield point showing a local maximum value in the range with the strain being 0.5 to 5%. In Sample 3-3, in a range from the strain of 0% to the yield point, it is thought that elastic deformation occurs by maintaining of the plating layer 33 formed at the portion at which the warp filament assembly 72a and the weft filament assembly 72b intersect each other. Thereafter, it is thought that, at the yield point, the plating layer 33 formed at the portion at which the warp filament assembly 72a and the weft filament assembly 72b intersect each other is destroyed.

Thereafter, in a range in which the stress does not change much (a range with the strain being about 5 to about 15%), it is thought that the tensile force is absorbed by deformation of the first openings 34a and the second openings 34b, in a manner similar to Sample 3-1 and Sample 3-2.

Thereafter, as the strain becomes greater than about 15%, since the first opening ratio and the second opening ratio of Sample 3-3 are 20%, it is thought that the first openings 34a and the second openings 34b become completely closed, and the tensile force acting on the first electrode sheet and the second electrode sheet can no longer be absorbed. Accordingly, it is thought that the stress increases.

### 3.1.7.6. DC Resistance Value Change Rate of Sensor Sheet

Next, the DC resistance value change rate of the sensor sheet was measured. A test piece was prepared by cutting the sensor sheet into a strip shape of 90 mm×20 mm. The angle formed between the longitudinal direction of the test piece and the longitudinal direction of the warp filament assembly 72a is set to 45°.

The test piece is held by a pair of chucks. The distance between the pair of chucks is 50 mm. The tensile test is performed on the test piece at a tensile speed of 1 mm/sec. Electric wires were connected respectively to both ends of the first electrode sheet, and the DC resistance value between the two electric wires was measured. The DC resistance value change rate is calculated based on Formula (1) below for the DC resistance value at this time. Measurement of the DC resistance value is performed using a digital multimeter 2000 series manufactured by KEITHLEY. The above test is performed for Samples 3-1 to 3-2 and Sample 3-3.

$$\begin{matrix}[ Math . 2 ] & \\ DC resistance value change rate = \frac{Difference in DC resistance value before and after stretching}{Initial DC resistance value before stretching} \times 1 \; 00 [ \% ] & ( 1 )\end{matrix}$$

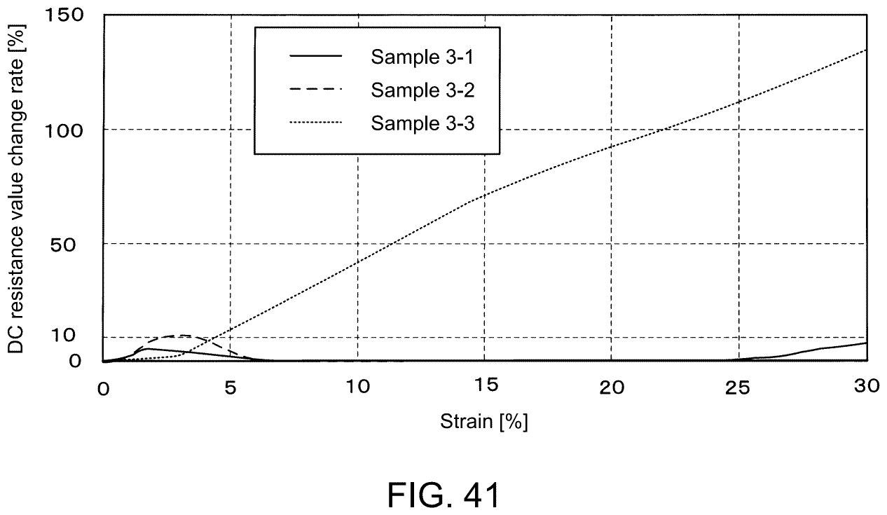

FIG. 41 is a graph showing changes in the DC resistance value change rate with respect to the strain. The DC resistance value change rate of Sample 3-1 increased in a range with the strain being 0 to about 2%, and the DC resistance value change rate became about 5% at a strain of about 2%. Thereafter, decreasing in a range of about 2 to about 5%, the DC resistance value change rate became about 0%. Thereafter, at a strain of about 25% or more, the DC resistance value change rate gradually increased, and the DC resistance value change rate became about 7% at a strain of 30%. In this manner, the DC resistance value change rate of Sample 3-1 was 10% or less in a range with the strain being 0 to 30%.

The DC resistance value change rate of Sample 3-2 increased in a range with the strain being 0 to about 3%, and the DC resistance value change rate became about 10% at a strain of about 3%. Thereafter, decreasing in a range of about 3 to about 5%, the DC resistance value change rate became about 0%. Thereafter, even at a strain of 30%, the DC resistance value change rate was about 0%. In this manner, the DC resistance value change rate of Sample 3-2 was 10% or less in the range with the strain being 0 to 30%.

The DC resistance value change rate of Sample 3-3 was about 2% in a range with the strain being 0% to about 3%. Thereafter, in a range with the strain being about 3% to 30%, the DC resistance value change rate increased monotonically, and became about 130% at a strain of 30%. In this manner, the DC resistance value change rate of Sample 3-3 was greater than 10% in the range with the strain being 0 to 30%, and compared to Sample 3-1 and Sample 3-2, the resistance change during stretching was extremely large.

### 3.1.7.7. DC Resistance Value Change Rate of Sensor Sheet During 10% Elongation

Next, the DC resistance value change rate of the sensor sheet during 10% elongation was measured. A test piece was prepared by cutting the sensor sheet into a strip shape of 90 mm×20 mm. The angle formed between the longitudinal direction of the test piece and the longitudinal direction of the warp filament assembly 72a is set to 45°.

The test piece is held by a pair of chucks. The distance between the pair of chucks is 50 mm. The tensile test is performed on the test piece at a tensile speed of 1 mm/sec. Electric wires were connected respectively to both ends of the first electrode sheet, and the DC resistance value between the two electric wires was measured. The DC resistance value change rate is calculated based on Formula (1) below for the DC resistance value at this time. Measurement of the DC resistance value is performed using a digital multimeter 2000 series manufactured by KEITHLEY. The above test is performed for Samples 3-1 to 3-2 and Sample 3-3.

When measuring the DC resistance value change rate of the sensor sheet described above, with respect to a reference length (50 mm) of the state before applying a tensile force to the sensor sheet, a test of elongating the sensor sheet by 10%, then returning to the reference length, and again elongating by 10% is repeated for a predetermined number of times. The number of repetitions in this test is 1 time, 5 times, and 10 times. The DC resistance value change rate is calculated based on Formula (1) above for the DC resistance value at this time. The above test is performed for Samples 3-1 to 3-2 and Sample 3-3.

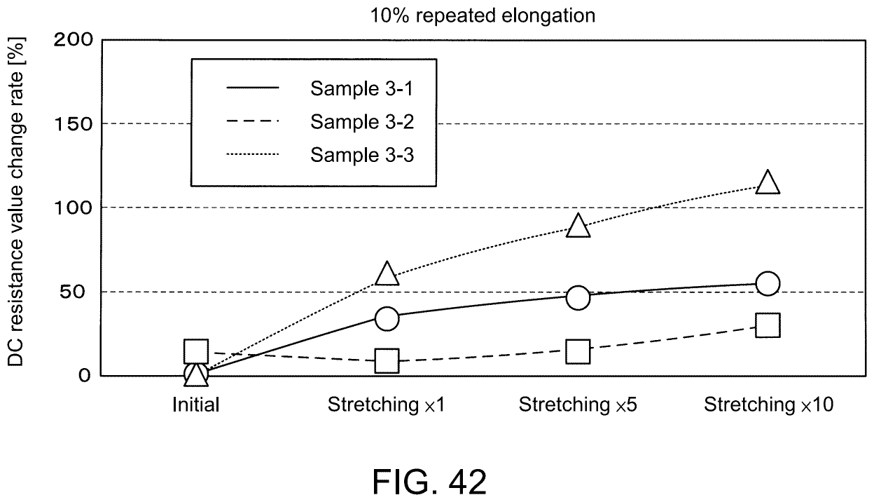

FIG. 42 shows a graph related to a relationship between the number of repetitions of the tensile test and the DC resistance value change rate. In Sample 3-1, the DC resistance value change rate at the initial measurement was about 0%. Thereafter, as the number of repetitions increased, the DC resistance value change rate increased to about 36% upon 1 repetition, to about 48% upon 5 repetitions, and to about 57% upon 10 repetitions. Upon 10 repetitions, the DC resistance value change rate of Sample 3-1 was 60% or less.

In Sample 3-2, the DC resistance value change rate at the initial measurement was about 14% and was larger than that of Sample 3-1. However, the DC resistance value change rate did not increase much even though the number of repetitions increased, with the DC resistance value change rate being about 9% upon 1 repetition and about 15% upon 5 repetitions. Upon 10 repetitions, the DC resistance value change rate was about 30%. Upon 10 repetitions, the DC resistance value change rate of Sample 3-2 was 50% or less.

In Sample 3-3, the DC resistance value change rate at the initial measurement was equivalent to that of Sample 3-1 and was about 0%. However, compared to Sample 3-1 and Sample 3-2, the DC resistance value change rate increased more as the number of repetitions increased, with the DC resistance value change rate being about 61% upon 1 repetition, being about 89% upon 5 repetitions, and being about 115% upon 10 repetitions.

As described above, it was learned that a change in the DC resistance value of the sensor sheets related to Samples 3-1 and 3-2 is small compared to Sample 3-3, even in the case where the 10% elongation test was repeated.

### 3.1.7.8. DC Resistance Value Change Rate of Sensor Sheet During 20% Elongation

Next, the DC resistance value change rate of Samples 3-1 to 3-2 and Sample 3-3 in the case of elongating the sensor sheet by 20% is measured.

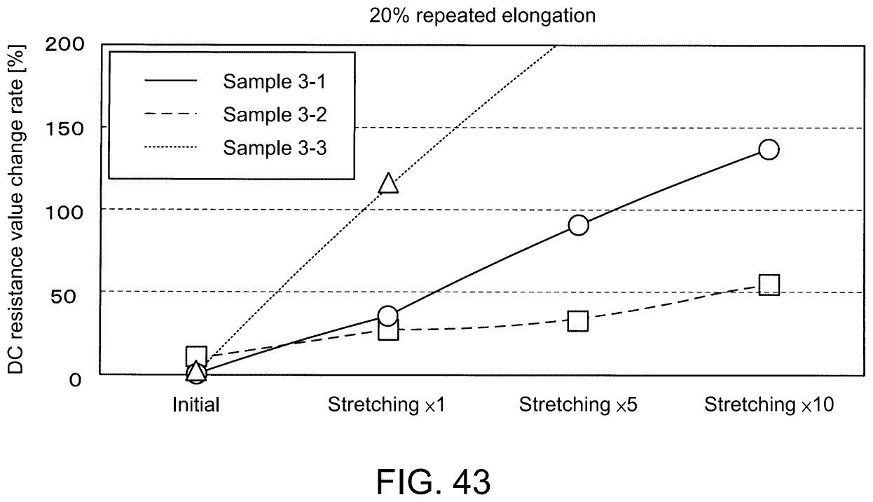

FIG. 43 shows a graph related to a relationship between the number of repetitions of the tensile test and the DC resistance value change rate. In Sample 3-1, the DC resistance value change rate at the initial measurement was about 0%. Thereafter, as the number of repetitions increased, the DC resistance value change rate increased to about 35% upon 1 repetition and to about 91% upon 5 repetitions. Upon 10 repetitions, the DC resistance value change rate was about 137%.

In Sample 3-2, the DC resistance value change rate at the initial measurement was about 10% and was larger than that of Sample 3-1. However, the DC resistance value change rate did not increase much even though the number of repetitions increased, with the DC resistance value change rate being about 27% upon 1 repetition and being about 32% upon 5 repetitions. Upon 10 repetitions, the DC resistance value change rate of Sample 3-2 was about 55%.

In Sample 3-3, the DC resistance value change rate at the initial measurement was about 0% and was equivalent to that of Sample 3-1. However, the DC resistance value change rate showed about 114% upon 1 repetition and exceeded 200% upon 5 repetitions.

As described above, it was learned that a change in the DC resistance value of the sensor sheets related to Samples 3-1 and 3-2 is small compared to Sample 3-3, even in the case where the 20% elongation test was repeated.

### 3.1.8. Actions and Effects of Present Embodiment

Next, actions and effects of the present embodiment will be described. The sensor sheet 18 related to the present embodiment includes an insulating sheet 24, a first electrode sheet 25, 25a, a first bonding part 36, a second electrode sheet 26, and a second bonding part 37. The insulating sheet 24 has a first surface 27 and a second surface 28 and is formed of a foamed body. The first electrode sheet 25, 25a has conductivity, is disposed on the first surface 27 side of the insulating sheet 24, and has first openings 34a penetrating through the first electrode sheet 25, 25a. The first bonding part 36 bonds the insulating sheet 24 and the first electrode sheet 25, 25a to each other. The second electrode sheet 26 has conductivity, is disposed on the second surface 28 side of the insulating sheet 24, and has second openings 34b penetrating through the second electrode sheet 26. The second bonding part 37 bonds the insulating sheet 24 and the second electrode sheet 26 to each other. The first electrode sheet 25, 25a and the second electrode sheet 26 are conductive cloths woven with multiple filament assemblies 72. The filament assembly 72 includes multiple filaments 71 and a plating layer 33 formed on at least a part of a surface of the filament 71. The first electrode sheet 25, 25a has the first openings 34a that are opened between the multiple filament assemblies 72, and the second electrode sheet 26 has the second openings 34b that are opened between the multiple filament assemblies 72. The sensor sheet 18 is configured not to have a yield point showing a local maximum value in a range with a strain being 0.5 to 10% in a stress-strain curve in a tensile test. An opening ratio, which is a ratio of an opening area of the first openings 34a to an area of the first electrode sheet 25, 25a, is 1% or more and 40% or less. An opening ratio, which is a ratio of an opening area of the second openings 34b to an area of the second electrode sheet 26, 26a, is 1% or more and 40% or less.

Upon application of a tensile force to the sensor sheet 18, the first openings 34a of the first electrode sheet 25, 25a deform, and the opening area of the first openings 34a deforms to decrease. In addition, new conductive paths are formed between the multiple filament assemblies 72 which were separated by the first openings 34a. Accordingly, even in the case where a tensile force is applied to the sensor sheet 18, a change in the electrical resistance value can be suppressed. The above also applies to the second openings 34b of the second electrode sheet 26, 26a.

The opening ratio of the first openings 34a is preferably 1% or more and 40% or less. With the opening ratio being 40% or less, in the case where the opening area of the first openings 34a deforms in a decreasing direction, it becomes easy for the multiple filament assemblies 72 to contact each other. In this manner, since it becomes easy for the multiple filament assemblies 72 to contact each other, the opening ratio of the first openings 34a is preferably 1% or more and 40% or less, more preferably 1% or more and 30% or less, and even more preferably 1% or more and 20% or less. The above also applies to the second openings 34b.

The sensor sheet 18 related to the present embodiment is configured not to have a yield point showing a local maximum value in the range with the strain being 0.5 to 10% in the stress-strain curve in the tensile test. Accordingly, in the region with a relatively small strain of 0.5 to 10%, a large stress does not occur, and a rapid change in the stress is suppressed. As a result, efficiency of a work of assembling the sensor sheet 18 to the steering wheel 10 can be improved. Furthermore, by not having a yield point showing a local maximum value in a range with the strain being 0.5 to 5%, since a large stress does not occur and the stress does not change when the sensor sheet 18 is slightly pulled, workability is further improved, which is more preferable.

Upon application of a tensile force to the sensor sheet 18, the first openings 34a of the first electrode sheet 25 deform, and the opening area of the first openings 34a deforms to decrease. In other words, the tensile strain does not concentrate on the filament 71 itself, and stretching is possible due to changes in spatial arrangements of the entirety of the filaments 71. Specifically, since structural stretchability and flexibility are exerted due to a decrease in the opening area associated with changes in the spatial arrangements of the entirety of the filaments 71, the tensile strain applied to the filament 71 itself is small, and damage to the plating layer 33 formed on the filament 71 can be suppressed. Thus, even in the case where a tensile force is applied to the sensor sheet 18, a change in the electrical resistance value can be suppressed.

In addition, since the sensor sheet 18 related to the present embodiment is configured not to have a yield point showing a local maximum value in the range with the strain being 0.5 to 10% in the stress-strain curve in the tensile test, breakage the plating layer 33 in the range with the strain being 0.5 to 10% can be suppressed. Accordingly, a change in the electrical resistance value of the sensor sheet 18 can be suppressed.

The sensor sheet 18 related to the present embodiment is configured such that, in the stress-strain curve, a maximum value of the stress at a strain of 0 to 5% is 0.5 MPa or less. In addition, the sensor sheet 18 is configured such that, in the stress-strain curve, a maximum value of the stress at a strain of 0 to 20% is 3 MPa or less. Accordingly, in the case where a tensile force is applied to the sensor sheet 18, application of an excessively large stress to the first electrode sheet 25, 25a can be suppressed. As a result, since destruction of the structure of the first electrode sheet 25, 25a can be suppressed, a change in the electrical resistance value of the sensor sheet 18 can be suppressed.

From the viewpoint of reducing the stress applied to the first electrode sheet 25, 25a, or from the viewpoint of reducing the stress applied to the second electrode sheet 26, 26a, in the stress-strain curve, the maximum value of the stress of the sensor sheet 18 at a strain of 0 to 5% is preferably 0.5 MPa or less, more preferably 0.4 MPa or less, and even more preferably 0.3 MPa or less.

Similarly, from the viewpoint of reducing the stress applied to the first electrode sheet 25, 25a, or from the viewpoint of reducing the stress applied to the second electrode sheet 26, 26a, in the stress-strain curve, the maximum value of the stress of the sensor sheet 18 at a strain of 0 to 20% is preferably 3 MPa or less, more preferably 2 MPa or less, and even more preferably 1.5 MPa or less.

In addition, the first electrode sheet 25, 25a related to the present embodiment is configured such that, in a stress-strain curve, a maximum value of a stress at a strain of 0 to 5% is 3 MPa or less. Furthermore, the first electrode sheet 25, 25a is configured such that, in the stress-strain curve, a maximum value of the stress at a strain of 0 to 20% is 15 MPa or less. The same also applies to the second electrode sheet 26, 26a.

From the viewpoint of reducing the stress applied to the first electrode sheet 25, 25a, or from the viewpoint of reducing the stress applied to the second electrode sheet 26, 26a, in the stress-strain curve, the maximum value of the stress of the first electrode sheet 25, 25a or the second electrode sheet 26, 26a at a strain of 0 to 5% is preferably 3 MPa or less, more preferably 2 MPa or less, and even more preferably 1 MPa or less.

Similarly, from the viewpoint of reducing the stress applied to the first electrode sheet 25, 25a, or from the viewpoint of reducing the stress applied to the second electrode sheet 26, 26a, the maximum value of the stress of the first electrode sheet 25, 25a or the second electrode sheet 26, 26a at a strain of 0 to 20% is preferably 15 MPa or less, more preferably 10 MPa or less, and even more preferably 7 MPa or less.

The stress-strain curve of the sensor sheet 18 related to the present embodiment is a stress-strain curve in the case of holding a test piece of 20 mm×90 mm and performing a tensile test at a tensile speed of 1 mm/s.

The sensor sheet 18 related to the present embodiment is configured such that, at a strain of 20% in the tensile test, a DC resistance value change rate defined according to Formula (1) is 50% or less.

$$\begin{matrix}[ Math . 3 ] & \\ DC resistance value change rate = \frac{Difference in DC resistance value before and after stretching}{Initial DC resistance value before stretching} \times 1 \; 00 [ \% ] & ( 1 )\end{matrix}$$

The difference in the DC resistance value before and after stretching is a difference obtained by subtracting the initial DC resistance value before stretching from a DC resistance value after stretching.

According to the present embodiment, even in the case where the sensor sheet 18 is elongated, a change in the DC resistance value can be suppressed. Accordingly, a change in the electrical resistance value of the sensor sheet 18 can be suppressed. The DC resistance value change rate is preferably 50% or less, more preferably 30% or less, and even more preferably 11% or less.

The sensor sheet 18 related to the present embodiment is configured such that, upon repeating 10 times a test of configuring the strain to 20% and then returning the strain to 0%, a DC resistance value change rate defined according to Formula (1) is 150% or less.

$$\begin{matrix}[ Math . 4 ] & \\ DC resistance value change rate = \frac{Difference in DC resistance value before and after stretching}{Initial DC resistance value before stretching} \times 1 \; 00 [ \% ] & ( 1 )\end{matrix}$$

The difference in the DC resistance value before and after stretching is a difference obtained by subtracting the initial DC resistance value before stretching from a DC resistance value after stretching.

According to the present embodiment, even in the case where an operation of elongating the sensor sheet 18 and then returning the sensor sheet 18 to the original dimensions is repeated, a change in the DC resistance value can be suppressed. Accordingly, a change in the electrical resistance value of the sensor sheet 18 can be suppressed. The DC resistance value change rate is preferably 150% or less, more preferably 140% or less, and even more preferably 100% or less.

In the present embodiment, a cross-sectional area of each of the multiple filament assemblies 72 is larger than an opening area of the first opening 34a in a state in which no strain is generated in the first electrode sheet 25, 25a. Accordingly, since a ratio of the filament assembly 72 occupying a unit area becomes large, many conductive paths are formed in the first electrode sheet 25, 25a. As a result, even in the case where a tensile force is applied to the sensor sheet 18 and some of the multiple conductive paths are damaged, it becomes possible to retain conductive paths that are electrically conductible. Accordingly, a change in the electrical resistance value of the sensor sheet 18 can be suppressed. In addition, the cross-sectional area of each of the multiple filament assemblies 72 is larger than an opening area of the second opening 34b in a state in which no strain is generated in the second electrode sheet 26, 26a. Since the actions and effects are the same as the first electrode sheet 25, 25a, descriptions will be omitted.

In addition, the multiple filament assemblies 72 related to the present embodiment include warp filament assemblies 72a and weft filament assemblies 72b, and an area of a portion at which the warp filament assembly 72a and the weft filament assembly 72b intersect each other is larger than an opening area of the first opening 34a in a state in which no strain is generated in the first electrode sheet 25, 25a. Similarly, in the second electrode sheet 26, 26a, an area of a portion at which the warp filament assembly 72a and the weft filament assembly 72b intersect each other is larger than an opening area of the second opening 34b in a state in which no strain is generated in the second electrode sheet 26, 26a.

At the portion at which the warp filament assembly 72a and the weft filament assembly 72b intersect each other, the warp filament assembly 72a and the weft filament assembly 72b are electrically conducted to each other. Thus, at the portion at which the warp filament assembly 72a and the weft filament assembly 72b intersect each other, in addition to forming the plating layer 33 on a portion exposed to outside, at a portion close to inside (inner side of intersection), the more regions in which the plating layer 33 is formed, the easier it becomes for the warp filament assembly 72a and the weft filament assembly 72b to be electrically conducted to each other. Thus, according to the present embodiment, even in the case where a tensile force is applied to the sensor sheet 18, electrical conduction between the warp filament assembly 72a and the weft filament assembly 72b can be maintained. As a result, a change in the electrical resistance value of the sensor sheet 18 can be suppressed.

The sensor sheet 18 related to the present embodiment further includes a second electrode sheet 26, 26a, which is conductive, on the second surface 28 of the insulating sheet 24. By including the second electrode sheet 26, 26a, the sensor sheet 18 can be configured to be capable of being electromagnetically shielded, so sensitivity of the sensor sheet 18 can be improved.

The multiple filament assemblies 72 related to the present embodiment include warp filament assemblies 72a and weft filament assemblies 72b. The warp filament assembly 72a and the weft filament assembly 72b include a non-twisted bundle 74 in which multiple filaments 71 are bundled in an untwisted state, and a plating layer 33 formed on at least a part of a surface of the non-twisted bundle 74.

With the filament assembly 72 being the non-twisted bundle 74, the multiple filaments 71 constituting the filament assembly 72 are configured to easily move relatively freely. Thus, even in the case where a tensile force is applied to the sensor sheet 18, it becomes possible to absorb the stress by movement of the multiple filaments 71 constituting the non-twisted bundle 74. Accordingly, since application of an excessive stress to the sensor sheet 18 is suppressed, a change in the electrical resistance value of the sensor sheet 18 can be suppressed.

In the filament assembly 72 related to the present embodiment, a portion electrically connected by mutual contact between the plating layers 33 formed on surfaces of the filaments 71 adjacent to each other is also present on outer surfaces of the multiple filaments 71 located inside the non-twisted bundle 74 formed in a bundle shape. Thus, in the case where a tensile force is applied to the sensor sheet 18, even if the plating layer 33 formed on the outer surfaces of the filaments 71 located on the surface of the non-twisted bundle 74 breaks, the plating layer 33 formed on the outer surfaces of the multiple filaments 71 located inside the non-twisted bundle 74 is still present. As a result, due to mutual contact between the plating layers 33 formed on the outer surfaces of the multiple filaments 71 located inside the non-twisted bundle 74, a change in the electrical resistance value can be suppressed even in the case where a tensile force is applied to the sensor sheet 18.

### Embodiment 3-2

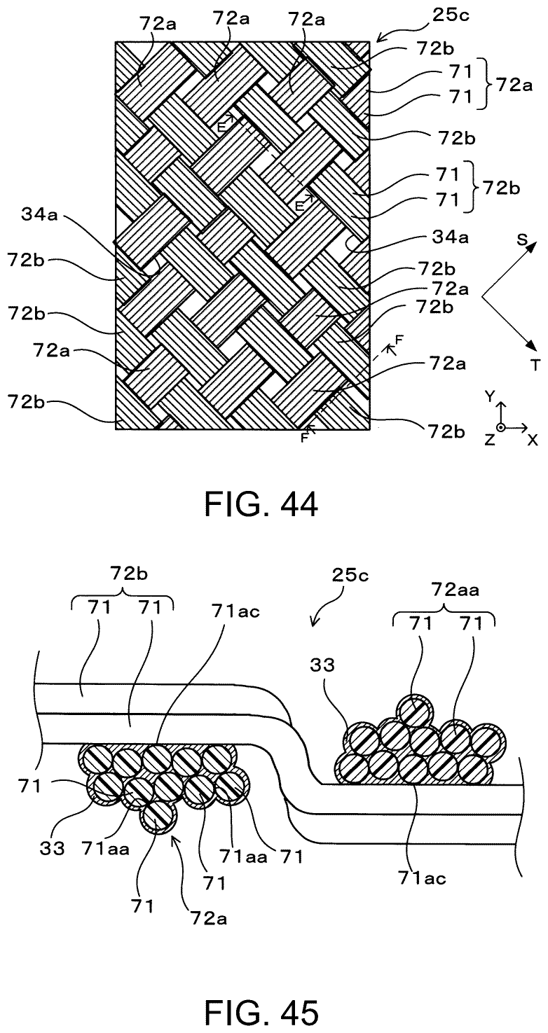

Next, Embodiment 3-2 will be described with reference to FIG. 44 to FIG. 47. Among reference signs used in Embodiment 3-2 onward, reference signs identical to those used in the previous embodiments represent the same constituent elements as those in the previous embodiments unless otherwise stated.

### 3.2.1. Configuration of First Electrode Sheet 25c

As shown in FIG. 44, a first electrode sheet 25c related to Embodiment 3-2 includes warp filament assemblies 72a and weft filament assemblies 72b. As described above, the warp filament assembly 72a and the weft filament assembly 72b include a non-twisted bundle 74 in which multiple filaments 71 are bundled in an untwisted state, and a plating layer 33 formed on a surface of the non-twisted bundle 74. Although not shown in detail, the sensor sheet 18 related to the present embodiment includes a second electrode sheet on the second surface side of the insulating sheet 24. Since the configuration of the second electrode sheet is substantially identical to that of the first electrode sheet 25c, repeated descriptions will be omitted.

Any metal or alloy, such as copper, nickel, tin, solder, etc. may be appropriately selected as the metal constituting the plating layer 33. Since the metal constituting the plating layer 33 is the same as that in Embodiment 3-1, repeated descriptions will be omitted.

In the present embodiment, the metal species constituting the plating layer 33 of the multiple warp filament assemblies 72a and the metal species constituting the plating layer 33 of the multiple weft filament assemblies 72b are the same as each other. However, the metal species constituting the plating layer 33 of the multiple warp filament assemblies 72a and the metal species constituting the plating layer 33 of the multiple weft filament assemblies 72b may also be different from each other. In addition, the metal species constituting the plating layer 33 of the multiple warp filament assemblies 72a may differ in an arrangement direction of the multiple warp filament assemblies 72a. In addition, the metal species constituting the plating layer 33 of the multiple weft filament assemblies 72b may differ in an arrangement direction of the multiple weft filament assemblies 72b. In addition, of at least two warp filament assemblies 72a among the multiple warp filament assemblies 72a, the metal species constituting the plating layer 33 formed at the multiple filaments 71 constituting each warp filament assembly 72a may be different from each other. Similarly, of at least two weft filament assemblies 72b among the multiple weft filament assemblies 72b, the metal species constituting the plating layer 33 formed at the multiple filaments 71 constituting each weft filament assembly 72b may be different from each other.

By varying the metal species, it is possible to create variations between properties (electrical properties, chemical properties, mechanical properties, etc.) of the plating layer 33 of the multiple warp filament assemblies 72a and properties (electrical properties, chemical properties, mechanical properties, etc.) of the multiple weft filament assemblies 72b. Examples of the electrical properties may include an electrical resistance value. Examples of the chemical properties may include an ionization tendency and an affinity. Examples of the mechanical properties may include a friction coefficient, a strength, and an elongation rate. An opening ratio, which is a ratio of the opening area of the first openings 34a formed in the first electrode sheet 25c of the present embodiment to the area of the first electrode sheet 25c, is 30% or more. However, the value of the opening ratio is not particularly limited and may also be less than 30%.

As shown in FIG. 44, each warp filament assembly 72a includes multiple filaments 71. The number of the filaments 71 constituting one warp filament assembly 72a is not particularly limited.

As shown in FIG. 44, each weft filament assembly 72b includes multiple filaments 71.

As shown in FIG. 47, the longitudinal direction S of the multiple warp filament assemblies 72a and the longitudinal direction X of the first electrode sheet 25c are configured to intersect each other. In addition, the longitudinal direction T of the multiple weft filament assemblies 72b and the longitudinal direction X of the first electrode sheet 25c are configured to intersect each other. Specifically, the longitudinal direction S of the multiple warp filament assemblies 72a forms an acute angle that is substantially 45° with respect to the longitudinal direction X of the first electrode sheet 25c. In addition, the longitudinal direction T of the multiple weft filament assemblies 72b forms an acute angle that is substantially 45° with respect to the longitudinal direction X of the first electrode sheet 25c. The same also applies to the second electrode sheet.

As shown in FIG. 45, the plating layer 33 is formed on at least a part of the surface of each filament 71 constituting the warp filament assembly 72a. The plating layer 33 may be formed on the entire surface of each filament 71 constituting the warp filament assembly 72a, or the plating layer 33 may be formed on a part of the surface of each filament 71 constituting the warp filament assembly 72a. In the present embodiment, the plating layer 33 is formed on the surface of each filament 71 excluding warp filament contact points 71aa at which adjacent filaments 71 contact each other. In the present embodiment, the plating layer 33 is also formed on the surfaces of the filaments 71 located in an inner region of one warp filament assembly 72a. The filaments 71 adjacent to each other are electrically connected to each other by the plating layer 33 in the region exposed on the surface of the first electrode sheet 25c.

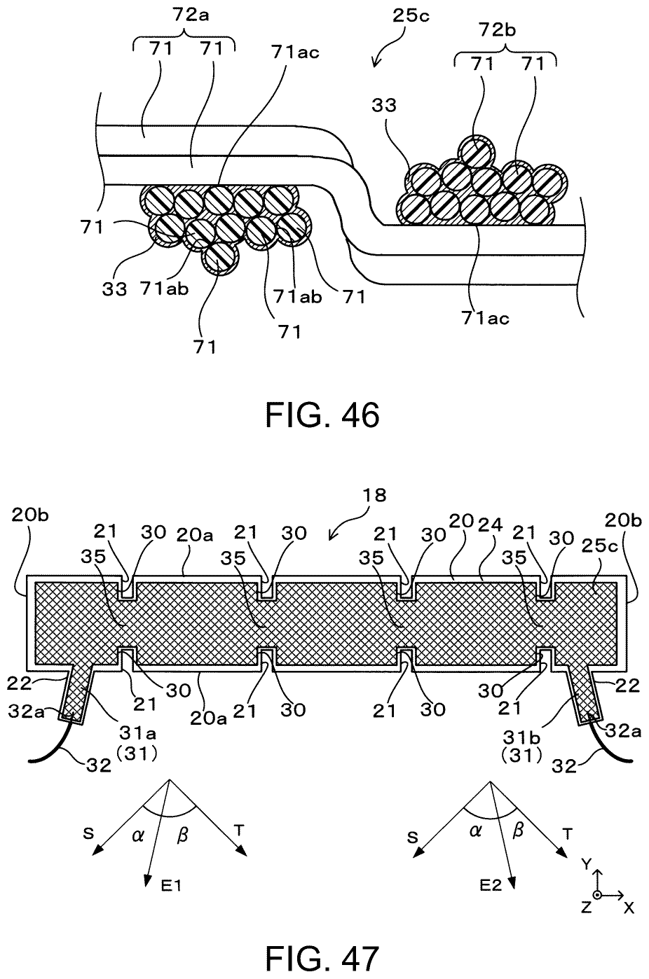

As shown in FIG. 46, the plating layer 33 is formed on at least a part of the surface of each filament 71 constituting the weft filament assembly 72b. The plating layer 33 may be formed on the entire surface of each filament 71 constituting the weft filament assembly 72b, or the plating layer 33 may be formed on a part of the surface of each filament 71 constituting the weft filament assembly 72b. In the present embodiment, the plating layer 33 is formed on the surface of each filament 71 excluding weft filament contact points 71ab at which adjacent filaments 71 contact each other. In the present embodiment, the plating layer 33 is also formed on the surfaces of the filaments 71 located in an inner region of one weft filament assembly 72b. The filaments 71 adjacent to each other are electrically connected to each other by the plating layer 33 in the region exposed on the surface of the first electrode sheet 25c.

In addition, in the present embodiment, the plating layer 33 is formed on the surface of each filament 71 excluding weft filament contact points 71ab at which the filaments 71 constituting the warp filament assembly 72a and the filaments 71 constituting the weft filament assembly 72b contact each other. The warp filament assembly 72a and the weft filament assembly 72b are electrically connected to each other by the plating layer 33.

### 3.2.2. Relationship Between First Electrode Sheet 25c and Narrow Part 35

3.2.2.1. As shown in FIG. 47, in the first electrode sheet 25c, a region interposed between two recesses 30 formed at positions overlapping in the intersecting direction Y is taken as a narrow part 35 which is narrower in the intersecting direction Y than other portions. At the narrow part 35, an occupied area of the multiple warp filament assemblies 72a projected in a thickness direction Z of the narrow part 35 is larger than an occupied area of the multiple weft filament assemblies 72b projected in the thickness direction Z of the narrow part 35.

3.2.2.2. At the narrow part 35, an interval between adjacent weft filament assemblies 72b is smaller than an interval between adjacent warp filament assemblies 72a.

3.2.2.3. The number of the multiple filaments 71 constituting the warp filament assembly 72a at the narrow part 35 is greater than the number of the multiple filaments 71 constituting the warp filament assembly 72a at a portion different from the narrow part 35.

3.2.2.4. The number of the multiple filaments 71 constituting the weft filament assembly 72b at the narrow part 35 is greater than the number of the multiple filaments 71 constituting the weft filament assembly 72b at a portion different from the narrow part 35.

The configurations described in sections 3.2.2.1. to 3.2.2.4. above are independent of each other, all of the configurations described in sections 3.2.2.1. to 3.2.2.4. may be included, or at least one selected from the configurations described in sections 3.2.2.1. to 3.2.2.4. may be included. In addition, the configurations described in sections 3.2.2.1. to 3.2.2.4. may also be omitted.

### 3.2.3. Relationship Between First Electrode Sheet 25c and Extension Part 31

As described above, in the first electrode sheet 25c of the present embodiment, the longitudinal direction S of the multiple warp filament assemblies 72a forms an acute angle that is substantially 45° with respect to the longitudinal direction X of the first electrode sheet 25c, and the longitudinal direction T of the multiple weft filament assemblies 72b forms an acute angle that is substantially 45° with respect to the longitudinal direction X of the first electrode sheet 25c. In FIG. 47, extending directions of the multiple warp filament assemblies 72a and the multiple weft filament assemblies 72b of the first electrode sheet 25c are schematically shown by a grid pattern inclined at an inclination of 45°.

3.2.3.1. As shown in FIG. 47, at extension parts 31a and 31b of the first electrode sheet 25c, an angle α formed between an extending direction E1 of the extension part 31a formed on the left side of FIG. 47 and the longitudinal direction S of the multiple warp filament assemblies 72a is smaller than an angle β formed between the extending direction E1 of the extension part 31a and the longitudinal direction T of the multiple weft filament assemblies 72b.

3.2.3.2. As shown in FIG. 47, at the extension part 31 of the first electrode sheet 25c, an angle α formed between an extending direction E2 of the extension part 31b formed on the right side of FIG. 47 and the longitudinal direction S of the multiple warp filament assemblies 72a is greater than an angle β formed between the extending direction E2 of the extension part 31b and the longitudinal direction T of the multiple weft filament assemblies 72b. The same also applies to the second electrode sheet.

3.2.3.3. At the extension part 31 of the first electrode sheet 25c, an occupied area of the multiple warp filament assemblies 72a projected in a thickness direction Z of the extension part 31 is greater than an occupied area of the multiple weft filament assemblies 72b projected in the thickness direction Z of the extension part 31.

3.2.3.4. At the extension part 31 of the first electrode sheet 25c, an interval between adjacent filaments 71 of the weft filament assembly 72b is smaller than an interval between adjacent filaments 71 of the warp filament assembly 72a.

3.2.3.5. The number of the multiple filaments 71 constituting the warp filament assembly 72a at the extension part 31 of the first electrode sheet 25c is greater than the number of the multiple filaments 71 constituting the warp filament assembly 72a at a portion different from the extension part 31.

3.2.3.6. The number of the multiple filaments 71 constituting the weft filament assembly 72b at the extension part 31 of the first electrode sheet 25c is greater than the number of the multiple filaments 71 constituting the weft filament assembly 72b at a portion different from the extension part 31.

The configurations described in sections 3.2.3.1. to 3.2.3.6. above are independent of each other, all of the configurations described in sections 3.2.3.1. to 3.2.3.6. may be included, or at least one selected from the configurations described in sections 3.2.3.1. to 3.2.3.6. may be included. In addition, the configurations described in sections 3.2.3.1. to 3.2.3.6. may also be omitted. The same also applies to the second electrode sheet.

### 3.2.4. Bending Test

When a bending test is performed on the first electrode sheet 25c at an angle of 135° using a clamp with a load of 50 g and R 0.38 mm in accordance with JIS P8115:2001, the increase rate of the electrical resistance value preferably after 1000 cycles is 50% or less, the increase rate of the electrical resistance value more preferably after 2000 cycles is 50% or less, the increase rate of the electrical resistance value even more preferably after 5000 cycles is 50% or less, and the increase rate of the electrical resistance value particularly preferably after 10000 cycles is 50% or less. Accordingly, it is possible to obtain a sensor sheet 18 in which an increase in the electrical resistance value is suppressed even in the case where an external force is applied.

### 3.2.5. Actions and Effects of Present Embodiment

Next, actions and effects of the present embodiment will be described. The first electrode sheet 25c related to the sensor sheet 18 of the present embodiment is a conductive cloth including multiple warp filament assemblies 72a having multiple filaments 71, and multiple weft filament assemblies 72b having multiple filaments 71. A plating layer 33 composed of metal is formed on a surface of each filament 71.

According to the present embodiment, in the case where an external force is applied to the sensor sheet 18, even if the plating layer 33 peels off and the conductive path from one end to the other end of one filament 71 is disconnected, the possibility of remaining of conductive paths of other filaments 71 is enhanced. In addition, even in the case where the conductive path between one filament 71 and another filament 71 is disconnected, the possibility of remaining of conductive paths between any other filaments 71 is enhanced. As a result, even in the case where an external force is applied to the sensor sheet 18, it is possible to enhance the possibility of remaining of the conductive paths between the multiple filaments 71 constituting the sensor sheet 18. Thus, it is possible to suppress an increase in the electrical resistance value of the sensor sheet 18 in the case where an external force is applied to the sensor sheet 18.

In addition, in the present embodiment, the multiple warp filament assemblies 72a are arranged side by side at equal intervals, and the multiple weft filament assemblies 72b are arranged side by side at different intervals. The strength of the first electrode sheet 25c can be improved by the multiple warp filament assemblies 72a arranged side by side at equal intervals, and the stretchability of the first electrode sheet 25c can be improved by the multiple weft filament assemblies 72b arranged side by side at different intervals.

In the present embodiment, adjacent filaments 71 constituting the warp filament assembly 72a are electrically connected to each other by the plating layer 33 in a region exposed on a surface of the first electrode sheet 25c. Accordingly, the multiple filaments 71 constituting the warp filament assembly 72a can be electrically connected to each other.

In the present embodiment, adjacent filaments 71 constituting the weft filament assembly 72b are electrically connected to each other by the plating layer 33 in a region exposed on the surface of the first electrode sheet 25c. Accordingly, the multiple filaments 71 constituting the weft filament assembly 72b can be electrically connected to each other.

As shown in FIG. 45, in the present embodiment, the filaments 71 constituting the warp filament assembly 72a contact each other at warp filament contact points 71aa (an example of filament contact points). In addition, as shown in FIG. 46, the filaments 71 constituting the weft filament assembly 72b contact each other at weft filament contact points 71ab (an example of the filament contact points). In addition, as shown in FIG. 45 and FIG. 46, the filaments 71 constituting the warp filament assembly 72a and the filaments 71 constituting the weft filament assembly 72b contact each other at warp-weft filament contact points 71ac (an example of the filament contact points). According to the present embodiment, the plating layer 33 is formed on the surfaces of the multiple filaments 71 excluding the warp filament contact points 71aa, the weft filament contact points 71ab, and the warp-weft filament contact points 71ac. Accordingly, even in the case where an external force is applied to the sensor sheet 18, the possibility of remaining of conductive paths of the multiple filaments 71 constituting the sensor sheet 18 can be enhanced. Accordingly, an increase in the electrical resistance value of the sensor sheet 18 can be suppressed in the case where an external force is applied to the sensor sheet 18.

3.2.6.1. The first electrode sheet 25c related to the present embodiment includes a narrow part 35 that is narrower, than other portions, in an intersecting direction Y intersecting a longitudinal direction X of the first electrode sheet 25c. At the narrow part 35, an occupied area of the multiple warp filament assemblies 72a projected in a thickness direction Z of the narrow part 35 is larger than an occupied area of the multiple weft filament assemblies 72b projected in the thickness direction Z of the narrow part 35. According to the present embodiment, by configuring the occupied area of the multiple warp filament assemblies 72a to be larger than the occupied area of the multiple weft filament assemblies 72b at the narrow part 35, the strength of the narrow part 35 can be improved.

3.2.6.2. At the narrow part 35 of the present embodiment, an interval between adjacent filaments 71 constituting the multiple weft filament assemblies 72b is smaller than an interval between adjacent filaments 71 constituting the multiple warp filament assemblies 72a. Since the narrow part 35 easily deforms significantly, a relatively large force is easily applied, and the plating layer 33 easily peels off. According to the present embodiment, by configuring the interval between the filaments 71 constituting the multiple weft filament assemblies 72b to be smaller than the interval between the filaments 71 constituting the multiple warp filament assemblies 72a, the conductive paths between the filaments 71 constituting the weft filament assembly 72b can be maintained.

3.2.6.3. The number of the multiple filaments 71 constituting the warp filament assembly 72a at the narrow part 35 related to the present embodiment is greater than the number of the multiple filaments 71 constituting the warp filament assembly 72a at a portion different from the narrow part 35. According to the present embodiment, by configuring the number of the multiple filaments 71 constituting the warp filament assembly 72a at the narrow part 35 to be greater than that at another portion, the strength of the narrow part 35 can be improved.

3.2.6.4. The number of the multiple filaments 71 constituting the weft filament assembly 72b at the narrow part 35 related to the present embodiment is greater than the number of the multiple filaments 71 constituting the weft filament assembly 72b at a portion different from the narrow part 35. According to the present embodiment, by configuring the number of the multiple filaments 71 constituting the weft filament assembly 72b at the narrow part 35 to be greater than that at another portion, the strength of the narrow part 35 can be improved.

3.2.6.5. The present embodiment includes extension parts 31a and 31b that extend in extending directions E1 and E2 from a long-side edge extending along the longitudinal direction X of the first electrode sheet 25c. At the extension parts 31a and 31b, an occupied area of the multiple warp filament assemblies 72a projected in a thickness direction Z of the extension parts 31a and 31b is larger than an occupied area of the multiple weft filament assemblies 72b projected in the thickness direction Z of the extension parts 31a and 31b. Accordingly, by configuring the occupied area of the multiple warp filament assemblies 72a to be larger than that of the multiple weft filament assemblies 72b, the strength of the extension parts 31a and 31b can be improved.

3.2.6.6. At the extension part 31a related to the present embodiment, an angle α formed between the extending direction E1 of the extension part 31a and a longitudinal direction S of the multiple warp filament assemblies 72a is smaller than an angle β formed between the extending direction E1 of the extension part 31a and a longitudinal direction T of the multiple weft filament assemblies 72b. According to the present embodiment, the longitudinal direction S of the multiple warp filament assemblies 72a can be configured along the extending direction E1 of the extension part 31a. Accordingly, the strength of the extension part 31a can be improved.

3.2.6.7. At the extension part 31b related to the present embodiment, an angle α formed between the extending direction E2 of the extension part 31b and the longitudinal direction S of the multiple warp filament assemblies 72a is larger than an angle β formed between the extending direction E2 of the extension part 31b and the longitudinal direction T of the multiple weft filament assemblies 72b. Accordingly, the longitudinal direction T of the multiple weft filament assemblies 72b can be configured along the extending direction E2 of the extension part 31b. Accordingly, the strength of the extension part 31b can be improved.

3.2.6.8. At the extension part 31 related to the present embodiment, an interval between adjacent filaments 71 constituting the weft filament assembly 72b is smaller than an interval between adjacent filaments 71 constituting the warp filament assembly 72a. Since the extension part 31 easily deforms significantly, a relatively large force is easily applied, and the plating layer 33 easily peels off. According to the present embodiment, by configuring the interval between adjacent filaments 71 constituting the weft filament assembly 72b to be smaller than the interval between adjacent filaments 71 constituting the warp filament assembly 72a, the conductive paths between the filaments 71 constituting the weft filament assembly 72b can be maintained.

3.2.6.9. The number of the multiple filaments 71 constituting the warp filament assembly 72a at the extension part 31 related to the present embodiment is greater than the number of the multiple filaments 71 constituting the warp filament assembly 72a at a portion different from the extension part 31. According to the present embodiment, by configuring the number of the multiple filaments 71 constituting the warp filament assembly 72a at the extension part 31 to be greater than that at another portion, the strength of the extension part 31 can be improved.

3.2.6.10. The number of the multiple filaments 71 constituting the weft filament assembly 72b at the extension part 31 related to the present embodiment is greater than the number of the multiple filaments 71 constituting the weft filament assembly 72b at a portion different from the extension part 31. According to the present embodiment, by configuring the number of the multiple filaments 71 constituting the weft filament assembly 72b at the extension part 31 to be greater than that of another portion, the strength of the extension part 31 can be improved.

3.2.6.11. An opening ratio, which is a ratio of an opening area of the first openings 34a of the first electrode sheet 25c related to the present embodiment to an area of the first electrode sheet 25c, is 30% or more. Accordingly, stretchability of the first electrode sheet 25c can be improved.

The configurations described in sections 3.2.6.1. to 3.2.6.11. above are independent of each other, all of the configurations described in sections 3.2.6.1. to 3.2.6.11. may be included, or at least one selected from the configurations described in sections 3.2.6.1. to 3.2.6.11. may be included. In addition, the configurations described in sections 3.2.6.1. to 3.2.6.11. may also be omitted. The same also applies to the second electrode sheet.

### Embodiment 3-3

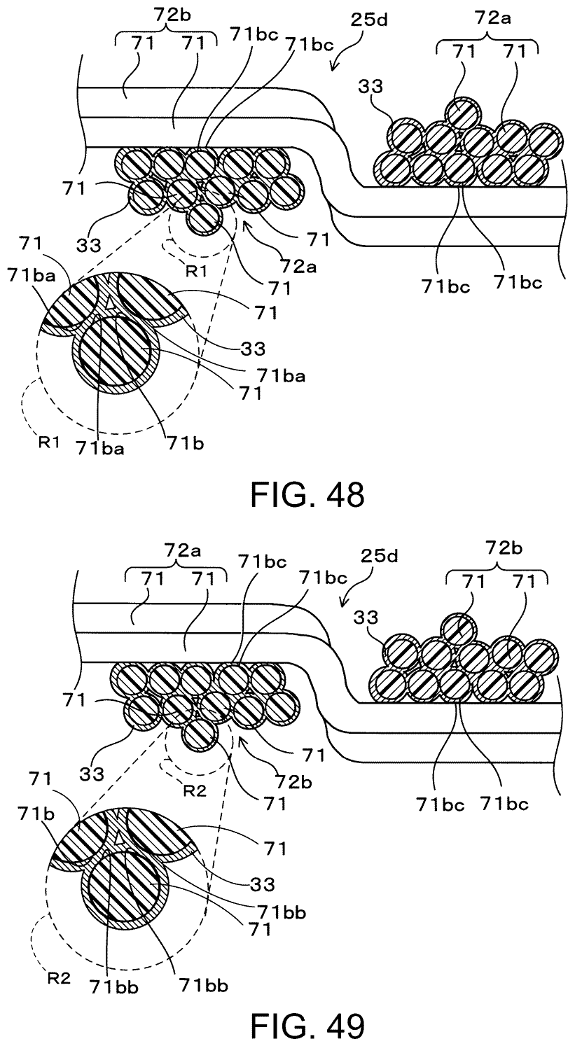

Next, a first electrode sheet 25d of Embodiment 3-3 will be described with reference to FIG. 48 to FIG. 49. FIG. 48 also includes a partial enlarged view showing an enlarged view of a region R1.

As shown in FIG. 48, in the present embodiment, at least a part of the multiple filaments 71 constituting the multiple warp filament assemblies 72a includes warp filament opposing surfaces 71ba (an example of filament opposing surfaces) opposed to each other. In the present embodiment, the plating layer 33 is formed on the warp filament opposing surfaces 71ba.

Among the multiple filaments 71 constituting the warp filament assembly 72a, the plating layer 33 formed on the warp filament opposing surface 71ba of one filament 71 and the plating layer 33 formed on the warp filament opposing surface 71ba of another filament 71 adjacent to the one filament 71 contact each other. Accordingly, the multiple filaments 71 constituting the warp filament assembly 72a are electrically connected to each other.

In addition, FIG. 49 also includes a partial enlarged view showing an enlarged view of a region R2. As shown in FIG. 49, in the present embodiment, at least a part of the multiple filaments 71 constituting the weft filament assembly 72b includes weft filament opposing surfaces 71bb opposed to each other. In the present embodiment, the plating layer 33 is formed on the weft filament opposing surfaces 71bb. By mutual contact between the plating layers 33 formed on the weft filament opposing surfaces 71bb of adjacent filaments 71 constituting the weft filament assembly 72b, the multiple filaments 71 constituting the weft filament assembly 72b are electrically connected to each other.

At a portion at which the warp filament assembly 72a and the weft filament assembly 72b intersect and overlap with each other, the filaments 71 exposed on the outer surface of the warp filament assembly 72a and the filaments 71 exposed on the outer surface of the weft filament assembly 72b include warp-weft filament opposing surfaces 71bc (an example of the filament opposing surfaces) opposed to each other. In the present embodiment, the plating layer 33 is formed on the warp-weft filament opposing surfaces 71bc. Accordingly, the warp filament assembly 72a and the weft filament assembly 72b are electrically connected to each other.

In the present embodiment, among the multiple filaments 71 constituting the warp filament assembly 72a, at least a part of the multiple filaments 71 located inside the warp filament assembly 72a includes warp filament opposing surfaces 71ba opposed to each other, and the plating layer 33 is formed on the warp filament opposing surfaces 71ba.

By forming the plating layer 33 on the warp filament opposing surfaces 71ba of the filaments 71 located inside the warp filament assembly 72a, even in the case where an external force is applied to the sensor sheet 18, spreading of the external force directly to the warp filament opposing surfaces 71ba is suppressed. As a result, the possibility of remaining of the plating layer 33 formed on the opposing surfaces is enhanced. Accordingly, even in the case where an external force is applied to the sensor sheet 18, the possibility of remaining of the conductive paths of the warp filament assembly 72a constituting the sensor sheet 18 can be enhanced. Thus, an increase in the electrical resistance value of the sensor sheet 18 can be suppressed in the case where an external force is applied to the sensor sheet 18.

In the present embodiment, among the multiple filaments 71 constituting the warp filament assembly 72a, the plating layer 33 formed on the warp filament opposing surface 71ba of one filament 71 and the plating layer 33 formed on the warp filament opposing surface 71ba of another filament 71 contact each other. According to the present embodiment, since the conductive path between the one filament 71 and the another filament 71 can be retained, an increase in the electrical resistance value of the sensor sheet 18 can be suppressed in the case where an external force is applied to the sensor sheet 18. Since the same actions and effects as the warp filament assembly 72a are also obtained for the weft filament assembly 72b, repeated descriptions will be omitted.

In the present embodiment, one filament 71 among the multiple filaments 71 constituting the warp filament assembly 72a and one filament 71 among the multiple filaments 71 constituting the weft filament assembly 72b include warp-weft filament opposing surfaces 71bc opposed to each other, and the plating layer 33 is formed on the warp-weft filament opposing surfaces 71bc.

Since the warp-weft filament opposing surfaces 71bc are, as a whole, located inside the first electrode sheet 25d, even in the case where an external force is applied to the sensor sheet 18, it is possible to enhance the possibility of remaining of the conductive paths between the filaments 71 constituting the warp filament assembly 72a and the filaments 71 constituting the weft filament assembly 72b constituting the sensor sheet 18b. Thus, an increase in the electrical resistance value of the sensor sheet 18 can be suppressed in the case where an external force is applied to the sensor sheet 18.

In the present embodiment, the plating layer 33 formed on the warp-weft filament opposing surface 71bc of one filament 71 constituting the warp filament assembly 72a and the plating layer 33 formed on the warp-weft filament opposing surface 71bc of one filament 71 constituting the weft filament assembly 72b contact each other. According to the present embodiment, since the conductive paths between the warp filament assembly 72a and the weft filament assembly 72b can be retained, an increase in the electrical resistance value of the sensor sheet 18 can be suppressed in the case where an external force is applied to the sensor sheet 18. Since the same actions and effects as the warp filament assembly 72a are also obtained for the weft filament assembly 72b, repeated descriptions will be omitted.

When the user's hand continues to be in contact with the steering wheel 10, the steering wheel is placed in a high-temperature and high-humidity condition. As the high-temperature and high-humidity condition continues for a long time, there is a risk that the plating layer 33 formed on the surfaces of the filaments 71 exposed on the outer surfaces of the warp filament assembly 72a and the weft filament assembly 72b may be damaged. According to the present embodiment, since the plating layer 33 is formed on the warp filament opposing surfaces 71ba, the weft filament opposing surfaces 71bb, and the warp-weft filament opposing surfaces 71bc, even in the case where the plating layer 33 formed on the surfaces of the filaments 71 exposed on the outer surfaces of the warp filament assembly 72a and the weft filament assembly 72b is damaged, the plating layer 33 formed on the warp filament opposing surfaces 71ba, the weft filament opposing surfaces 71bb, and the warp-weft filament opposing surfaces 71bc is less likely to be damaged. Accordingly, an increase in the electrical resistance value of the sensor sheet 18 can be suppressed. Since the same actions and effects as described above are also obtained for the second electrode sheet, repeated descriptions will be omitted.

### Embodiment 3-4

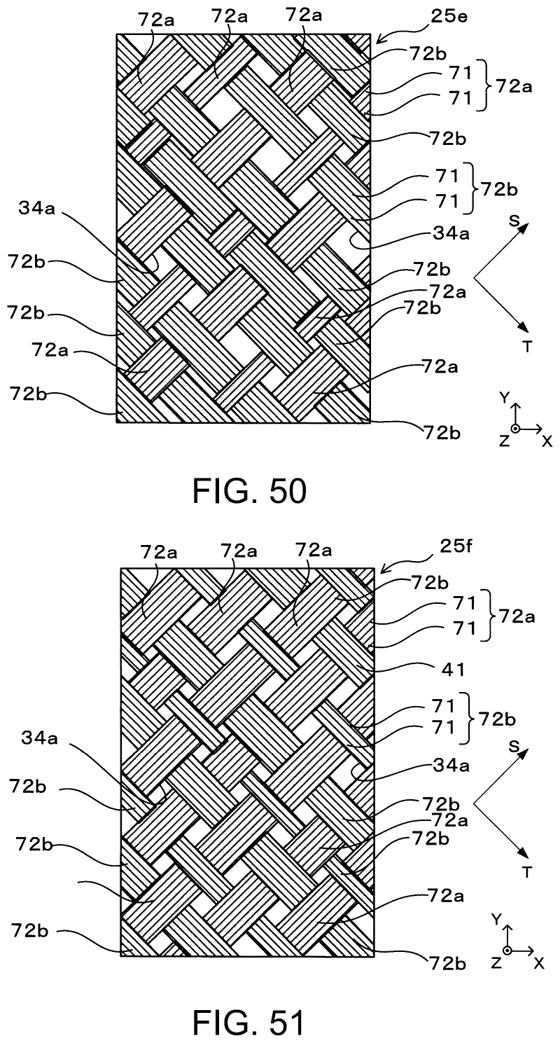

Next, Embodiment 3-4 will be described with reference to FIG. 50.

(a) In a first electrode sheet 25e of the present embodiment, the number of the multiple filaments 71 constituting the multiple warp filament assemblies 72a differs in an arrangement direction of the multiple warp filament assemblies 72a.

(b) In addition, in the present embodiment, an interval between the warp filament assemblies 72a adjacent to each other differs in the arrangement direction of the multiple warp filament assemblies 72a.

(c) In the present embodiment, the number of the multiple filaments 71 constituting the multiple warp filament assemblies 72a differs in the arrangement direction of the multiple warp filament assemblies 72a. By varying the strength of each of the multiple warp filament assemblies 72a in this manner, it is possible to easily change the strength of the first electrode sheet 25e partially.

(d) In the present embodiment, the multiple warp filament assemblies 72a are arranged side by side at intervals, and the interval between the warp filament assemblies 72a adjacent to each other differs in the arrangement direction of the multiple warp filament assemblies 72a. By varying the intervals between the multiple warp filament assemblies 72a in this manner, it is possible to easily change stretchability of the first electrode sheet 25e.

The configurations described in (a) to (d) above are independent of each other, all of the configurations described in (a) to (d) may be included, or at least one selected from the configurations described in (a) to (d) may be included. In addition, the configurations described in (a) to (d) may also be omitted. Since the second electrode sheet can also have the same configuration as the first electrode sheet 25e, repeated descriptions will be omitted.

### Embodiment 3-5

Next, Embodiment 3-5 will be described with reference to FIG. 51.

(e) In a first electrode sheet 25f of the present embodiment, the number of the multiple filaments 71 constituting the multiple weft filament assemblies 72b differs in an arrangement direction of the multiple weft filament assemblies 72b.

(f) In addition, in the present embodiment, an interval between the weft filament assemblies 72b adjacent to each other differs in the arrangement direction of the multiple weft filament assemblies 72b.

(g) In the present embodiment, the number of the multiple filaments 71 constituting the multiple weft filament assemblies 72b differs in the arrangement direction of the multiple weft filament assemblies 72b. By varying the strength of each of the multiple weft filament assemblies 72b in this manner, it is possible to easily change the strength of the first electrode sheet 25f partially.

(h) In the present embodiment, the multiple weft filament assemblies 72b are arranged side by side at intervals, and the interval between the weft filament assemblies 72b adjacent to each other differs in the arrangement direction of the multiple weft filament assemblies 72b. By varying the intervals between the multiple weft filament assemblies 72b in this manner, it is possible to easily change stretchability of the first electrode sheet 25f.

The configurations described in (e) to (h) above are independent of each other, all of the configurations described in (e) to (h) may be included, or at least one selected from the configurations described in (e) to (h) may be included. In addition, the configurations described in (e) to (h) may also be omitted. Since the second electrode sheet can also include the same configuration as the first electrode sheet 25f, repeated descriptions will be omitted.

### Embodiment 3-6

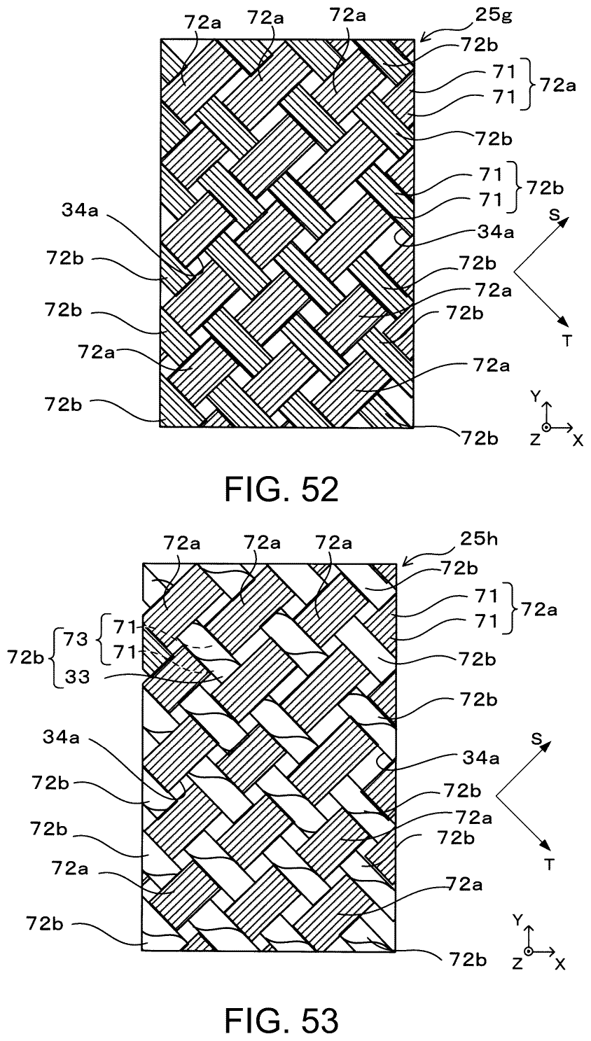

Next, Embodiment 3-6 will be described with reference to FIG. 52.

In a first electrode sheet 25g of the present embodiment, the number of the multiple filaments 71 constituting the warp filament assembly 72a and the number of the multiple filaments 71 constituting the weft filament assembly 72b are different from each other. Accordingly, the strength of the warp filament assembly 72a and the strength of the weft filament assembly 72b can be caused to differ from each other. As a result, it is possible to easily change the strength of the first electrode sheet 25 partially. The number of the filaments 71 constituting the warp filament assembly 72a may be greater than the number of the filaments 71 constituting the weft filament assembly 72b. In addition, the number of the filaments 71 constituting the warp filament assembly 72a may also be smaller than the number of the filaments 71 constituting the weft filament assembly 72b. Since the second electrode sheet can also have the same configuration as the first electrode sheet 25g, repeated descriptions will be omitted.

### Embodiment 3-7

Next, Embodiment 3-7 will be described with reference to FIG. 53. In a first electrode sheet 25h of the present embodiment, the weft filament assembly 72b includes a twisted wire 73 obtained by twisting multiple filaments 71, and a plating layer 33 formed on a surface of the twisted wire 73. The twisted wire 73 is formed by twisting multiple filaments 71.

According to the present embodiment, plating is applied in a state in which contact pressure between the warp filament assembly 72a and the weft filament assembly 72b is ensured by the weft filament assembly 72b including the twisted wire 73. Thus, the contact pressure at each contact point between the multiple warp filament assemblies 72a and the multiple weft filament assemblies 72b is further improved, and an increase in the electrical resistance value of the sensor sheet 18 can be suppressed.

However, the embodiment may also be configured such that the warp filament assembly 72a includes the twisted wire 73 and the plating layer 33, and the weft filament assembly 72b includes a non-twisted bundle 74 and the plating layer 33. Since the second electrode sheet also includes the same configuration as the first electrode sheet 25h, repeated descriptions will be omitted.

### Embodiment 3-8

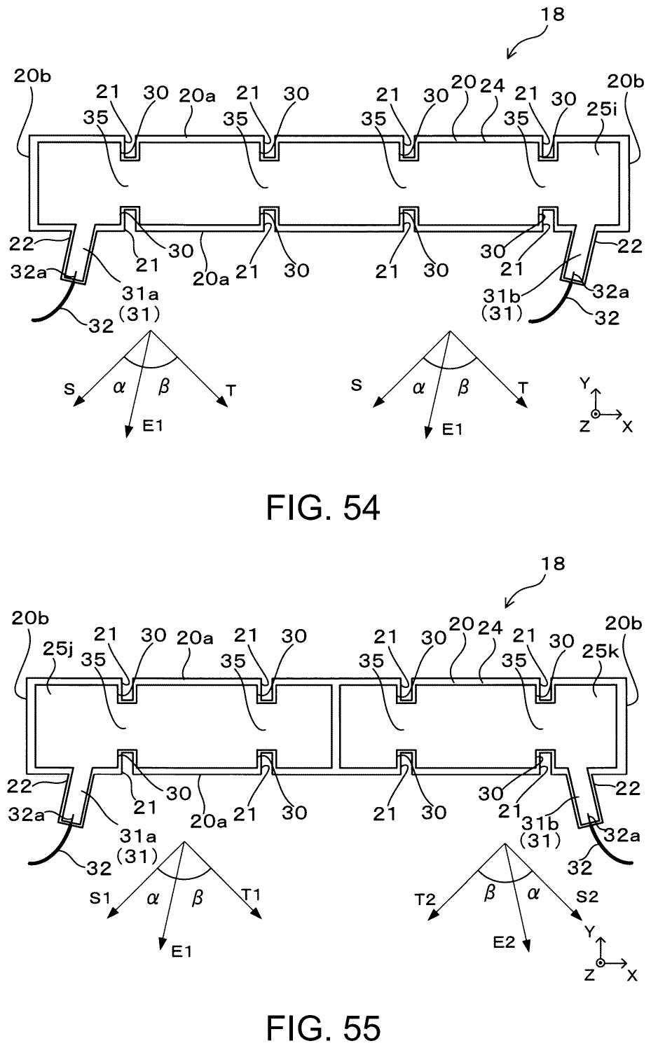

Next, Embodiment 3-8 will be described with reference to FIG. 54. In the sensor sheet 18 of the present embodiment, two sheet extension parts 22 formed at the sensor sheet 18 are formed in parallel. In other words, the two sheet extension parts 22 are extended in a same extending direction E1. The extension parts 31 formed at the first electrode sheet 25i are also formed extending in the same extending direction E1.

In the present embodiment, an angle α formed between the longitudinal direction S of the multiple warp filament assemblies 72a of the first electrode sheet 25i and the extending direction E1 of the extension part 31 is smaller than an angle β formed between the longitudinal direction T of the multiple weft filament assemblies 72b of the first electrode sheet 25i and the extending direction E1 of the extension part 31.

According to the present embodiment, the longitudinal direction S of the multiple warp filament assemblies 72a can be configured along the extending direction E1 of the extension part 31. Accordingly, the strength of the extension part 31 can be improved. Since the second electrode sheet can also include the same configuration as the first electrode sheet 25i, repeated descriptions will be omitted.

### Embodiment 3-9

Embodiment 3-9 will be described with reference to FIG. 55. In the sensor sheet 18 of the present embodiment, two first electrode sheets 25j and 25k are arranged on the first surface 27 of the insulating sheet 24 along the longitudinal direction X of the insulating sheet 24. Although not shown in detail, two second electrode sheets are arranged on the second surface 28 of the insulating sheet 24 along the longitudinal direction X of the insulating sheet 24.

In the present embodiment, a longitudinal direction S1 of the multiple warp filament assemblies 72a of the first electrode sheet 25j disposed on the left side in FIG. 55 is perpendicular to a longitudinal direction S2 of the multiple warp filament assemblies 72a of the first electrode sheet 25k disposed on the right side in FIG. 55. In addition, a longitudinal direction T1 of the multiple weft filament assemblies 72b of the first electrode sheet 25j disposed on the left side in FIG. 55 is perpendicular to a longitudinal direction T2 of the multiple weft filament assemblies 72b of the first electrode sheet 25k disposed on the right side in FIG. 55.

In the present embodiment, an angle α formed between the longitudinal direction S1 of the warp filament assembly 72a of the first electrode sheet 25i and the extending direction E1 of the extension part 31 is smaller than an angle β formed between the longitudinal direction T1 of the weft filament assembly 72b of the first electrode sheet 25j and the extending direction E1 of the extension part 31.

In addition, an angle α formed between the longitudinal direction S2 of the multiple warp filament assemblies 72a of the first electrode sheet 25k and the extending direction E2 of the extension part 31b is smaller than an angle β formed between the longitudinal direction T2 of the multiple weft filament assemblies 72b of the first electrode sheet 25j and the extending direction E2 of the extension part 31b.

According to the present embodiment, the longitudinal direction S1 of the multiple warp filament assemblies 72a can be configured along the extending direction E1 of the extension part 31a. Accordingly, the strength of the extension part 31a can be improved. In addition, the longitudinal direction S2 of the multiple warp filament assemblies 72a can be configured along the extending direction E2 of the extension part 31b. Accordingly, the strength of the extension part 31b can be improved. Since the second electrode sheet can also include the same configuration as the first electrode sheets 25j and 25k, repeated descriptions will be omitted.

The disclosure is not limited to the above-described embodiments, and may be applied to various embodiments within a scope that does not deviate from the spirit thereof.

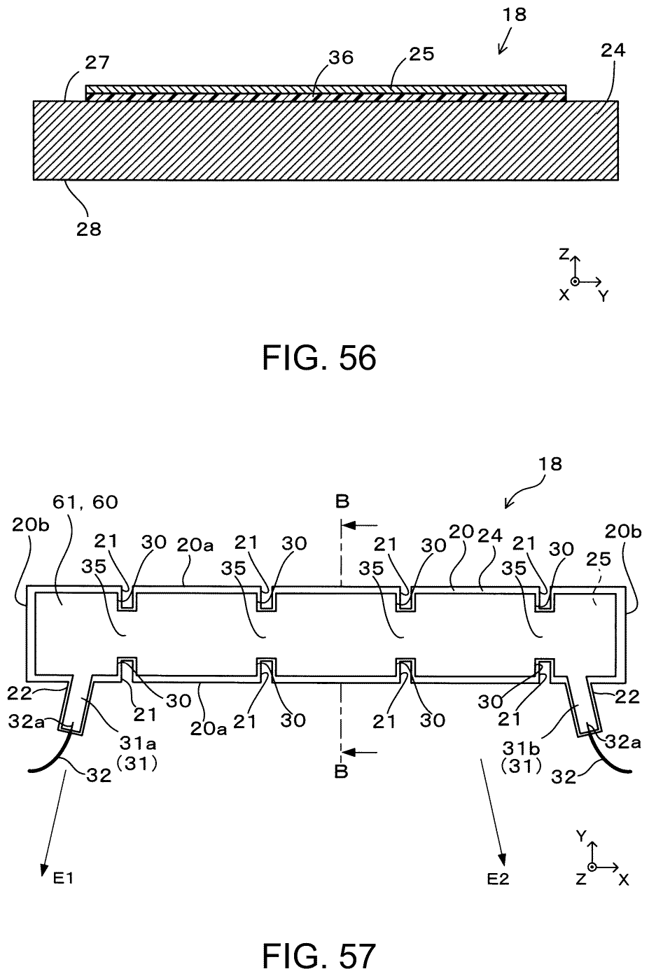

As shown in FIG. 56, the embodiment may also be configured such that the first electrode sheet 25 is disposed on the first surface 27 of the insulating sheet 24, and the second electrode sheet 26 is not disposed on the second surface 28 of the insulating sheet 24.

### Embodiment 4-1

Next, Embodiment 4-1 will be described. Since Embodiment 4-1 includes configurations identical to the configurations described in sections 1.1.1 to 1.1.4 of Embodiment 1-1, the descriptions in sections 1.1.1 to 1.1.4 will be read as sections 4.1.1 to 4.1.4, and repeated descriptions will be omitted.

4.1.5. Bonding structure between first electrode sheet 25, the second electrode sheet 26, and insulating sheet 24

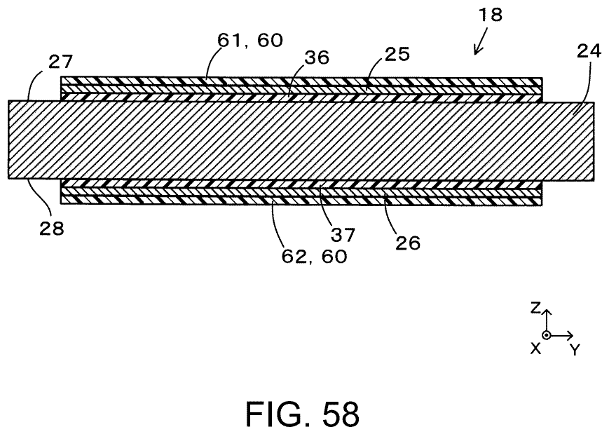

As shown in FIG. 58, on the first surface 27 side of the insulating sheet 24, the insulating sheet 24 and the first electrode sheet 25 are bonded to each other by a first bonding part 36 interposed between the insulating sheet 24 and the first electrode sheet 25. The material constituting the first bonding part 36 is not particularly limited, and may be appropriately selected from any material such as, for example, an acrylic adhesive, a silicone adhesive, a urethane adhesive, a rubber-based adhesive, etc. In addition, as shown in FIG. 58, on the second surface 28 side of the insulating sheet 24, the insulating sheet 24 and the second electrode sheet 26 are bonded to each other by a second bonding part 37 interposed between the insulating sheet 24 and the second electrode sheet 26. Since the material constituting the second bonding part 37 is the same as that of the first bonding part 36, repeated descriptions will be omitted.

### 4.1.6. Protecting Part 60

As shown in FIG. 58, a first protecting part 61 is disposed on the surface (outer surface) of the first electrode sheet 25. The first protecting part 61 is formed to cover, in a layer shape, the surface of the first electrode sheet 25. In addition, a second protecting part 62 is disposed on the surface (outer surface) of the second electrode sheet 26. The second protecting part 62 is formed to cover, in a layer shape, the surface of the second electrode sheet 26. In the following description, in the case of not distinguishing between the first protecting part 61 and the second protecting part 62, the first protecting part 61 and the second protecting part 62 may be referred to as a protecting part 60.

The protecting part 60 is configured to include a resin material or a rubber material. The material forming the protecting part 60 is not particularly limited, and may be appropriately selected from any material, including polyolefin such as polyethylene and polypropylene, polyester such as polybutylene terephthalate and polyethylene terephthalate, polyamide such as nylon 6 and nylon 6,6, polyurethane, silicone polymer, etc. However, an acrylic material, a urethane-based material, and a silicone-based material are preferable.

The protecting part 60 may include an additive such as an antioxidant in addition to the resin material, and may also include a filler.

The first protecting part 61 disposed at the first electrode sheet 25 and the second protecting part 62 disposed at the second electrode sheet 26 may be formed of the same material or may be formed of different materials.

The first electrode sheet 25 and the first protecting part 61 may be configured such that integration with the first electrode sheet 25 is achieved by adhesiveness of the first protecting part 61. In addition, the first electrode sheet 25 and the first protecting part 61 may be configured to be integrated by heat-bonding the first protecting part 61 to the first electrode sheet 25. In addition, the first electrode sheet 25 and the first protecting part 61 may be configured to be integrated by adhesion with an adhesive. The adhesive may be a conventional adhesive, or the same material as the material constituting the first bonding part 36 described above may also be applied.

The configuration integrating the second electrode sheet 26 and the second protecting part 62 may be the same as or different from the configuration integrating the first electrode sheet 25 and the first protecting part 61.

### 4.1.7. Configuration of Electrode Sheet

The first electrode sheet 25 and the second electrode sheet 26 will be described. The first electrode sheet 25 and the second electrode sheet 26 are conductive cloths having conductivity. The first electrode sheet 25 and the second electrode sheet 26 have both conductivity and flexibility. The first electrode sheet 25 and the second electrode sheet 26 have stretchability in the longitudinal direction X and the intersecting direction Y.

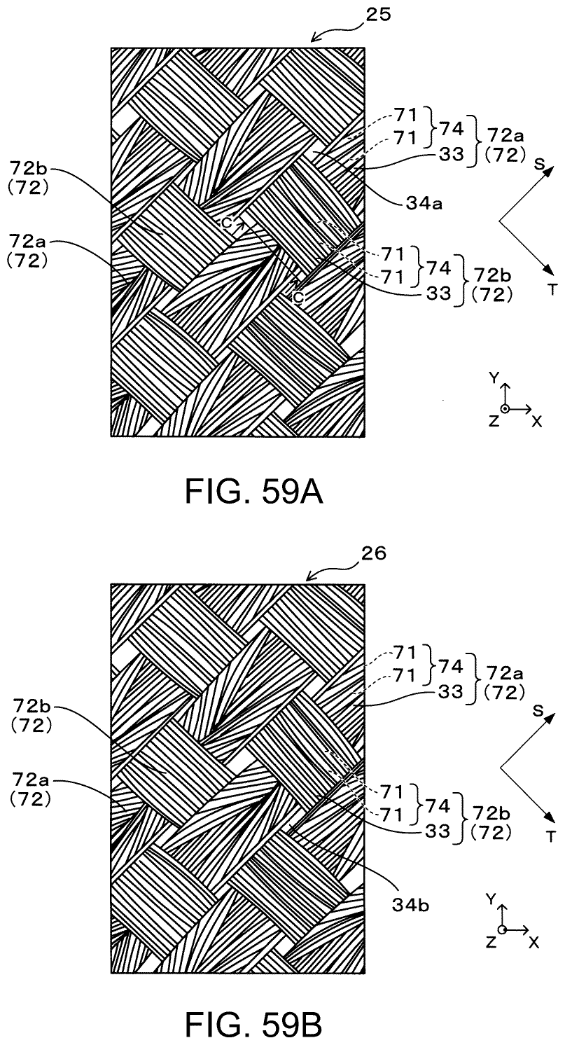

As shown in FIG. 59A and FIG. 59B, the first electrode sheet 25 and the second electrode sheet 26 are conductive cloths woven with multiple filament assemblies 72. The filament assembly 72 includes multiple filaments 71 and a plating layer 33 formed on at least a part of a surface of the filament 71.

As shown in FIG. 59A to FIG. 59B, the first electrode sheet 25 and the second electrode sheet 26 are manufactured by forming the plating layer 33 on a base fabric woven with multiple non-twisted bundles 74. Each non-twisted bundle 74 is formed by bundling multiple filaments 71 in an untwisted state.

Examples of a resin constituting the filament 71 may include, for example, polyolefin such as polyethylene and polypropylene, polyester such as polyethylene terephthalate and polybutylene terephthalate, and polyamide such as nylon 6 and nylon 6,6. However, the resin constituting the filament 71 is not limited to the above, and any resin may be selected as appropriate. The second electrode sheet 26 also includes the same configuration.

The plating layer 33 is formed on the surface of the base fabric woven with multiple filament assemblies 72. A method of forming the plating layer 33 is not particularly limited, may be, for example, electroplating, may be electroless plating, may be electroplating performed after performing electroless plating, or may be electroless plating performed after performing electroplating, and any method may be selected as appropriate.

Any metal or alloy, such as copper, nickel, tin, solder, etc., may be appropriately selected as a metal constituting the plating layer 33 formed on the surface of the base fabric. The plating layer 33 formed on the surface of the base fabric may be composed of one metal species or may be composed of multiple metal species. For example, copper alone may be plated on the surface of the base fabric, nickel alone may be plated on the surface of the base fabric, or a copper plating layer composed of copper may be formed on the surface of the base fabric and a nickel plating layer composed of nickel may be formed on the surface of the copper plating layer. The plating layer 33 formed on the surface of the base fabric may be formed by electroplating or may be formed by electroless plating. The second electrode sheet 26 also includes the same configuration.

As shown in FIG. 59A, the first electrode sheet 25 includes first openings 34a that are opened between the multiple filament assemblies 72. The first openings 34a penetrate through the first electrode sheet 25. A first opening ratio, which is a ratio of an opening area of the first openings 34a formed in the first electrode sheet 25 to an area of the first electrode sheet 25, is 1% or more and 40% or less.

As shown in FIG. 59B, the second electrode sheet 26 includes second openings 34b that are opened between the multiple filament assemblies 72. The second openings 34b penetrate through the second electrode sheet 26. A second opening ratio, which is a ratio of an opening area of the second openings 34b formed in the second electrode sheet 26 to an area of the second electrode sheet 26, is 1% or more and 40% or less.

### 4.1.8. Examples and Samples

### 4.1.8.1. Example 4-1 and Sample 4-1

### Example 4-1 and Sample 4-1

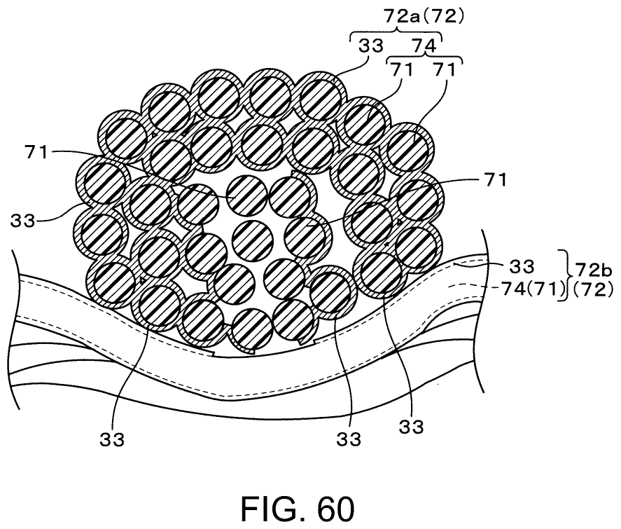

Example 4-1 will be described with reference to FIG. 59A to FIG. 60. As shown in FIG. 59A, the first electrode sheet 25 related to Example 4-1 is a conductive cloth woven with multiple filament assemblies 72. The multiple filament assemblies 72 include a non-twisted bundle 74 in which multiple filaments 71 are bundled in an untwisted state, and a plating layer 33 formed on at least a part of a surface of the non-twisted bundle 74. The filament assembly 72 is formed in a shape that is flat in a thickness direction of the first electrode sheet 25. Since the first electrode sheet 25 and the second electrode sheet 26 have a substantially identical configuration, repeated descriptions will be omitted unless specifically stated.

The first electrode sheet 25 related to the present Example 4-1 is formed by weaving a warp filament assembly 72a, in which multiple filaments 71 are bundled in an untwisted state, and a weft filament assembly 72b, in which multiple filaments 71 are bundled in an untwisted state, to form the base fabric, and forming the plating layer 33 on the surface of the base fabric. However, the manufacturing method of the first electrode sheet 25 is not limited to the above method.

As shown in FIG. 59A, the first electrode sheet 25 of the present embodiment includes multiple warp filament assemblies 72a and multiple weft filament assemblies 72b. The first electrode sheet 25 includes first openings 34a that are opened between the multiple filament assemblies 72. The first openings 34a penetrate through the first electrode sheet 25. In the present Example 4-1, an opening ratio, which is a ratio of the opening area of the first openings 34a formed in the first electrode sheet 25 to the area of the first electrode sheet 25, is about 3%. The opening ratio is a ratio of a total opening area of the multiple first openings 34a formed in a target region of the first electrode sheet 25 to an area of the target region of the first electrode sheet 25. The opening ratio is calculated, for example, by specifying a 10 mm×10 mm target region in the first electrode sheet 25, totaling the areas of the first openings 34a within the target region, and dividing the total area by the area of the target region.

As shown in FIG. 59B, the second electrode sheet 26 of the present embodiment includes multiple warp filament assemblies 72a and multiple weft filament assemblies 72b. The second electrode sheet 26 of the present embodiment includes second openings 34b that are opened between the multiple filament assemblies 72. The second openings 34b penetrate through the second electrode sheet 26. In the present Example 4-1, an opening ratio, which is a ratio of the opening area of the second openings 34b formed in the second electrode sheet 26 to the area of the second electrode sheet 26 of the present embodiment, is about 3%.

The number of the filaments 71 included in the filament assembly 72 constituting the first electrode sheet 25 is not particularly limited. The filament assembly 72 related to the present embodiment includes 75 filaments 71, but the number of the filaments 71 may be any number. In addition, the second electrode sheet 26 is the same as the first electrode sheet 25.

As shown in FIG. 60, the plating layer 33 is formed on at least a part of the surface of the non-twisted bundle 74 constituting the filament assembly 72. The warp filament assembly 72a and the weft filament assembly 72b are electrically connected to each other by the contact between the plating layer 33 of the warp filament assembly 72a and the plating layer 33 of the weft filament assembly 72b.

As shown in FIG. 59A, the longitudinal direction S of the multiple warp filament assemblies 72a and the longitudinal direction X of the first electrode sheet 25 are configured to intersect each other. In addition, the longitudinal direction T of the multiple weft filament assemblies 72b and the longitudinal direction X of the first electrode sheet 25 are configured to intersect each other. Specifically, the longitudinal direction S of the multiple warp filament assemblies 72a forms an acute angle that is substantially 45° with respect to the longitudinal direction X of the first electrode sheet 25. In addition, the longitudinal direction T of the multiple weft filament assemblies 72b forms an acute angle that is substantially 45° with respect to the longitudinal direction X of the first electrode sheet 25a. “An angle being substantially 45°” includes cases where the angle is 45°, and also includes cases where the angle can be considered substantially 45°. Since the second electrode sheet 26 also includes the same configuration as the first electrode sheet 25, repeated descriptions will be omitted.

In the case where the longitudinal direction S of the warp filament assembly 72a is parallel to the longitudinal direction X of the first electrode sheet 25 (in the case where the acute angle is substantially 0°), upon stretching the first electrode sheet 25 in a direction parallel to the direction X, the warp filament assembly 72a itself is extended, and a large load is required.

In contrast, in the case where the longitudinal direction S of the warp filament assembly 72a is inclined at an inclination of 45° with respect to the longitudinal direction X of the first electrode sheet 25 (in the case where the acute angle is substantially 45°), upon stretching the first electrode sheet 25 in a direction parallel to the direction X, the square or rectangular grids (first openings 34) composed of the warp filament assemblies 72a and the weft filament assemblies 72b deform into a rhombic shape, and since the warp filament assembly 72a or the weft filament assembly 72b itself is not extended, a large load is not required. In other words, in the case where the acute angle is substantially 45°, structural flexibility is imparted. Furthermore, the higher the opening ratio is, the more easily the square or rectangular grids deform into a rhombic shape, and the less likely it is for structural flexibility to be compromised. Since the second electrode sheet 26 is also the same as the first electrode sheet 25, repeated descriptions will be omitted.

However, the longitudinal direction S of the multiple warp filament assemblies 72a may also form an acute angle that is different from 45° with respect to the longitudinal direction X of the first electrode sheet 25. In addition, the longitudinal direction T of the multiple weft filament assemblies 72b may also form an acute angle that is different from 45° with respect to the longitudinal direction X of the first electrode sheet 25.

The number of the multiple filaments 71 constituting the warp filament assembly 72a and the number of the multiple filaments 71 constituting the weft filament assembly 72b may be the same as or different from each other. In the present Embodiment 4-1, the number of the multiple filaments 71 constituting the warp filament assembly 72a and the number of the multiple filaments 71 constituting the weft filament assembly 72b are set to be substantially the same. “Substantially the same” includes case where the numbers are the same, and also includes cases where the numbers, although not the same, can be considered substantially the same. Since the above also applies to the weft filament assembly 72b, repeated descriptions will be omitted. In the present Example 4-1, the number of the filaments 71 is set to 75. However, the number of the filaments 71 is not limited to the above number.

As shown in FIG. 60, the plating layer 33 is formed at at least a part of the multiple filaments 71 constituting the warp filament assembly 72a. For example, the plating layer 33 is formed on the surfaces of the filaments 71 exposed on the outer surface of the warp filament assembly 72a. Among the filaments 71 located inside the warp filament assembly 72a, the plating layer 33 is not formed on the surfaces of a part of the filaments 71. At the portion at which the plating layer 33 is not formed, the surfaces of the filaments 71 are exposed. Since the above also applies to the weft filament assembly 72b, repeated descriptions will be omitted. However, the plating layer 33 may also be formed on the surface of each filament constituting the multiple filaments 71.

At a portion at which the warp filament assembly 72a and the weft filament assembly 72b are opposed to and intersect each other, the plating layer 33 is formed at a part, and at the portion at which the plating layer 33 is not formed, the surfaces of the filaments 71 are exposed. Of the portion at which the warp filament assembly 72a and the weft filament assembly 72b are opposed to and intersect each other, the plating layer 33 is formed in a region close to the portion exposed outside, and the plating layer 33 is not formed at the portion close to inside. Since the weft filament assembly 72b also includes the same configuration as the warp filament assembly 72a, repeated descriptions will be omitted.

In the present Example 4-1, the resin constituting the filament 71 is polyethylene terephthalate (PET), and the diameter of the filament 71 is about 10 μm. The metal constituting the plating layer 33 is formed in a three-layer structure, with the outermost layer being Ni, the intermediate layer being Cu, and the innermost layer (filament 71 side) being Ni. The diameter of the warp filament assembly 72a is about 185 μm, and the diameter of the weft filament assembly 72b is about 185 μm.

As shown in FIG. 58, the first electrode sheet 25 described above is bonded to the first surface 27 of the insulating sheet 24 via the first bonding part 36. In addition, the second electrode sheet 26, which includes the same configuration as the first electrode sheet 25, is bonded to the second surface 28 of the insulating sheet 24 via the second bonding part 37. The insulating sheet 24 is an ether-based polyurethane foamed body. The first bonding part 36 is an acrylic adhesive manufactured by Nogawa Chemical Co., Ltd. A thickness of the first bonding part 36 is 50 μm. Since the first bonding part 36 and the second bonding part 37 are identical, repeated descriptions will be omitted.

The first protecting part 61 is disposed on and integrated with the outer surface of the first electrode sheet 25. The first electrode sheet 25 and the first protecting part 61 are integrated with an acrylic adhesive. The resin constituting the first protecting part 61 is an acrylic adhesive. A thickness of the first protecting part 61 is about 50 to 100 μm. Since the first protecting part 61 and the second protecting part 62 are identical, repeated descriptions will be omitted.

In this manner, Sample 4-1 of the sensor sheet 18 related to the first electrode sheet 25 and the second electrode sheet 26 of Example 4-1 is prepared.

### 4.1.8.2. Example 4-2 and Sample 4-2

### Example 4-2 and Sample 4-2

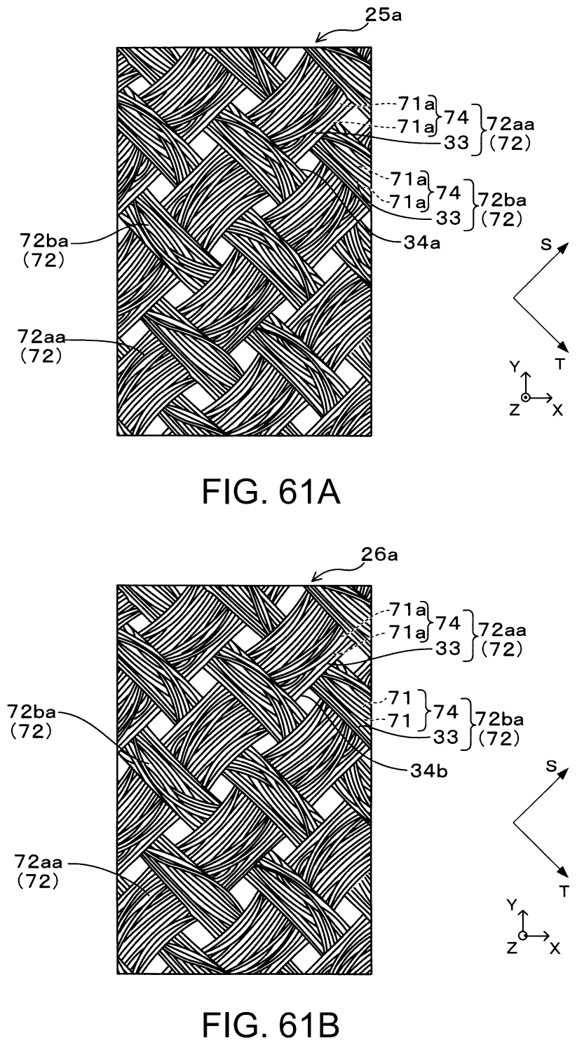

Next, configurations of the first electrode sheet 25a and the second electrode sheet 26a related to Example 4-2 will be described with reference to FIG. 61A to FIG. 61B. In the first electrode sheet 25a related to the present Example 4-2, the number of filaments 71a constituting a warp filament assembly 72aa and the number of filaments 71a constituting a weft filament assembly 72ba are different from each other. In the present Example 4-2, the number of the filaments 71a constituting the warp filament assembly 72aa is greater than the number of the filaments 71a constituting the weft filament assembly 72ba. However, the number of the filaments 71a constituting the warp filament assembly 72aa may also be configured to be less than the number of the filaments 71a constituting the weft filament assembly 72ba.

In the present Example 4-2, the number of the filaments 71a constituting the warp filament assembly 72aa is set to about twice the number of the filaments 71a constituting the weft filament assembly 72ba. In the present Example 4-2, the number of the filaments 71a constituting the warp filament assembly 72aa is set to about 80, and the number of the filaments 71a constituting the weft filament assembly 72ba is set to about 40. However, the difference between the number of the filaments 71a constituting the warp filament assembly 72aa and the number of the filaments 71a constituting the weft filament assembly 72ba is not limited to the above.

An opening ratio, which is a ratio of the opening area of the first openings 34a formed in the first electrode sheet 25a related to the present Example 4-2 to the area of the first electrode sheet 25a, is about 10%. In addition, an opening ratio, which is a ratio of the opening area of the second openings 34b formed in the second electrode sheet 26a to the area of the second electrode sheet 26a, is about 10%.

Since the second electrode sheet 26a has the same configuration as the first electrode sheet 25a, repeated descriptions will be omitted.

In the present Example 4-2, the resin constituting the filament 71a is polyethylene terephthalate (PET), and the diameter of the filament 71a is about 10 μm. The metal constituting the plating layer 33 has a one-layer structure and is configured as one layer of Ni. The diameter of the warp filament assembly 72a is about 180 μm, and the diameter of the weft filament assembly 72b is about 90 μm.

Since configurations other than the above are the same as those in Example 4-1, repeated descriptions will be omitted.

In addition, in the present Example 4-2, the insulating sheet 24 is an ether-based polyurethane foamed body. The first bonding part 36 is an acrylic adhesive. The thickness of the first bonding part 36 is about 50 μm. Since the first bonding part 36 and the second bonding part 37 are identical, repeated descriptions will be omitted.

The first protecting part 61 is disposed on and integrated with the outer surface of the first electrode sheet 25a. The first electrode sheet 25a and the first protecting part 61 are integrated with an acrylic adhesive. The resin constituting the first protecting part 61 is an acrylic adhesive. A thickness of the first protecting part 61 is about 50 to 100 μm. Since the first protecting part 61 and the second protecting part 62 are identical, repeated descriptions will be omitted.

Except for the above, Sample 4-2 of the sensor sheet 18 related to the first electrode sheet of Example 4-2 is prepared in the same manner as Sample 4-1. Descriptions overlapping with Sample 4-1 will be omitted.

### 4.1.8.3. Tensile Test of First Electrode Sheet

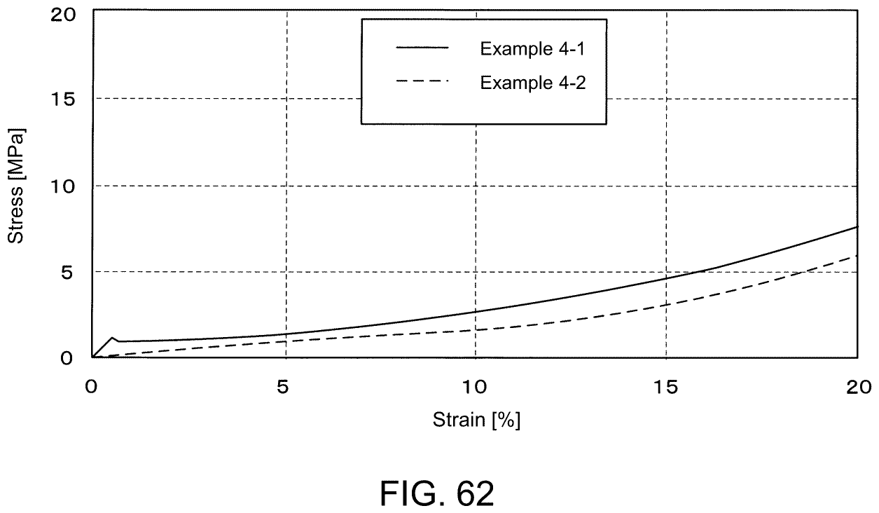

Next, the tensile test performed on the first electrode sheet will be described with reference to FIG. 62. Test pieces were prepared by cutting the first electrode sheets related to Examples 4-1 to 4-2 into a strip shape of 150 mm×20 mm. The thickness of the first electrode sheet is different among Examples 4-1 to 4-2 but is about 0.1 mm. The angle formed between the longitudinal direction of the test piece and the longitudinal direction of the warp filament assembly 72a is set to 45°.

The test piece is held by a pair of chucks. The distance between the pair of chucks is 70 mm. The tensile test is performed on the test piece at a tensile speed of 1 mm/sec, and a stress is calculated by dividing a load by a cross-sectional area of the test piece. The tensile testing machine is AGS-X 1 kN manufactured by Shimadzu Corporation. The tensile test is performed in a range with a strain being 0 to 20%. FIG. 62 is a graph showing changes in the stress with respect to the strain.

In Example 4-1 and Example 4-2, in the region with the strain being 0 to 20%, the stress increased gradually and monotonically. In the stress-strain curve in the tensile test, Example 4-1 and Example 4-2 do not have a yield point showing a local maximum value in a range with the strain being 0.5 to 10%.

Example 4-1 shows a stress of about 1.4 MPa at a strain 5%, and shows a stress of about 7.5 MPa at a strain of 20%. Example 4-2 shows a stress of about 0.9 MPa at a strain of 5%, and shows a stress of about 5.9 MPa at a strain of 20%. In the first electrode sheets 25 and 25a related to Example 4-1 and Example 4-2, a maximum value of the stress at a strain of 0 to 5% is 3 MPa or less, and a maximum value of the stress at a strain of 0 to 20% is 15 MPa or less.

### 4.1.8.4. Tensile Test of Sensor Sheet

Next, the tensile test performed on the sensor sheet will be described. Test pieces are prepared by cutting the sensor sheets related to Samples 4-1 to 4-2 into a strip shape of 90 mm×20 mm. The thickness of the sensor sheet is different between Samples 4-1 to 4-2 but is about 1 mm. The angle formed between the longitudinal direction of the test piece and the longitudinal direction of the warp filament assembly 72a constituting the first electrode sheet and the second electrode sheet is set to 45°. In this test, configurations obtained by excluding the first protecting part 61 and the second protecting part 62 from each of the configurations of Samples 4-1 to 4-2 described above were used as the test pieces.

An electric wire is connected to one end of the first electrode sheet in the longitudinal direction and is connected to a DC power supply. An electric wire is connected to the other end of the first electrode sheet in the longitudinal direction and is connected to a voltage measuring instrument.

The test piece is held by a pair of chucks. The distance between the pair of chucks is 50 mm. The tensile test is performed on the test piece at a tensile speed of 1 mm/sec, and a stress is calculated by dividing a load by a cross-sectional area of the test piece. In addition, during the tensile test, a DC resistance value (an example of the electrical resistance value) of the sensor sheet is calculated from a voltage of the DC power supply and a voltage drop of the sensor sheet.

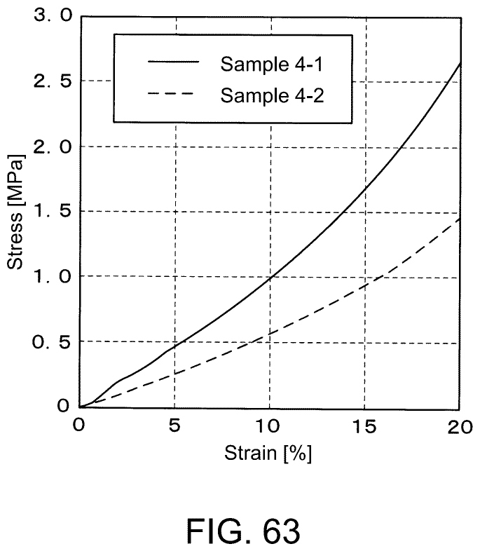

FIG. 63 shows a stress-strain curve in the tensile test performed on the sensor sheet. FIG. 63 shows a graph of the region with the strain being 0 to 20%. The stress of Samples 4-1 to 4-2 increased monotonically in the region with the strain being 0 to 20%. In the stress-strain curve in the tensile test, Sample 4-1 and Sample 4-2 do not have a yield point showing a local maximum value in a range with the strain being 0.5 to 10%.

Sample 4-1 shows a stress of about 0.5 MPa at a strain of 5%, and shows about 2.6 MPa, which is a maximum value of the stress, at a strain of 20%. Sample 4-2 shows a stress of about 0.3 MPa at a strain of 5%, and shows about 1.5 MPa, which is a maximum value of the stress, at a strain of 20%. In Sample 4-1 and Sample 4-2, in the stress-strain curve, a maximum value of the stress at a strain of 0 to 5% is 0.5 MPa or less, and a maximum value of the stress at a strain of 0 to 20% is 3 MPa or less.

In Sample 4-1 and Sample 4-2, in the stress-strain curve, the stress at a strain of 0 to 5% is 0.5 MPa or less, and the maximum value of the stress at a strain of 0 to 20% is 3 MPa or less.

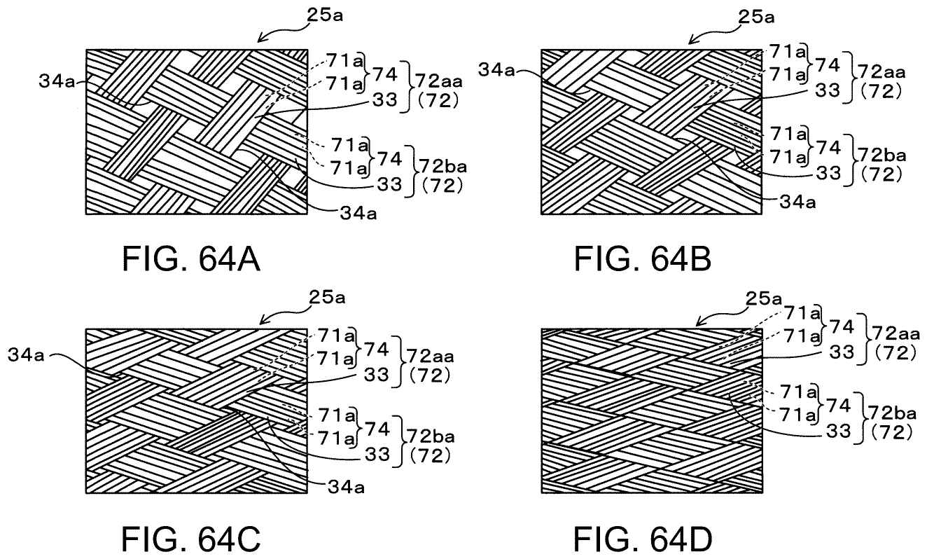

Upon application of a tensile force to Sample 4-1 and Sample 4-2, the first openings 34a of the first electrode sheet elongate in the tensile direction and contract in the direction intersecting the tensile direction. FIG. 64A to FIG. 64D show states of deformation of the first openings 34a, taking Sample 4-2 as an example. As shown in FIG. 64A, in the state of an elongation rate of 0%, the first openings 34a are open, but as the elongation rate increases to 10% (refer to FIG. 64B), 20% (refer to FIG. 64C), and 30% (refer to FIG. 64D), the gaps between the fibers of the conductive cloth decrease, and in the state of the elongation rate of 30%, the first openings 34a almost disappear. It is thought that since stretching readily occurs due to such changes in the fiber shape, the stress generated during stretching is small. In other words, it is thought that the presence of the first openings 34a contributes to the expression of such structural stretchability and flexibility of the fibers. Since the above configuration is the same in the second electrode sheet, descriptions will be omitted. Since the same also applies to Sample 4-1, descriptions will be omitted.

In Sample 4-1 and Sample 4-2, it is thought that, in the case where a tensile force is applied to the sensor sheet, the tensile force is absorbed by gradual deformation of the first openings 34a. Accordingly, at the portion at which the warp filament assembly 72a and the weft filament assembly 72b intersect each other, it is thought that since relative positions between the warp filament assembly 72a and the weft filament assembly 72b do not change much, an electrical connection state between the warp filament assembly 72a and the weft filament assembly 72b is maintained. Accordingly, in Sample 4-1 and Sample 4-2, it is thought that the DC resistance value hardly changes even in the case where a tensile force is applied to the sensor sheet.

### 4.1.8.5. DC Resistance Value Change Rate of the Sensor Sheet

Next, the DC resistance value change rate of the sensor sheet was measured. A test piece was prepared by cutting the sensor sheet into a strip shape of 90 mm×20 mm. The angle formed between the longitudinal direction of the test piece and the longitudinal direction of the warp filament assembly 72a is set to 45°. In this test, configurations obtained by excluding the first protecting part 61 and the second protecting part 62 from each of the configurations of Samples 4-1 to 4-2 described above were used as the test pieces.

The test piece is held by a pair of chucks. The distance between the pair of chucks is 50 mm. The tensile test is performed on the test piece at a tensile speed of 1 mm/sec. Electric wires were connected respectively to both ends of the first electrode sheet, and the DC resistance value between the two electric wires was measured. The DC resistance value change rate is calculated based on Formula (1) below for the DC resistance value at this time. Measurement of the DC resistance value is performed using a digital multimeter 2000 series manufactured by KEITHLEY. The above test is performed for Samples 4-1 to 4-2.

$$\begin{matrix}[ Math . 5 ] & \\ DC resistance value change rate = \frac{Difference in DC resistance value before and after stretching}{Initial DC resistance value before stretching} \times 1 \; 00 [ \% ] & ( 1 )\end{matrix}$$

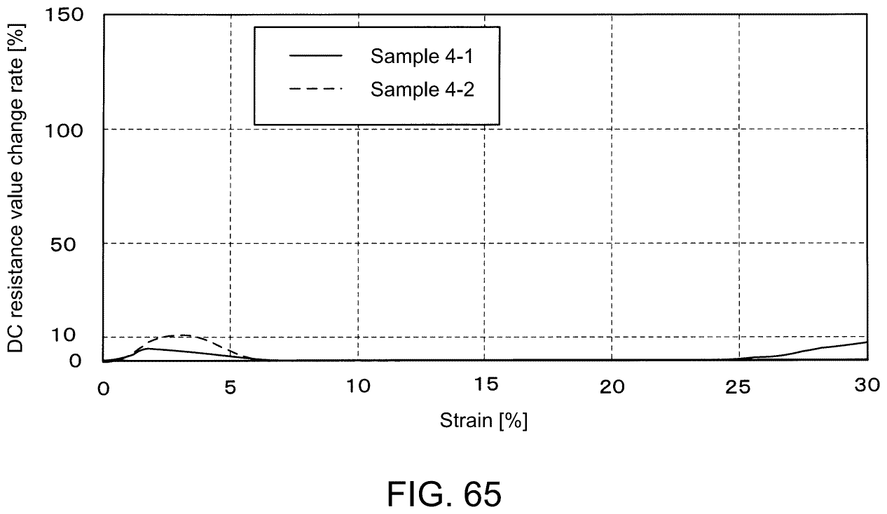

FIG. 65 is a graph showing changes in the DC resistance value change rate with respect to the strain. The DC resistance value change rate of Sample 4-1 increased in a range with the strain being 0 to about 2%, and the DC resistance value change rate became about 5% at a strain of about 2%. Thereafter, decreasing in a range of about 2 to about 5%, the DC resistance value change rate became about 0%. Thereafter, at a strain of about 25% or more, the DC resistance value change rate gradually increased, and the DC resistance value change rate became about 7% at a strain of 30%. In this manner, the DC resistance value change rate of Sample 4-1 was 10% or less in a range with the strain being 0 to 30%.

The DC resistance value change rate of Sample 4-2 increased in a range with the strain being 0 to about 3%, and the DC resistance value change rate became about 10% at a strain of about 3%. Thereafter, decreasing in a range of about 3 to about 5%, the DC resistance value change rate became about 0%. Thereafter, even at a strain of 30%, the DC resistance value change rate was about 0%. In this manner, the DC resistance value change rate of Sample 4-2 was 10% or less in the range with the strain being 0 to 30%.

### 4.1.8.6. DC Resistance Value Change Rate of Sensor Sheet During 10% Elongation

Next, the DC resistance value change rate of the sensor sheet during 10% elongation was measured. A test piece was prepared by cutting the sensor sheet into a strip shape of 90 mm×20 mm. The angle formed between the longitudinal direction of the test piece and the longitudinal direction of the warp filament assembly 72a is set to 45°. In this test, configurations obtained by excluding the first protecting part 61 and the second protecting part 62 from the configurations of Samples 4-1 to 4-2 described above were used as the test pieces.

The test piece is held by a pair of chucks. The distance between the pair of chucks is 50 mm. The tensile test is performed on the test piece at a tensile speed of 1 mm/sec. Electric wires were connected respectively to both ends of the first electrode sheet, and the DC resistance value between the two electric wires was measured. The DC resistance value change rate is calculated based on Formula (1) below for the DC resistance value at this time. Measurement of the DC resistance value is performed using a digital multimeter 2000 series manufactured by KEITHLEY. The above test is performed for Samples 4-1 to 4-2.

When measuring the DC resistance value change rate of the sensor sheet described above, with respect to a reference length (50 mm) of the state before applying a tensile force to the sensor sheet, a test of elongating the sensor sheet by 10%, then returning to the reference length, and again elongating by 10% is repeated for a predetermined number of times. The number of repetitions in this test is 1 time, 5 times, and 10 times. The DC resistance value change rate is calculated based on Formula (1) above for the DC resistance value at this time. The above test is performed for Samples 4-1 to 4-2.

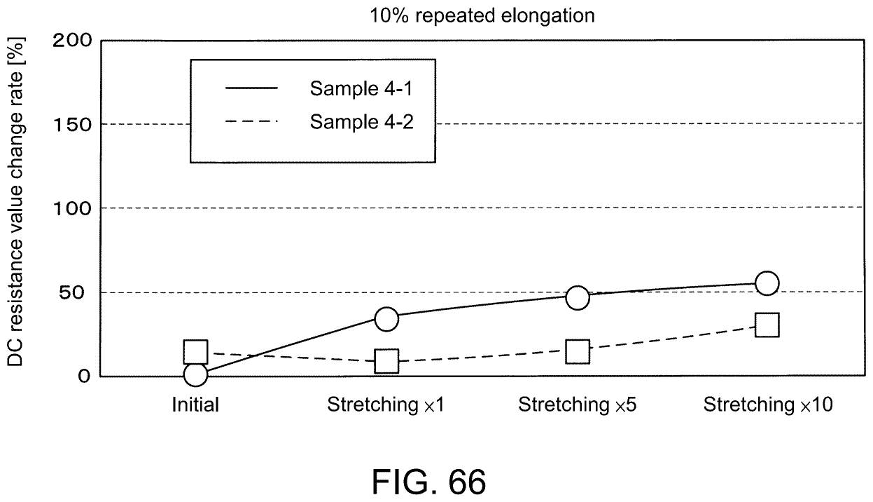

FIG. 66 shows a graph related to a relationship between the number of repetitions of the tensile test and the DC resistance value change rate. In Sample 4-1, the DC resistance value change rate at the initial measurement was about 0%. Thereafter, as the number of repetitions increased, the DC resistance value change rate increased to about 36% upon 1 repetition, to about 48% upon 5 repetitions, and to about 57% upon 10 repetitions. Upon 10 repetitions, the DC resistance value change rate of Sample 4-1 was 60% or less.

In Sample 4-2, the DC resistance value change rate at the initial measurement was about 14% and was larger than that of Sample 4-1. However, the DC resistance value change rate did not increase much even though the number of repetitions increased, with the DC resistance value change rate being about 9% upon 1 repetition and about 15% upon 5 repetitions. Upon 10 repetitions, the DC resistance value change rate was about 30%. Upon 10 repetitions, the DC resistance value change rate of Sample 4-2 was 50% or less. As described above, it was learned that a change in the DC resistance value of the sensor sheets related to Samples 4-1 and 4-2 is small even in the case where the 10% elongation test was repeated.

### 4.1.8.7. DC Resistance Value Change Rate of Sensor Sheet During 20% Elongation

Next, the DC resistance value change rate of Samples 4-1 to 4-2 in the case of elongating the sensor sheet by 20% is measured. In this test, configurations obtained by excluding the first protecting part 61 and the second protecting part 62 from each of the configurations of Samples 4-1 to 4-2 described above were used as the test pieces.

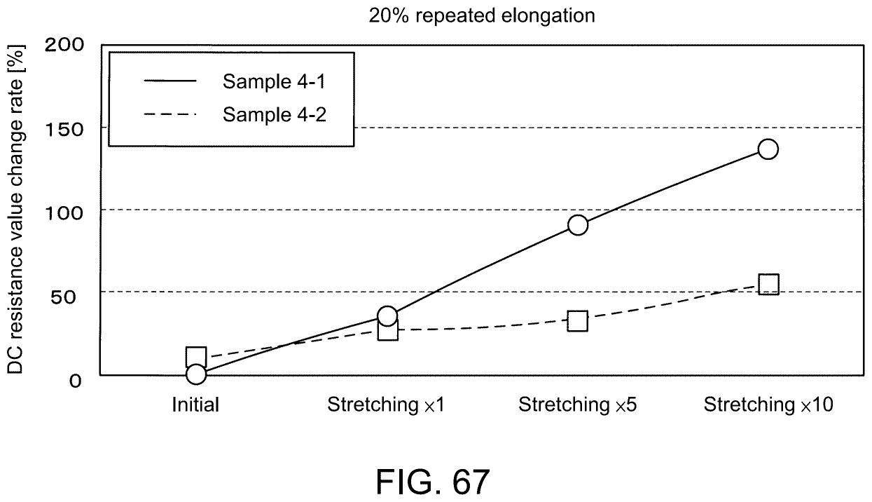

FIG. 67 shows a graph related to a relationship between the number of repetitions of the tensile test and the DC resistance value change rate. In Sample 4-1, the DC resistance value change rate at the initial measurement was about 0%. Thereafter, as the number of repetitions increased, the DC resistance value change rate increased to about 35% upon 1 repetition and to about 91% upon 5 repetitions. Upon 10 repetitions, the DC resistance value change rate was about 137%.

In Sample 4-2, the DC resistance value change rate at the initial measurement was about 10% and was larger than that of Sample 4-1. However, the DC resistance value change rate did not increase much even though the number of repetitions increased, with the DC resistance value change rate being about 27% upon 1 repetition and being about 32% upon 5 repetitions. Upon 10 repetitions, the DC resistance value change rate of Sample 4-2 was about 55%. As described above, it was learned that a change in the DC resistance value of the sensor sheets related to Samples 4-1 and 4-2 is small even in the case where the 20% elongation test was repeated.

### 4.1.9. Modification Example of Embodiment 4-1

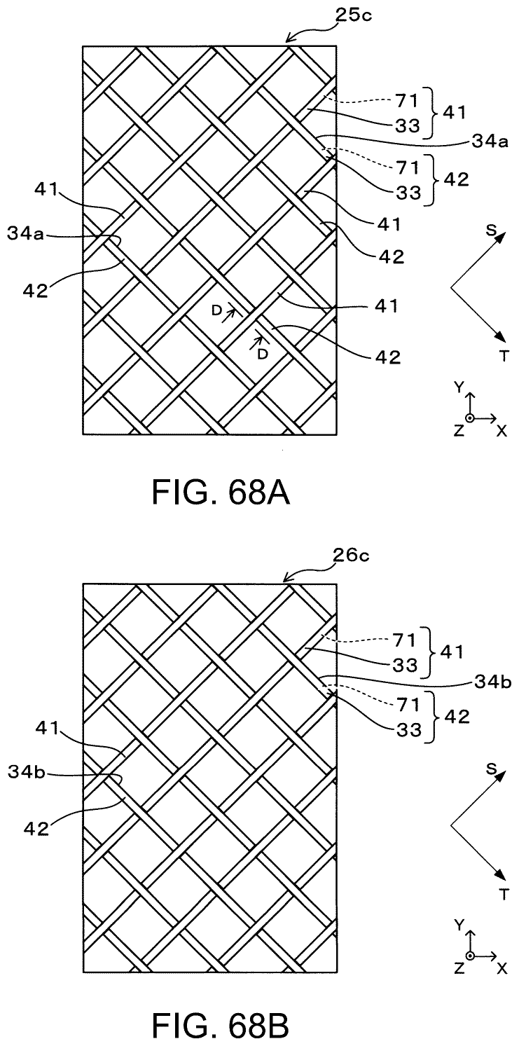

A modification example of Embodiment 4-1 will be described with reference to FIG. 68A to FIG. 70. In the present modification example, the configurations of the first electrode sheet 25c and the second electrode sheet 26c are different from those in Sample 4-1. As shown in FIG. 68A, the first electrode sheet 25c of the present modification example includes multiple warps 41 and multiple wefts 42. The first electrode sheet 25c is formed by weaving the warps 41 and the multiple wefts 42. The warp 41 is composed of one filament 71 and a plating layer 33 formed on a surface of the filament 71, and the weft 42 is composed of one filament 71 and a plating layer 33 formed on a surface of the filament 71.

The first electrode sheet 25c includes a first opening 34a that is opened between two warps 41 adjacent to each other among the multiple warps 41 and two wefts 42 adjacent to each other among the multiple wefts 42. The first opening 34a penetrates through the first electrode sheet 25c. In the present modification example, an opening ratio, which is a ratio of an opening area of the first openings 34a formed in the first electrode sheet 25c to an area of the first electrode sheet 25c, is about 63%.

As shown in FIG. 68B, the second electrode sheet 26c of the present modification example includes multiple warps 41 and multiple wefts 42. The second electrode sheet 26c is formed by weaving the warps 41 and the multiple wefts 42. The warp 41 is composed of one filament 71, and the weft 42 is composed of one filament 71.

The second electrode sheet 26c includes a second opening 34b that is opened between two warps 41 adjacent to each other among the multiple warps 41 and two wefts 42 adjacent to each other among the multiple wefts 42. In the present modification example, an opening ratio, which is a ratio of an opening area of the second openings 34b formed in the second electrode sheet 26c to an area of the second electrode sheet 26c, is about 63%.

As shown in FIG. 68A, the multiple warps 41 related to the present modification example are disposed at substantially equal intervals. “Substantially equal intervals” includes cases where the intervals are equal, and also includes cases where the intervals, although not equal, can be considered substantially equal. In addition, the intervals between the multiple warps 41 may also be different from each other.

In addition, the multiple wefts 42 related to the present modification example are disposed at substantially equal intervals. “Substantially equal intervals” includes cases where the intervals are equal, and also includes cases where the intervals, although not equal, can be considered substantially equal. In addition, the intervals between the multiple wefts 42 may also be different from each other.

As shown in FIG. 68B, since the configuration of the second electrode sheet 26 is the same as that of the first electrode sheet 25, repeated descriptions will be omitted.

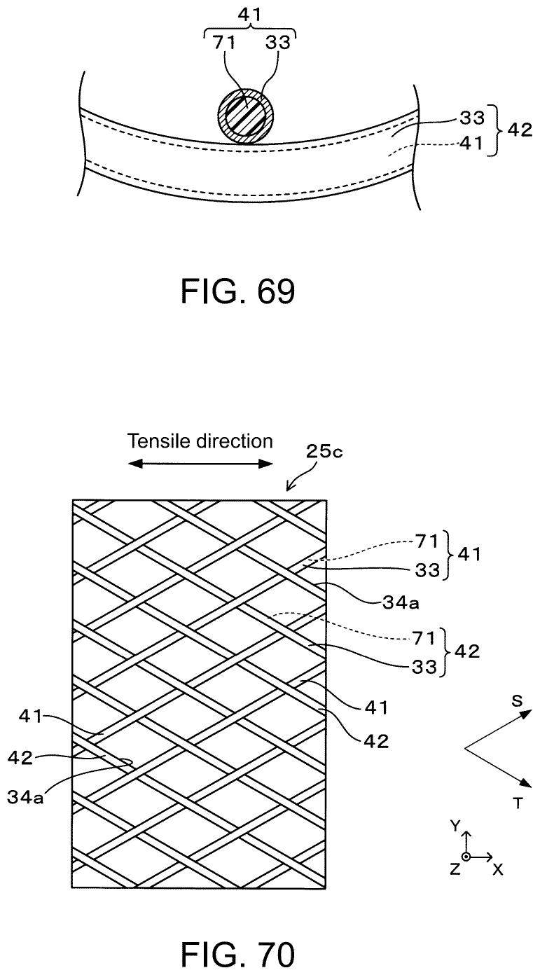

As shown in FIG. 69, the plating layer 33 is formed at at least a part of the warp 41. The plating layer 33 may be formed on the entire surface of the warp 41, or the plating layer 33 may be formed on a part of the surface of the warp 41.

In addition, the plating layer 33 is formed at at least a part of the weft 42. The plating layer 33 may be formed on the entire surface of the weft 42, or the plating layer 33 may be formed on a part of the surface of the weft 42.

In the present modification example, the warp 41 and the weft 42 are electrically connected to each other by the contact between the plating layer 33 formed on the surface of the warp 41 and the plating layer 33 formed on the surface of the weft 42.

Upon application of a tensile force to the present modification example, the first openings 34a of the first electrode sheet 25c elongate in the tensile direction and contract in the direction intersecting the tensile direction. FIG. 70 shows a state of deformation of the first openings 34a in the present modification example. Accordingly, it is thought that since the tensile force is absorbed, a change in the stress is small. Since the same also applies to the second electrode sheet 26c, repeated descriptions will be omitted.

Since configurations other than the above are the same as those in Sample 4-1, repeated descriptions will be omitted.

### 4.1.10. Actions and Effects of Present Embodiment

Next, actions and effects of the present embodiment will be described. The sensor sheet 18 related to the present embodiment includes an insulating sheet 24 having a first surface 27 and a second surface 28, a first electrode sheet 25 disposed on the first surface 27 side of the insulating sheet 24 and composed of a conductive cloth, a first bonding part 36 that bonds the first surface 27 of the insulating sheet 24 and an inner surface of the first electrode sheet 25 to each other, and a first protecting part 61 disposed on an outer surface of the first electrode sheet 25 to protect the outer surface of the first electrode sheet 25.

According to the present embodiment, since the first electrode sheet 25 is protected from an external force by the first protecting part 61, damage to the conductive path of the first electrode sheet 25 can be suppressed. Accordingly, a change in the electrical resistance value of the sensor sheet 18 can be suppressed.

In addition, the sensor sheet 18 related to the present embodiment includes a second electrode sheet 26 disposed on the second surface 28 side of the insulating sheet 24 and composed of a conductive cloth, a second bonding part 37 that bonds the second surface 28 of the insulating sheet 24 and an inner surface of the second electrode sheet 26 to each other, and a second protecting part 62 disposed on an outer surface of the second electrode sheet 26 to protect the outer surface of the second electrode sheet 26.

According to the present embodiment, since the second electrode sheet 26 is protected from an external force by the second protecting part 62, damage to the conductive path of the second electrode sheet 26 can be suppressed. Accordingly, deterioration of shielding performance of the sensor sheet 18 can be suppressed.

The first protecting part 61 and the second protecting part 62 related to the present embodiment are configured to include a resin material. Accordingly, the strength of the first protecting part 61 and the second protecting part 62 is improved. In addition, a work of disposing the first protecting part 61 on the surface of the first electrode sheet 25 can be easily performed, and a work of disposing the second protecting part 62 on the surface of the second electrode sheet 26 can be easily performed.

The first protecting part 61 related to the present embodiment is formed in a layer shape covering the outer surface of the first electrode sheet 25. Accordingly, since the outer surface of the first electrode sheet 25 can be reliably covered, the first electrode sheet 25 can be further protected. As a result, a change in the electrical resistance value of the sensor sheet 18 can be further suppressed.

In addition, the second protecting part 62 is formed in a layer shape covering the outer surface of the second electrode sheet 26. Accordingly, since the outer surface of the second electrode sheet 26 can be reliably covered, the second electrode sheet 26 can be further protected. As a result, shielding performance of the sensor sheet 18 can be further improved.

The conductive cloth constituting the first electrode sheet 25 related to the present embodiment is woven with multiple filament assemblies 72. The first protecting part 61 is formed on an outer circumference of the filament assembly 72. Accordingly, since the filament assembly 72 can be protected by the first protecting part 61, a change in the electrical resistance value of the sensor sheet 18 can be further suppressed.

The first bonding part 36 related to the present embodiment is interposed between the insulating sheet 24 and the first electrode sheet 25. Accordingly, the insulating sheet 24 and the first electrode sheet 25 can be reliably bonded to each other.

The conductive cloth constituting the first electrode sheet 25 related to the present embodiment is woven with multiple filament assemblies 72, and the filament assembly 72 includes multiple filaments 71. The conductive cloth includes first openings 34a that are opened between the multiple filament assemblies 72. An opening ratio, which is a ratio of an opening area of the first openings 34a to an area of the first electrode sheet 25, is 3% or more. Accordingly, in the case where an external force is applied to the first electrode sheet 25, the external force can be absorbed by deformation of the first openings 34a. Accordingly, since application of an excessively large stress to the first electrode sheet 25 can be suppressed, breakage of the conductive path of the first electrode sheet 25 can be suppressed. As a result, a change in the electrical resistance value of the sensor sheet 18 can be suppressed.

The insulating sheet 24 related to the present embodiment is made of a foamed elastomer. Accordingly, flexibility of the insulating sheet 24 can be improved. As a result, in the case where an external force is applied to the sensor sheet 18, the external force can be absorbed by deformation of the insulating sheet 24. Accordingly, since application of an excessively large stress to the first electrode sheet 25 can be suppressed, breakage the conductive path of the first electrode sheet 25 can be suppressed. As a result, a change in the electrical resistance value of the sensor sheet 18 can be suppressed.

The conductive cloth related to the present embodiment is woven with multiple filament assemblies 72, and the filament assembly 72 includes multiple filaments 71 and a plating layer 33 formed on at least a part of a surface of the filament 71. The multiple filaments 71 are electrically connected to each other by mutual contact between the plating layers 33 formed on the surfaces of the multiple filaments 71. Accordingly, the conductive path of the first electrode sheet 25 is formed.

The plating layer 33 is formed on the surface of each filament 71 of the multiple filaments 71. Accordingly, even in the case where an external force is applied to the sensor sheet 18 and relative positions of the multiple filaments 71 change, the conductive path is easily formed by the plating layer 33 formed on the surface of each filament 71. As a result, a change in the electrical resistance value of the sensor sheet 18 can be suppressed.

### Embodiment 4-2

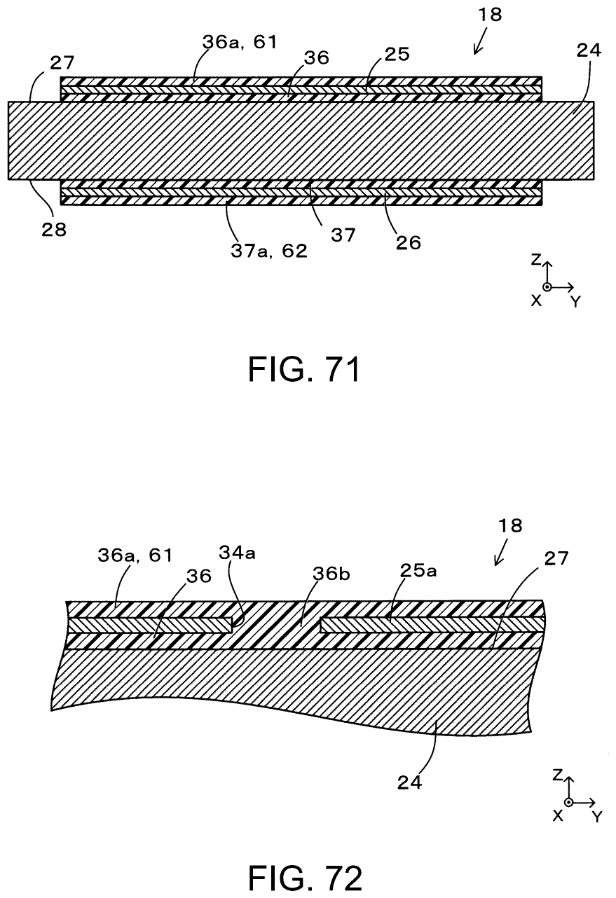

Next, Embodiment 4-2 will be described with reference to FIG. 71 to FIG. 72. As shown in FIG. 71, the first bonding part 36 related to the present embodiment includes a first exposed bonding part 36a exposed on an outer surface of the first electrode sheet 25. The first exposed bonding part 36a is formed in a layer shape on the outer surface of the first electrode sheet 25. The first exposed bonding part 36a also serves as a first protecting part 61 that protects the first electrode sheet 25. Accordingly, the manufacturing process of the sensor sheet 18 can be simplified compared to the case where a first protecting part 61 is separately disposed and fixed at the first electrode sheet 25 in addition to the first bonding part 36.

As shown in FIG. 72, the first electrode sheet 25 includes a first opening 34a. The first bonding part 36 intrudes inside the first opening 34a. The portion of the first bonding part 36 that intrudes into the first opening 34a is taken as a first intruding bonding part 36b. The first intruding bonding part 36b penetrates through the first electrode sheet 25 and is continuous with the first exposed bonding part 36a. As described above, since the first exposed bonding part 36a also serves as the first protecting part 61, the first intruding bonding part 36b is continuous with the first protecting part 61.

According to the present embodiment, the first bonding part 36 can be caused to intrude into the first opening 34a of the first electrode sheet 25 to serve as the first intruding bonding part 36b, and the first exposed bonding part 36a and the first intruding bonding part 36b can configured in a continuous shape. Accordingly, upon laminating the first bonding part 36 on the first surface 27 of the insulating sheet 24, disposing the first electrode sheet 25 on the first bonding part 36, and pressing the first electrode sheet 25 toward the insulating sheet 24, the first intruding bonding part 36b intrudes into the first opening 34a of the first electrode sheet 25. By further covering the first electrode sheet 25, the first exposed bonding part 36a is formed, and the first exposed bonding part 36a can serve as the first protecting part 61 that protects the first electrode sheet 25.

Since the opening ratio of the first opening 34a related to the present embodiment is 3% or more, the first bonding part 36 can be easily caused to intrude into the first opening 34a. Accordingly, the sensor sheet 18 related to the present embodiment can be easily manufactured. By configuring the opening ratio of the first opening 34a to be preferably to 5% or more, and more preferably 10% or more, the first bonding part 36 can be caused to intrude into the first opening 34a more easily.

In addition, as shown in FIG. 71, the second bonding part 37 related to the present embodiment includes a second exposed bonding part 37a exposed on an outer surface of the second electrode sheet 26. The second exposed bonding part 37a is formed in a layer shape on the outer surface of the second electrode sheet 26. The second exposed bonding part 37a also serves as a second protecting part 62 that protects the second electrode sheet 26. Since the configurations related to the second bonding part 37 and the second electrode sheet 26 are identical to the configurations related to the first bonding part 36 and the first electrode sheet 25, repeated descriptions will be omitted.

Among reference signs used in Embodiment 4-2 onward, reference signs identical to those used in the previous embodiments represent the same constituent elements as those in the previous embodiments unless otherwise stated.

### Embodiment 4-3

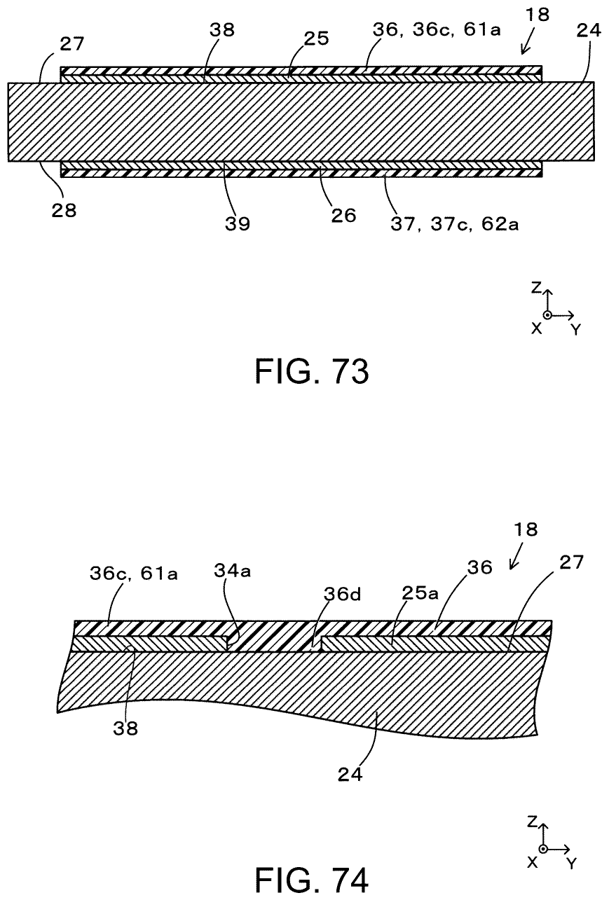

Next, Embodiment 4-3 will be described with reference to FIG. 73 to FIG. 74. As shown in FIG. 73, the first electrode sheet 25 related to the present embodiment is disposed on the first surface 27 of the insulating sheet 24. The first electrode sheet 25 may be in contact, over the entire surface or partially, with the first surface 27 of the insulating sheet 24. Accordingly, with the insulating sheet 24 and the first electrode sheet 25 directly contacting each other, a first direct region 38 in which the first bonding part 36 is not interposed is formed between the insulating sheet 24 and the first electrode sheet 25 (refer to FIG. 74).

The first bonding part 36 is disposed on the outer surface of the first electrode sheet 25. Accordingly, the portion of the first bonding part 36 exposed on the outer surface of the first electrode sheet 25 is taken as a first exposed bonding part 36c. The first exposed bonding part 36c is formed in a layer shape on the outer surface of the first electrode sheet 25. The first exposed bonding part 36c also serves as a first protecting part 61a that protects the first electrode sheet 25.

As shown in FIG. 74, the first electrode sheet 25 includes a first opening 34a. The first bonding part 36 intrudes inside the first opening 34a. The portion of the first bonding part 36 that intrudes into the first opening 34a is taken as a first intruding bonding part 36d. The first intruding bonding part 36d penetrates through the first electrode sheet 25 and is continuous with the first exposed bonding part 36c. As described above, since the first exposed bonding part 36c also serves as the first protecting part 61a, the first intruding bonding part 36d is continuous with the first protecting part 61a.

According to the present embodiment, the first bonding part 36 can be caused to intrude into the first opening 34a of the first electrode sheet 25 to serve as the first intruding bonding part 36d, and the first exposed bonding part 36c and the first intruding bonding part 36d can be configured in a continuous shape. Accordingly, upon laminating the first bonding part 36 on the first surface 27 of the insulating sheet 24, disposing the first electrode sheet 25 on the outer surface of the first bonding part 36, and pressing the first electrode sheet 25 toward the insulating sheet 24, the first intruding bonding part 36d intrudes into the first opening 34a of the first electrode sheet 25. By further covering the first electrode sheet 25, the first exposed bonding part 36c is formed, and the first exposed bonding part 36c can serve as the first protecting part 61a that protects the first electrode sheet 25.

In addition, as shown in FIG. 73, the second electrode sheet 26 related to the present embodiment is disposed on the second surface 28 of the insulating sheet 24. The second electrode sheet 26 may be in contact, over the entire surface or partially, with the second surface 28 of the insulating sheet 24. Accordingly, with the insulating sheet 24 and the second electrode sheet 26 directly contacting each other, a second direct region 39 in which the second bonding part 37 is not interposed is formed between the insulating sheet 24 and the second electrode sheet 26.

The second bonding part 37 is disposed on the outer surface of the second electrode sheet 26. Accordingly, the portion of the second bonding part 37 exposed on the outer surface of the second electrode sheet 26 is taken as a second exposed bonding part 37c. The second exposed bonding part 37c is formed in a layer shape on the outer surface of the second electrode sheet 26. The second exposed bonding part 37c also serves as a second protecting part 62a that protects the second electrode sheet 26. Since the configurations related to the second bonding part 37 and the second electrode sheet 26 are identical to the configurations related to the first bonding part 36 and the first electrode sheet 25, repeated descriptions will be omitted.

Since configurations other than the above are the same as those in Embodiment 4-2, repeated descriptions will be omitted.

According to the present embodiment, the first electrode sheet 25 is placed on the first surface 27 of the insulating sheet 24, and the first bonding part 36 formed in a layer shape is placed on the first electrode sheet 25. Next, the first bonding part 36 is pressed toward the insulating sheet 24. As a result, the first bonding part 36 intrudes into the first opening 34a of the first electrode sheet 25 to serve as the first intruding bonding part 36d. The first intruding bonding part 36d is in contact with the first surface 27 of the insulating sheet 24 within the first opening 34a. The insulating sheet 24 and the first electrode sheet 25 are bonded to each other by the first intruding bonding part 36d within the first opening 34a. Since the actions and effects related to the second bonding part 37 and the second electrode sheet 26 are identical to the actions and effects related to the first bonding part 36 and the first electrode sheet 25, repeated descriptions will be omitted.

### Embodiment 4-4

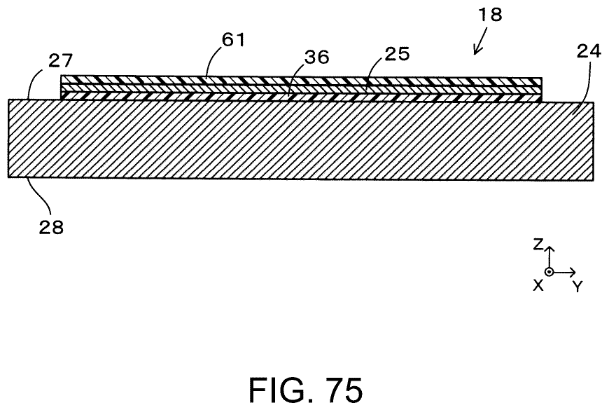

Next, Embodiment 4-4 will be described with reference to FIG. 75. As shown in FIG. 75, the sensor sheet 18 related to the present embodiment differs from Embodiment 4-1 in that the second electrode sheet 26 is not disposed on the second surface 28 side of the insulating sheet 24. Since configurations other than the above are the same as those in Embodiment 4-1, repeated descriptions will be omitted.

In addition, although not shown in detail, the sensor sheets 18 related to Embodiment 4-2 and Embodiment 4-3 may also be configured such that the second electrode sheet 26 is not disposed on the second surface 28 side of the insulating sheet 24.

The disclosure is not limited to the above-described embodiments, and may be applied to various embodiments within a range that does not deviate from the spirit thereof.

1. A sensor sheet (18) comprising an insulating sheet (24), a first electrode sheet (25), a first bonding part (36), a second electrode sheet (26), and a second bonding part (37), wherein
the insulating sheet (24) has a first surface (27) and a second surface (28) and is formed of a foamed body,
the first electrode sheet (25), which is conductive, is disposed on a first surface side of the insulating sheet and has first openings (34a) penetrating through the first electrode sheet (25),
the first bonding part (36) bonds the insulating sheet and the first electrode sheet to each other,
the second electrode sheet (26), which is conductive, is disposed on a second surface side of the insulating sheet and has second openings (34b) penetrating through the second electrode sheet (26), and
the second bonding part (37) bonds the insulating sheet and the second electrode sheet to each other, wherein
the first electrode sheet and the second electrode sheet are conductive cloths woven with a plurality of filament assemblies (72),
the plurality of filament assemblies comprise a plurality of filaments (71) and a plating layer (33) formed on at least a part of a surface of the filament,
the first electrode sheet comprises the first openings that are opened between the plurality of filament assemblies,
the second electrode sheet comprises the second openings that are opened between the plurality of filament assemblies,
the sensor sheet is configured not to have a yield point showing a local maximum value in a range with a strain being 0.5 to 10% in a stress-strain curve in a tensile test,
an opening ratio, which is a ratio of an opening area of the first openings to an area of the first electrode sheet, is 1% or more and 50% or less, and
an opening ratio, which is a ratio of an opening area of the second openings to an area of the second electrode sheet, is 1% or more and 50% or less.

2. The sensor sheet according to claim 1, wherein the sensor sheet is configured such that a maximum value of a stress at a strain of 0 to 5% is 0.5 MPa or less in the stress-strain curve.

3. The sensor sheet according to claim 1, wherein the sensor sheet is configured such that a maximum value of a stress at a strain of 0 to 20% is 3 MPa or less in the stress-strain curve.

4. The sensor sheet according to claim 1, wherein the first electrode sheet is configured such that a maximum value of a stress at a strain of 0 to 5% is 5 MPa or less in the stress-strain curve.

5. The sensor sheet according to claim 1, wherein the first electrode sheet is configured such that a maximum value of a stress at a strain of 0 to 20% is 10 MPa or less in the stress-strain curve.

6. The sensor sheet according to claim 1, wherein the stress-strain curve is a stress-strain curve in a case of holding a test piece of 20 mm×90 mm and performing a tensile test at a tensile speed of 1 mm/s.

7. The sensor sheet according to claim 1, wherein the filament has a cross-section in a non-circular shape.

8. The sensor sheet according to claim 7, wherein the cross-section of the filament is in a polygonal shape.

9. The sensor sheet according to claim 1, wherein the filament assembly further comprises an internal space (80) formed in at least a part between the filaments adjacent to each other.

10. The sensor sheet according to claim 9, wherein the plurality of filaments of the filament assembly are disposed in each of a surface direction of a sheet surface of the first electrode sheet and a normal direction of the sheet surface.

11. The sensor sheet according to claim 10, wherein the internal space is formed in at least a part between the filaments adjacent to each other in the surface direction and in at least a part between the filaments adjacent to each other in the normal direction.

12. The sensor sheet according to claim 9, wherein the plating layer is formed on at least a part of a portion of the surface of the filament that is exposed to the internal space, and
at the portion of the surface of the filament that is exposed to the internal space and is not formed with the plating layer, the surface of the filament is exposed.

13. The sensor sheet according to claim 1, wherein the plurality of filament assemblies comprise warp filament assemblies and weft filament assemblies, and
the plating layer is formed at at least a part of a non-exposed portion (81) at which the warp filament assembly and the weft filament assembly are opposed to and intersect each other.

14. The sensor sheet according to claim 1, wherein the plating layer is formed on at least a part of the surface of the filament that is exposed on an outer surface of the filament assembly, and
at a portion of the surface of the filament that is exposed on the outer surface of the filament assembly and is not formed with the plating layer, the surface of the filament is exposed.

15. The sensor sheet according to claim 1, wherein the plurality of filament assemblies comprise warp filament assemblies (72a) and weft filament assemblies (72b),
at a portion at which the warp filament assembly and the weft filament assembly intersect each other, the plating layer is formed at at least a part of a portion at which the filaments exposed on an outer surface of the warp filament assembly and the filaments exposed on an outer surface of the weft filament assembly are opposed to each other, and at a portion not formed with the plating layer, outer surfaces of the filaments are exposed.

16. The sensor sheet according to claim 1, wherein the plating layer is one layer composed of nickel, or multiple layers comprising a layer composed of copper and a layer composed of nickel.

17. The sensor sheet according to claim 1, further comprising:
a bonding part (36) bonding the first surface of the insulating sheet and an inner surface of the first electrode sheet to each other.

18. The sensor sheet according to claim 17, further comprising:
a protecting part (60) disposed on an outer surface of the first electrode sheet to protect the outer surface of the first electrode sheet.

19. The sensor sheet according to claim 17, wherein the bonding part is interposed between the insulating sheet and the first electrode sheet.

20. The sensor sheet according to claim 17, wherein the bonding part comprises an exposed bonding part (36a) exposed on an outer surface of the first electrode sheet, and
the exposed bonding part also serves as a protecting part that is disposed on the outer surface of the first electrode sheet to protect the outer surface of the first electrode sheet.

21. The sensor sheet according to claim 17, wherein with the insulating sheet and the first electrode sheet directly contacting each other, a direct region (38) in which the bonding part is not interposed is present between the insulating sheet and the first electrode sheet.

22. The sensor sheet according to claim 1, wherein the plurality of filament assemblies comprise warp filament assemblies and weft filament assemblies, and
an area of a portion at which the warp filament assembly and the weft filament assembly intersect each other is larger than the opening area of the first opening in a state in which no strain is generated in the first electrode sheet.

23. The sensor sheet according to claim 22, wherein the first electrode sheet is formed to be long in a longitudinal direction,
the first electrode sheet comprises:
an extension part (31) that extends in an extending direction from a long-side edge extending along the longitudinal direction of the first electrode sheet, and
at the extension part, an occupied area of a plurality of the warp filament assemblies projected in a thickness direction of the extension part is larger than an occupied area of a plurality of the weft filament assemblies projected in the thickness direction of the extension part.

24. The sensor sheet according to claim 22, wherein the first electrode sheet is formed to be long in a longitudinal direction,
the first electrode sheet comprises:
an extension part that extends in an extending direction from a long-side edge extending along the longitudinal direction of the first electrode sheet, and
at the extension part, an angle α formed between the extending direction of the extension part and a longitudinal direction of the warp filament assembly is smaller than an angle β formed between the extending direction of the extension part and a longitudinal direction of the weft filament assembly.

25. The sensor sheet according to claim 22, wherein the first electrode sheet is formed to be long in a longitudinal direction,
the first electrode sheet comprises:
an extension part that extends in an extending direction from a long-side edge extending along the longitudinal direction of the first electrode sheet, and
at the extension part, an angle α formed between the extending direction of the extension part and a longitudinal direction of the warp filament assembly is larger than an angle β formed between the extending direction of the extension part and a longitudinal direction of the weft filament assembly.

26. The sensor sheet according to claim 22, wherein the first electrode sheet is formed to be long in a longitudinal direction,
the first electrode sheet comprises:
an extension part that extends in an extending direction from a long-side edge extending along the longitudinal direction of the first electrode sheet, and
at the extension part, an interval between adjacent filaments among the plurality of filaments constituting the weft filament assembly is smaller than an interval between adjacent filaments among the plurality of filaments constituting the warp filament assembly.

27. The sensor sheet according to claim 22, wherein the first electrode sheet is formed to be long in a longitudinal direction,
the first electrode sheet comprises:
a narrow part (35) that is narrower, than other portions, in a direction intersecting the longitudinal direction of the first electrode sheet, and
at the narrow part, an occupied area of a plurality of the warp filament assemblies projected in a thickness direction of the narrow part is larger than an occupied area of a plurality of the weft filament assemblies projected in the thickness direction of the narrow part.

28. The sensor sheet according to claim 22, wherein the first electrode sheet is formed to be long in a longitudinal direction,
the first electrode sheet comprises:
a narrow part that is narrower, than other portions, in a direction intersecting the longitudinal direction of the first electrode sheet, and
at the narrow part, an interval between adjacent filaments among the plurality of filaments constituting the weft filament assembly is smaller than an interval between adjacent filaments among the plurality of filaments constituting the warp filament assembly.

29. The sensor sheet according to claim 22, wherein the first electrode sheet is formed to be long in a longitudinal direction,
the first electrode sheet comprises:
a narrow part that is narrower, than other portions, in a direction intersecting the longitudinal direction of the first electrode sheet, and
a quantity of the plurality of filaments constituting the warp filament assembly at the narrow part is greater than a quantity of the plurality of filaments constituting the warp filament assembly at a portion different from the narrow part.

30. A manufacturing method of a sensor sheet comprising:
forming a filament assembly by bundling a plurality of filaments;
forming a base fabric by weaving a plurality of the filament assemblies;
forming a conductive cloth by performing a plating treatment on the base fabric; and
forming a sensor sheet by bonding the conductive cloth to a first surface of an insulating sheet made of an elastomer having the first surface and a second surface.
